(19) United States
(12) Patent Application Publication
(10) Pub. No.: US 2025/0261049 A1
(43) Pub. Date: Aug. 14, 2025

(54) MOBILITY FOR MULTI-MODAL UES AND DISTRIBUTED ARCHITECTURE

(71) Applicant: QUALCOMM Incorporated, San Diego, CA (US)

(72) Inventors: Mickael MONDET, Louannec (FR); Prasad Reddy KADIRI, San Diego, CA (US); Diana MAAMARI, San Diego, CA (US); Hyun Yong LEE, San Diego, CA (US); Prashanth Haridas HANDE, San Diego, CA (US); Peerapol TINNAKORNSRISUPHAP, San Diego, CA (US)

(21) Appl. No.: 18/440,900

(22) Filed: Feb. 13, 2024

(51) Int. Cl. H04W 36/00; H04W 36/08

(52) U.S. Cl. CPC H04W 36/0009; H04W 36/0033; H04W 36/087

(57) ABSTRACT

An apparatus at a CP of a CU associated with a plurality of wireless devices associated with a first multi-modal service configured to output, for a target distributed unit (DU) associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure; and output, for the target DU, a second request relating to a second context of the second wireless device in the plurality of wireless devices, wherein the second request comprises a second identifier of at least the first wireless device.

### TECHNICAL FIELD

The present disclosure relates generally to communication systems, and more particularly, to user equipment (UE) mobility in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a CP of a CU associated with a plurality of wireless devices associated with a first multi-modal service, configured to output, for a target distributed unit (DU) associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure; and output, for the target DU, a second request relating to a second context of the second wireless device in the plurality of wireless devices, wherein the second request comprises a second identifier of at least the first wireless device.

In an aspect of the disclosure, a method, a computer-readable medium, and an apparatus are provided. The apparatus may be a CP of a CU associated with a plurality of wireless devices associated with a first multi-modal service, configured to outputting, for a source DU associated with a handover procedure for the plurality of wireless devices, a common request to modify a context of the plurality of wireless devices and obtain, from the source DU and based on the common request, a common response relating to the context of the plurality of wireless devices.

In an aspect of the disclosure, a method, a computer-readable medium, and an apparatus are provided. The apparatus may be a user plane (UP) of a CU associated with a plurality of wireless devices associated with a first multi-modal service, configured to obtain, from a source DU associated with a handover procedure for the plurality of wireless devices, a first common data delivery status indication relating to the plurality of wireless devices and refrain, based on the first common data delivery status indication, from routing data for the plurality of wireless devices to the source DU.

In an aspect of the disclosure, a method, a computer-readable medium, and an apparatus are provided. The apparatus may be a UP of a first CU associated with a target DU connected to a plurality of wireless devices associated with a first multi-modal service, configured to obtain, from a CP of a CU associated with the plurality of wireless devices, a common request associated with a bearer context setup for the plurality of wireless devices and output, for the CP of the CU, a common response associated with the bearer context setup for the plurality of wireless devices.

In an aspect of the disclosure, a method, a computer-readable medium, and an apparatus are provided. The apparatus may be one of an access and mobility management function (AMF) or a user plane function (UPF) associated with a plurality of wireless devices associated with a first multi-modal service, configured to obtain, from a CP of a CU associated with a target DU associated with the plurality of wireless devices, a common request associated with a path switch for the plurality of wireless devices, switch, based on the common request, a path for the plurality of wireless devices, and output, for the CP of the CU, a common response acknowledging the path switch for the plurality of wireless devices.

In an aspect of the disclosure, a method, a computer-readable medium, and an apparatus are provided. The apparatus may be a CP of a CU associated with a plurality of wireless devices associated with a first multi-modal service, configured to output, for a target DU associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure and output, for the target DU, a second request relating to a second context of the second wireless device in the plurality of wireless devices, wherein the second request comprises a second identifier of at least the first wireless device.

In an aspect of the disclosure, a method, a computer-readable medium, and an apparatus are provided. The apparatus may be a user plane (UP) of a CU associated with a plurality of wireless devices associated with a first multi-modal service, configured to obtain, from a source DU associated with a joint handover procedure for the plurality of wireless devices, a first data delivery status indication relating to a first wireless device in the plurality of wireless devices, wherein the first data delivery status indication comprises an identifier of at least a second wireless device in the plurality of wireless devices associated with the joint handover procedure and refrain, based on the first data delivery status indication, from routing data for the plurality of wireless devices to the source DU.

In an aspect of the disclosure, a method, a computer-readable medium, and an apparatus are provided. The apparatus may be a first user plane (UP) of a first CU associated with a source DU connected to a plurality of wireless devices associated with a first multi-modal service, configured to obtain, from a source DU associated with a joint handover procedure for the plurality of wireless devices, a first data delivery status indication relating to a first wireless device in the plurality of wireless devices, wherein the first data delivery status indication comprises a first identifier of at least a second wireless device in the plurality of wireless devices associated with the joint handover procedure and route, based on the first data delivery status indication, data for the plurality of wireless devices to a second UP of a second CU associated with a target DU.

In an aspect of the disclosure, a method, a computer-readable medium, and an apparatus are provided. The apparatus may be a user plane (UP) of a first CU associated with a target DU connected to a plurality of wireless devices associated with a first multi-modal service, configured to obtain, from a CP of a second CU associated with a joint handover procedure for the plurality of wireless devices, a first request associated with a first bearer context setup for a first wireless device in the plurality of wireless devices, wherein the first request comprises a first identifier of at least a second wireless device in the plurality of wireless devices associated with the joint handover procedure for the plurality of wireless devices, refrain, based on the first identifier of at least the second wireless device in the first request, from checking resources in response to the first request, obtain, from the CP of the CU, a second request associated with a second bearer context setup for the second wireless device in the plurality of wireless devices, wherein the second request comprises a second identifier of at least the first wireless device, and check, based on the first request and the second request, the resources for the plurality of wireless devices.

In an aspect of the disclosure, a method, a computer-readable medium, and an apparatus are provided. The apparatus may be one of an AMF or a UPF associated with a plurality of wireless devices associated with a first multi-modal service, configured to obtain, from a CP of a CU associated with a joint handover procedure for the plurality of wireless devices, a first request associated with a path switch for a first wireless device in the plurality of wireless devices, wherein the first request comprises a first identifier of at least a second wireless device in the plurality of wireless devices associated with the joint handover procedure for the plurality of wireless devices, refrain, based on the first identifier of at least the second wireless device in the first request, from switching a path for the plurality of wireless devices, obtain, from the CP of the CU, a second request associated with the path switch for the second wireless device, wherein the second request comprises a second identifier of at least the first wireless device, and switch, based on the first request and the second request, the path for the plurality of wireless devices.

In an aspect of the disclosure, a method, a computer-readable medium, and an apparatus are provided. The apparatus may be a source DU serving a plurality of wireless devices associated with a multi-modal service, configured to obtain, for a handover procedure for the plurality of wireless devices from the source DU to a target DU, a common context modification request relating to modifying a context of the plurality of wireless devices and output, based on the common context modification request, a first common data delivery status indication for the plurality of wireless devices.

In an aspect of the disclosure, a method, a computer-readable medium, and an apparatus are provided. The apparatus may be a target DU serving a plurality of wireless devices associated with a multi-modal service, configured to obtain, for a handover procedure for the plurality of wireless devices from a source DU to a target DU, a common context setup request relating to modifying a context of the plurality of wireless devices and output, based on the common context setup request, a common context setup response for the plurality of wireless devices.

In an aspect of the disclosure, a method, a computer-readable medium, and an apparatus are provided. The apparatus may be a source DU serving a plurality of wireless devices associated with a multi-modal service, configured to obtain, in association with a handover procedure for the plurality of wireless devices, a first context modification request for a first wireless device in the plurality of wireless devices, wherein the first context modification request comprises a first identifier for at least a second wireless device in the plurality of wireless devices, and obtain, in association with the handover procedure for the plurality of wireless devices, a second context modification request for the second wireless device, wherein the second context modification request comprises a second identifier for at least the first wireless device in the plurality of wireless devices.

In an aspect of the disclosure, a method, a computer-readable medium, and an apparatus are provided. The apparatus may be a target DU serving a plurality of wireless devices associated with a multi-modal service, configured to obtain, in association with a handover procedure for the plurality of wireless devices, a first context setup request for a first wireless device in the plurality of wireless devices, wherein the first context setup request comprises a first identifier for at least a second wireless device in the plurality of wireless devices and obtain, in association with the handover procedure for the plurality of wireless devices, a second context setup request for the second wireless device, wherein the second context setup request comprises a second identifier for at least the first wireless device in the plurality of wireless devices.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating a UE providing an XR and/or VR service that may be provided from a server via a base station.

FIG. 4B is a diagram illustrating a set of UEs associated with different multi-modal flows of a multi-modal service provided by a server via a base station in accordance with some aspects of the disclosure.

FIG. 4C is a diagram illustrating an XR flow that includes multiple XR traffic bursts in accordance with some aspects of the disclosure.

FIG. 5A is a diagram illustrating a first distributed architecture associated with some aspects of the disclosure.

FIG. 5B is a diagram illustrating a second distributed architecture associated with some aspects of the disclosure.

FIG. 5C is a diagram illustrating a third distributed architecture associated with some aspects of the disclosure.

FIG. 6 is a call flow diagram illustrating a method for a joint handover using common messages for a plurality of UEs in a first distributed architecture in accordance with some aspects of the disclosure.

FIG. 7 is a call flow diagram illustrating a method for a joint handover using common messages for a plurality of UEs in a second distributed architecture in accordance with some aspects of the disclosure.

FIG. 8 is a call flow diagram illustrating a method for a joint handover using common messages for a plurality of UEs in a third distributed architecture in accordance with some aspects of the disclosure.

FIG. 9 is a call flow diagram illustrating a method for a joint handover using UE-specific messages for a plurality of UEs in a first distributed architecture in accordance with some aspects of the disclosure.

FIG. 10A is a call flow diagram illustrating a first portion of a method for a joint handover using UE-specific messages for a plurality of UEs in a second distributed architecture in accordance with some aspects of the disclosure.

FIG. 10B is a call flow diagram illustrating a second portion of the method for the joint handover using UE-specific messages for the plurality of UEs in the second distributed architecture in accordance with some aspects of the disclosure.

FIG. 11A is a call flow diagram illustrating a first portion of a method for a joint handover using common messages for a plurality of UEs in a third distributed architecture in accordance with some aspects of the disclosure.

FIG. 11B is a call flow diagram illustrating a second portion of a method for a joint handover using common messages for a plurality of UEs in a third distributed architecture in accordance with some aspects of the disclosure.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a flowchart of a method of wireless communication.

FIG. 22 is a flowchart of a method of wireless communication.

FIG. 23 is a flowchart of a method of wireless communication.

FIG. 24 is a flowchart of a method of wireless communication.

FIG. 25 is a flowchart of a method of wireless communication.

FIG. 26 is a diagram illustrating an example of a hardware implementation for an example network entity.

FIG. 27 is a diagram illustrating an example of a hardware implementation for an example network entity.

### DETAILED DESCRIPTION

Some aspects of wireless communication provide a high-speed, low-latency, and high-reliability wireless connectivity which can enable latency-sensitive services like an immersive extended reality (XR), augmented reality (AR), and/or virtual reality (VR) multimedia (e.g., associated with cloud computing). For example, wireless communication may provide multi-media associated with one or more of AR Glasses, VR Head-Mounted Display (HMD), Cloud Gaming, or Cloud AI. In some aspects, these advanced applications may be associated with strict system characteristics including one or more of data rate, latency, and power consumption. For example, a first service may be associated with low-latency and high-reliability characteristics and/or thresholds such as a set of thresholds associated with an error rate and a latency, e.g., 99% packets of (XR) traffic delivered within a packet delay budget (PDB) (e.g. 10 ms). As mobile devices operate in cellular networks, the mobility procedures may significantly increase the packet delay of real-time multimedia traffic.

In some aspects, a VR and/or XR service may include audio, visual, and/or haptic data and/or traffic may be associated with multiple UEs (e.g., wireless devices such as VR goggles providing audio/visual content, gloves or other wearable devices providing haptic and/or tactile feedback, or other VR/XR devices). For example, tactile and multi-modal communication services may enable multi-modal interactions, combining ultra-low latency with extremely high availability, reliability, and/or security. In some aspects, good immersive experiences may be associated with multi-modal flows (e.g., multi-modal data and/or traffic) received by UEs within synchronization thresholds. For example, audio data may be delayed by up to 50 ms compared to related tactile/haptic data while tactile/haptic data may be delayed by up to 25 ms compared to related audio data. In some aspects, visual data may be delayed by up to 15 ms compared to related tactile/haptic data while tactile/haptic data may be delayed by up to 50 ms compared to related visual data.

The synchronization thresholds between multi-modal flows, in some aspects, may raise challenges related to inter-cell mobility, as two (or more) UEs may be involved. When a plurality of UEs is associated with different data flows associated with a same XR service, it may introduce challenges associated with ensuring the synchronization thresholds are met. In some aspects, in order to simplify meeting the synchronization UEs may be moved to a neighboring cell together if one UE experiences a trigger for moving cells (e.g., degrading radio conditions). The reasons for moving UEs together, in some aspects, may include (1) simplifying synchronization (such that all multi-modal QoS flows are managed by the same scheduler), (2) to ensure that packets which are synchronized go through the same path in the network (to avoid packets from one QoS flow to be delayed because of forwarding while packets of other flows are not), or (3) to ensure that the first UE is not moved to a target cell which doesn't have the resources to accept/support the other (related) UEs.

Various aspects relate generally to network signaling for UEs that are grouped together for serving a common service. In some examples, a CP of a CU associated with a plurality of wireless devices associated with a first multi-modal service, configured to output, for a source DU associated with a handover procedure for the plurality of wireless devices, a common request to modify a context of the plurality of wireless devices and obtain, from the source DU and based on the common request, a common response relating to the context of the plurality of wireless devices. In some aspects, a source DU serving a plurality of wireless devices associated with a multi-modal service may be configured to obtain, for a handover procedure for the plurality of wireless devices from the source DU to a target DU, a common context modification request relating to modifying a context of the plurality of wireless devices and output, based on the common context modification request, a first common data delivery status indication for the plurality of wireless devices. In some aspects, a target DU serving a plurality of wireless devices associated with a multi-modal service may be configured to obtain, for a handover procedure for the plurality of wireless devices from a source DU to a target DU, a common context setup request relating to modifying a context of the plurality of wireless devices and output, based on the common context setup request, a common context setup response for the plurality of wireless devices. In some aspects, a CP of a CU associated with a plurality of wireless devices associated with a first multi-modal service, may be configured to output, for a target distributed unit (DU) associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure; and output, for the target DU, a second request relating to a second context of the second wireless device in the plurality of wireless devices, wherein the second request comprises a second identifier of at least the first wireless device. In some aspects, source DU serving a plurality of wireless devices associated with a multi-modal service, may be configured to obtain, in association with a handover procedure for the plurality of wireless devices, a first context modification request for a first wireless device in the plurality of wireless devices, wherein the first context modification request comprises a first identifier for at least a second wireless device in the plurality of wireless devices, and obtain, in association with the handover procedure for the plurality of wireless devices, a second context modification request for the second wireless device, wherein the second context modification request comprises a second identifier for at least the first wireless device in the plurality of wireless devices. In some aspects, a target DU serving a plurality of wireless devices associated with a multi-modal service may be configured to obtain, in association with a handover procedure for the plurality of wireless devices, a first context setup request for a first wireless device in the plurality of wireless devices, wherein the first context setup request comprises a first identifier for at least a second wireless device in the plurality of wireless devices and obtain, in association with the handover procedure for the plurality of wireless devices, a second context setup request for the second wireless device, wherein the second context setup request comprises a second identifier for at least the first wireless device in the plurality of wireless devices.

Particular aspects of the subject matter described in this disclosure can be implemented to realize one or more of the following potential advantages. In some examples, by introducing network signaling for UEs that are grouped together for serving a common service, the described techniques can be used to provide movement and/or transfer between cells for multiple UEs associated with a multi-modal service without interruption.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

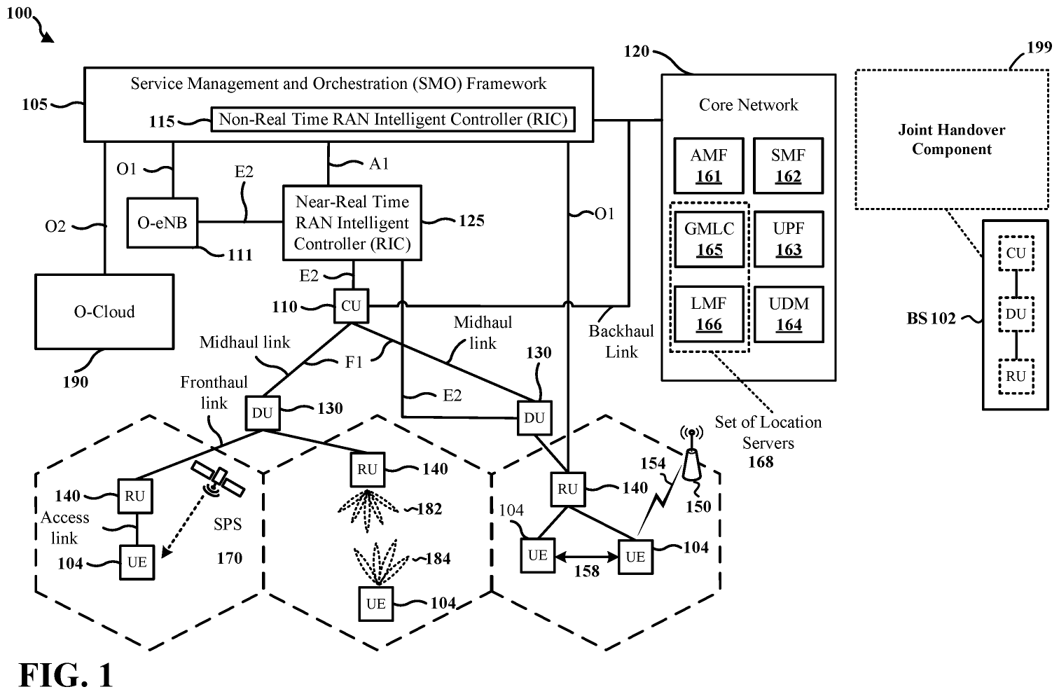

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 102 may have a joint handover component 199 that may be configured to output, for a target distributed unit (DU) associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure; and output, for the target DU, a second request relating to a second context of the second wireless device in the plurality of wireless devices, wherein the second request comprises a second identifier of at least the first wireless device.

The joint handover component 199 may be configured to output, for a source DU associated with a handover procedure for the plurality of wireless devices, a common request to modify a context of the plurality of wireless devices and obtain, from the source DU and based on the common request, a common response relating to the context of the plurality of wireless devices.

The joint handover component 199 may be configured to obtain, from a source DU associated with a handover procedure for the plurality of wireless devices, a first common data delivery status indication relating to the plurality of wireless devices and refrain, based on the first common data delivery status indication, from routing data for the plurality of wireless devices to the source DU.

The joint handover component 199 may be configured to obtain, from a CP of a CU associated with the plurality of wireless devices, a common request associated with a bearer context setup for the plurality of wireless devices and output, for the CP of the CU, a common response associated with the bearer context setup for the plurality of wireless devices.

The joint handover component 199 may be configured to obtain, from a CP of a CU associated with a target DU associated with the plurality of wireless devices, a common request associated with a path switch for the plurality of wireless devices, switch, based on the common request, a path for the plurality of wireless devices, and output, for the CP of the CU, a common response acknowledging the path switch for the plurality of wireless devices.

The joint handover component 199 may be configured to output, for a target DU associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure and output, for the target DU, a second request relating to a second context of the second wireless device in the plurality of wireless devices, wherein the second request comprises a second identifier of at least the first wireless device.

The joint handover component 199 may be configured to obtain, from a source DU associated with a joint handover procedure for the plurality of wireless devices, a first data delivery status indication relating to a first wireless device in the plurality of wireless devices, wherein the first data delivery status indication comprises an identifier of at least a second wireless device in the plurality of wireless devices associated with the joint handover procedure and refrain, based on the first data delivery status indication, from routing data for the plurality of wireless devices to the source DU.

The joint handover component 199 may be configured to obtain, from a source DU associated with a joint handover procedure for the plurality of wireless devices, a first data delivery status indication relating to a first wireless device in the plurality of wireless devices, wherein the first data delivery status indication comprises a first identifier of at least a second wireless device in the plurality of wireless devices associated with the joint handover procedure and route, based on the first data delivery status indication, data for the plurality of wireless devices to a second UP of a second CU associated with a target DU.

The joint handover component 199 may be configured to obtain, from a CP of a second CU associated with a joint handover procedure for the plurality of wireless devices, a first request associated with a first bearer context setup for a first wireless device in the plurality of wireless devices, wherein the first request comprises a first identifier of at least a second wireless device in the plurality of wireless devices associated with the joint handover procedure for the plurality of wireless devices, refrain, based on the first identifier of at least the second wireless device in the first request, from checking resources in response to the first request, obtain, from the CP of the CU, a second request associated with a second bearer context setup for the second wireless device in the plurality of wireless devices, wherein the second request comprises a second identifier of at least the first wireless device, and check, based on the first request and the second request, the resources for the plurality of wireless devices.

The joint handover component 199 may be configured to obtain, from a CP of a CU associated with a joint handover procedure for the plurality of wireless devices, a first request associated with a path switch for a first wireless device in the plurality of wireless devices, wherein the first request comprises a first identifier of at least a second wireless device in the plurality of wireless devices associated with the joint handover procedure for the plurality of wireless devices, refrain, based on the first identifier of at least the second wireless device in the first request, from switching a path for the plurality of wireless devices, obtain, from the CP of the CU, a second request associated with the path switch for the second wireless device, wherein the second request comprises a second identifier of at least the first wireless device, and switch, based on the first request and the second request, the path for the plurality of wireless devices.

The joint handover component 199 may be configured to obtain, for a handover procedure for the plurality of wireless devices from the source DU to a target DU, a common context modification request relating to modifying a context of the plurality of wireless devices and output, based on the common context modification request, a first common data delivery status indication for the plurality of wireless devices.

The joint handover component 199 may be configured to obtain, for a handover procedure for the plurality of wireless devices from a source DU to a target DU, a common context setup request relating to modifying a context of the plurality of wireless devices and output, based on the common context setup request, a common context setup response for the plurality of wireless devices.

The joint handover component 199 may be configured to obtain, in association with a handover procedure for the plurality of wireless devices, a first context modification request for a first wireless device in the plurality of wireless devices, wherein the first context modification request comprises a first identifier for at least a second wireless device in the plurality of wireless devices, and obtain, in association with the handover procedure for the plurality of wireless devices, a second context modification request for the second wireless device, wherein the second context modification request comprises a second identifier for at least the first wireless device in the plurality of wireless devices.

The joint handover component 199 may be configured to obtain, in association with a handover procedure for the plurality of wireless devices, a first context setup request for a first wireless device in the plurality of wireless devices, wherein the first context setup request comprises a first identifier for at least a second wireless device in the plurality of wireless devices and obtain, in association with the handover procedure for the plurality of wireless devices, a second context setup request for the second wireless device, wherein the second context setup request comprises a second identifier for at least the first wireless device in the plurality of wireless devices. Although the following description may be focused on 5G NR, the concepts described herein may be applicable to other similar areas, such as LTE, LTE-A, CDMA, GSM, and other wireless technologies.

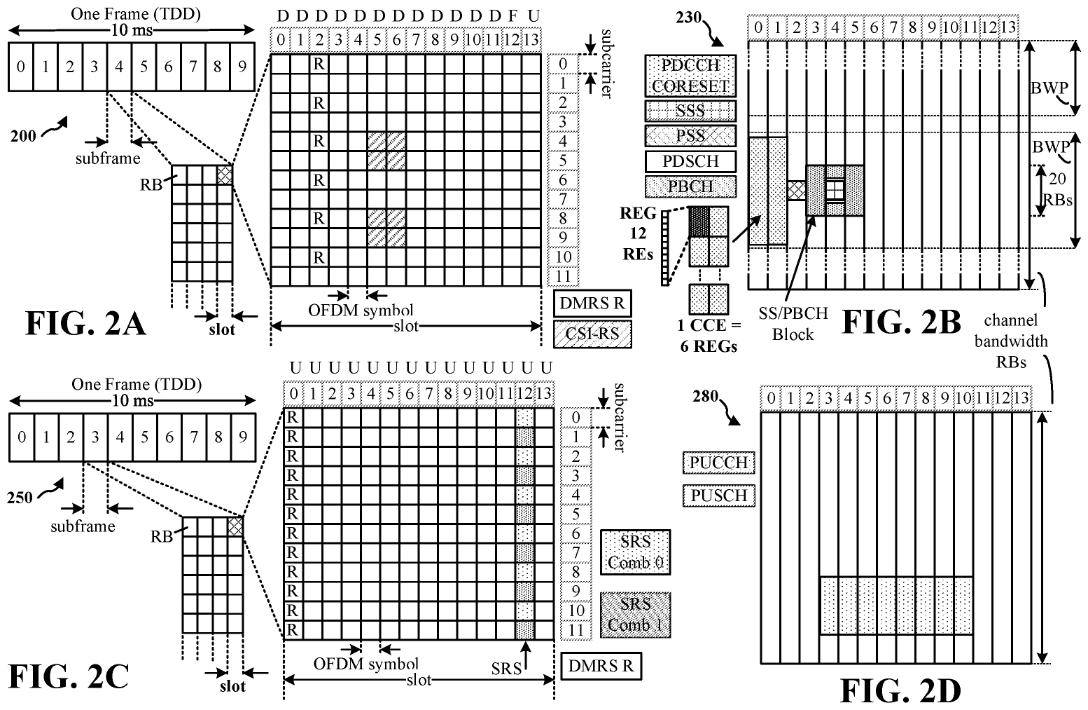

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

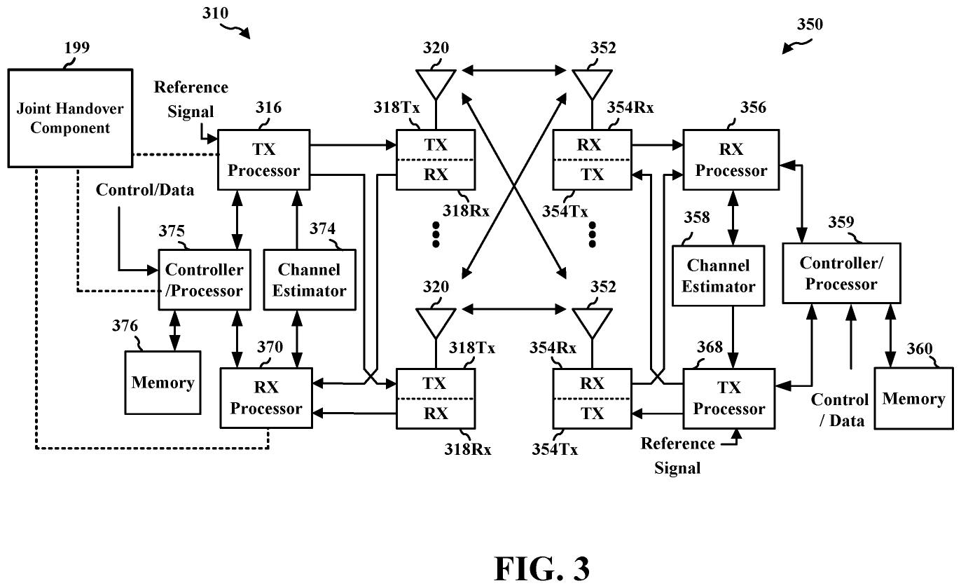

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the joint handover component 199 of FIG. 1.

Wireless communication systems, such as described in connection with FIGS. 1, 2A, 2B, 2C, 2D, and 3, may support various types of wireless traffic. Some aspects of wireless communication provide a high-speed, low-latency, and high-reliability wireless connectivity which can enable latency-sensitive services like an immersive extended reality (XR), augmented reality (AR), and/or virtual reality (VR) multimedia (e.g., associated with cloud computing).

XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

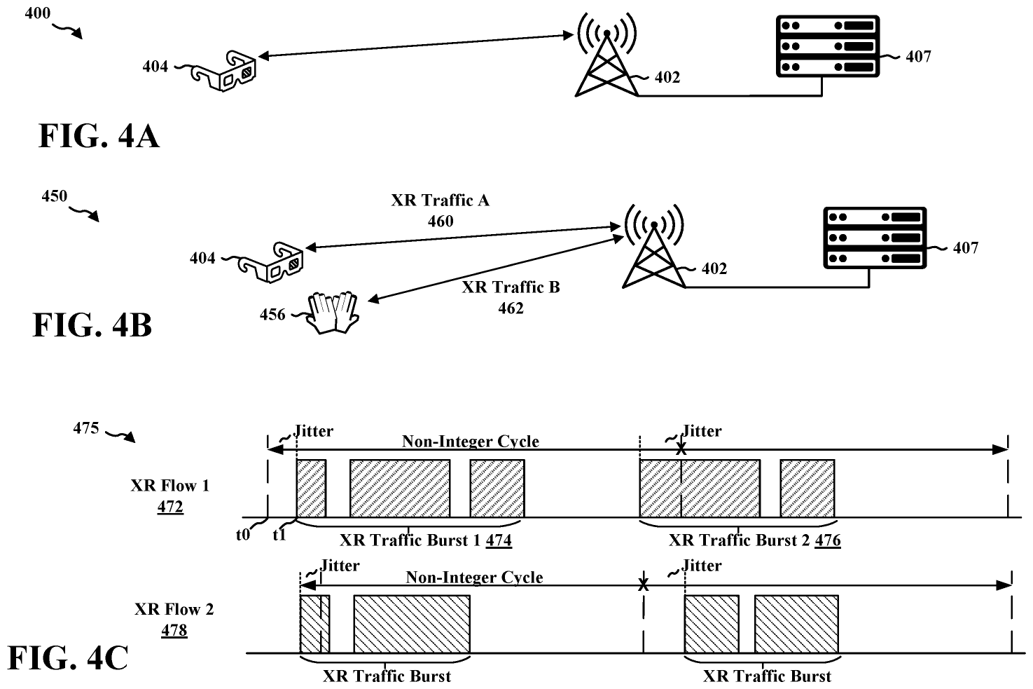

XR traffic may arrive in periodic traffic bursts (“XR traffic bursts”). An XR traffic burst may vary in a number of packets per burst and/or a size of each pack in the burst. The diagram 475 in FIG. 4C illustrates a first XR flow 472 that includes a first XR traffic burst 474 and a second XR traffic burst 476. As illustrated in the diagram 475, the traffic bursts may include different numbers of packets, e.g., the first XR traffic burst 474 being shown with three packets (represented as rectangles in the diagram 475) and the second XR traffic burst 476 being shown with two packets. Furthermore, as illustrated in the diagram 475, the three packets in the first XR traffic burst 474 and the two packets in the second XR traffic burst 476 may vary in size, that is, packets within the first XR traffic burst 474 and the second XR traffic burst 476 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 472, a UE may expect a first packet of the first XR traffic burst 474 to arrive at time to, but the first packet of the first XR traffic burst 474 arrives at time t1.

XR traffic may include multiple flows that arrive at a UE (or a base station) concurrently with one another (or within a threshold period of time). For instance, the diagram 475 includes a second XR flow 478. The second XR flow 478 may have different characteristics than the first XR flow 472. For instance, the second XR flow 478 may have XR traffic bursts with different numbers of packets, different sizes of packets, etc. In an example, the first XR flow 472 may include video data and the second XR flow 478 may include audio data for the video data. In another example, the first XR flow 472 may include intra-coded picture frames (I-frames) that include complete images and the second XR flow 478 may include predicted picture frames (P-frames) that include changes from a previous image.

For example, wireless communication may provide multi-media associated with one or more of AR Glasses, VR Head-Mounted Display (HMD), Cloud Gaming, or Cloud AI. In some aspects, these advanced applications may be associated with strict system characteristics including one or more of data rate, latency, and power consumption. For example, a first service may be associated with low-latency and high-reliability characteristics and/or thresholds such as a set of thresholds associated with an error rate and a latency, e.g., 99% packets of (XR) traffic delivered within a packet delay budget (PDB) (e.g. 10 ms). As mobile devices operate in cellular networks, the mobility procedures may significantly increase the packet delay of real-time multimedia traffic.

FIG. 4A is a diagram 400 illustrating an example of an exchange of XR traffic between a UE 404 and a service (e.g., server 407) via a base station 402. As an example, the service may include an XR service or a cloud gaming service, among other examples. For example, the UE may include or be associated with AR Glasses, VR Head-Mounted Display (HMD), Cloud Gaming, or Cloud AI. As an example, an uplink packet from the UE may include input information, such as tracking information or user pose information for the XR service, or input for a cloud gaming service. The server 407 may receive the uplink packet and generate a downlink packet based on the user pose information, tracking information, or gaming input. As an example, the downlink packet may include encoded video data, e.g., with separate images (whether staggered or simultaneous) for each eye. FIG. 4A illustrates a UE 404 providing an XR and/or VR service that may be provided from a server 407 via a base station 402. Diagram 400 illustrates that a UE 404 may be associated with a single modal flow such that moving from one cell to another is not associated with introducing synchronization problems.

FIG. 4B is a diagram 450 illustrating a set of multiple UEs (e.g., including UE 404 and UE 456) associated with different multi-modal flows (e.g., XR traffic A 460 and XR traffic B 462) of a multi-modal service provided by a server 407 via a base station 402 in accordance with some aspects of the disclosure. Diagram 450 illustrates that each UE may be associated with a different type of data (audio, visual, and/or tactile/haptic, etc.) and/or different data flows. As an example, the UE 404 may correspond to VR glasses, and the UE 456 may correspond to gloves associated with the same VR service as the VR glasses. The VR service may be for an immersive multi-modal VR application. The immersive experience may be based on data from multi-modal flows being received by the UE within a time period that meets a synchronization threshold. Table 2 illustrates example synchronization thresholds.

TABLE 2
Example Synchronization thresholds for
immersive multi-modal VR application

| | |
|---|---|
| Flow types | Synchronization thresholds |

| | | |
|---|---|---|
| Audio-Tactile | Audio delay: 50 ms | Tactile delay 25 ms |
| Visual-Tactile | Visual delay: 15 ms | Tactile delay: 50 ms |

Note 1:
For each media component, “delay” refers to the case where that media component is delayed compared to the other.

In some aspects, a VR and/or XR service may include audio, visual, and/or haptic data and/or traffic may be associated with multiple UEs (e.g., wireless devices such as VR goggles providing audio/visual content, gloves or other wearable devices providing haptic and/or tactile feedback, or other VR/XR devices). For example, tactile and multi-modal communication services may enable multi-modal interactions, combining ultra-low latency with extremely high availability, reliability, and/or security. In some aspects, good immersive experiences may be associated with multi-modal flows (e.g., multi-modal data and/or traffic) received by UEs within synchronization thresholds. For example, audio data may be delayed by up to 50 ms compared to related tactile/haptic data while tactile/haptic data may be delayed by up to 25 ms compared to related audio data. In some aspects, visual data may be delayed by up to 15 ms compared to related tactile/haptic data while tactile/haptic data may be delayed by up to 50 ms compared to related visual data.

The synchronization thresholds between multi-modal flows, in some aspects, may raise challenges related to inter-cell mobility, as two (or more) UEs may be involved. As an example, if one UE, e.g., UE 404, suffers signal degradation, it may determine to move cells which may lead to different schedulers scheduling data for the different data flows (e.g., XR traffic A 460 and XR traffic B 462) or the data taking different paths between the server 407 and the different UEs, such that synchronization thresholds might not be met.

When a plurality of UEs is associated with different data flows associated with a same XR service, it may introduce challenges associated with ensuring the synchronization thresholds are met. In some aspects, in order to simplify meeting the synchronization UEs may be moved to a neighboring cell together if one UE experiences a trigger for moving cells (e.g., degrading radio conditions). The reasons for moving UEs together, in some aspects, may include (1) simplifying synchronization (such that all multi-modal QoS flows are managed by the same scheduler), (2) to ensure that packets which are synchronized go through the same path in the network (to avoid packets from one QoS flow to be delayed because of forwarding while packets of other flows are not), or (3) to ensure that the first UE is not moved to a target cell which doesn't have the resources to accept/support the other (related) UEs.

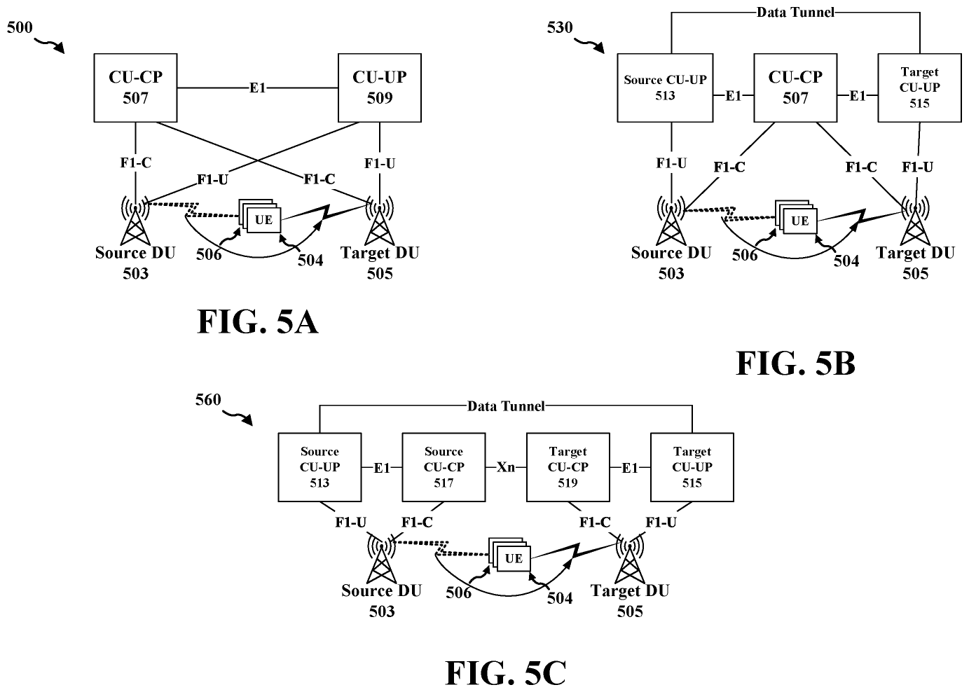

FIG. 5A is a diagram 500 illustrating a first distributed architecture for an intra-CU-CP-intra-CU-UP-Inter-DU handover associated with some aspects of the disclosure. Diagram 500 illustrates that a group of wireless devices including UE 504 and UE 506 may initially be connected to a source DU 503 and may transfer the connection (e.g., via a handover procedure) to a target DU 505. The source DU 503 and the target DU 505, in some aspects, may be associated with a same CU-CP 507 and a same CU-UP 509. In some aspects, the source DU may be referred to as a source base station or a component of a source base station, and the target DU may be referred to as a target base station or a component of a target base station. As one example, the source DU may correspond to a gNB-DU, and the target DU may correspond to a target gNB-DU.

FIG. 5B is a diagram 530 illustrating a second distributed architecture for an intra-CU-CP-inter-CU-UP-inter-DU handover associated with some aspects of the disclosure. Diagram 530 illustrates that a group of wireless devices including UE 504 and UE 506 may initially be connected to a source DU 503 and may transfer the connection (e.g., via a handover procedure) to a target DU 505. The source DU 503 may be associated with a first CU-UP (e.g., source CU-UP 513) and the target DU 505 may be associated with a second CU-UP (e.g., target CU-UP 515). As in diagram 500, both the source DU 503 (e.g., a component of a source base station) and the target DU 505 (e.g., a component of a target base station) may be associated with a same CU-CP 507.

FIG. 5C is a diagram 560 illustrating a second distributed architecture for an inter-CU-CP-inter-CU-UP-inter-DU handover associated with some aspects of the disclosure. Diagram 560 illustrates that a group of wireless devices including UE 504 and UE 506 may initially be connected to a source DU 503 and may transfer the connection (e.g., via a handover procedure) to a target DU 505. The source DU 503 may be associated with a first CU-UP (source CU-UP 513) and a first CU-CP (source CU-CP 517). The target DU 505 may be associated with a second CU-UP (target CU-UP 515) and a second CU-CP (target CU-UP 519). In each of FIGS. 5A, 5B, and 5C, an AMF or UPF may be common to each of the CU components and/or functionality (e.g., the CU-CP or CU-UP).

Some aspects presented herein provide for network signaling for UEs that are grouped together, or associated, for a common service, e.g., such as described in connection with FIG. 4B. In some examples, a CP of a CU associated with a plurality of wireless devices associated with a first multi-modal service, may output, for a target distributed unit (DU) associated with a handover procedure for the plurality of wireless devices (e.g., a plurality of UEs), a first common request relating to a context of the plurality of wireless devices and obtain, from the target DU and based on the first common request, a first common response relating to the context of the plurality of wireless devices. The CP of the CU may also output, for a source DU associated with the handover procedure for the plurality of wireless devices, a second common request to modify the context of the plurality of wireless devices based on the first common response and obtain, from the source DU and based on the second common request, a second common response relating to the context of the plurality of wireless devices. In some aspects, the CP of the CU may output, for a target DU associated with a joint handover procedure for the plurality of wireless devices (e.g., a plurality of UEs), a first request relating to a first context of a first wireless device in the plurality of wireless devices, where the first request includes a first identifier of at least a second wireless device in the plurality of wireless devices associated with the joint handover procedure and output, for the target DU, a second request relating to a second context of the second wireless device in the plurality of wireless devices, where the second request comprises a second identifier of at least the first wireless device.

Particular aspects of the subject matter described in this disclosure can be implemented to realize one or more of the following potential advantages. In some examples, by introducing network signaling for UEs that are grouped together for a common service, the described techniques can be used to provide movement between cells for multiple UEs associated with a multi-modal service without interruption and maintaining synchronization between data flows for the different UEs within the synchronization thresholds for the service. By avoiding interruption and maintaining synchronization, an improved immersive user experience can be provided while enabling mobility between cells.

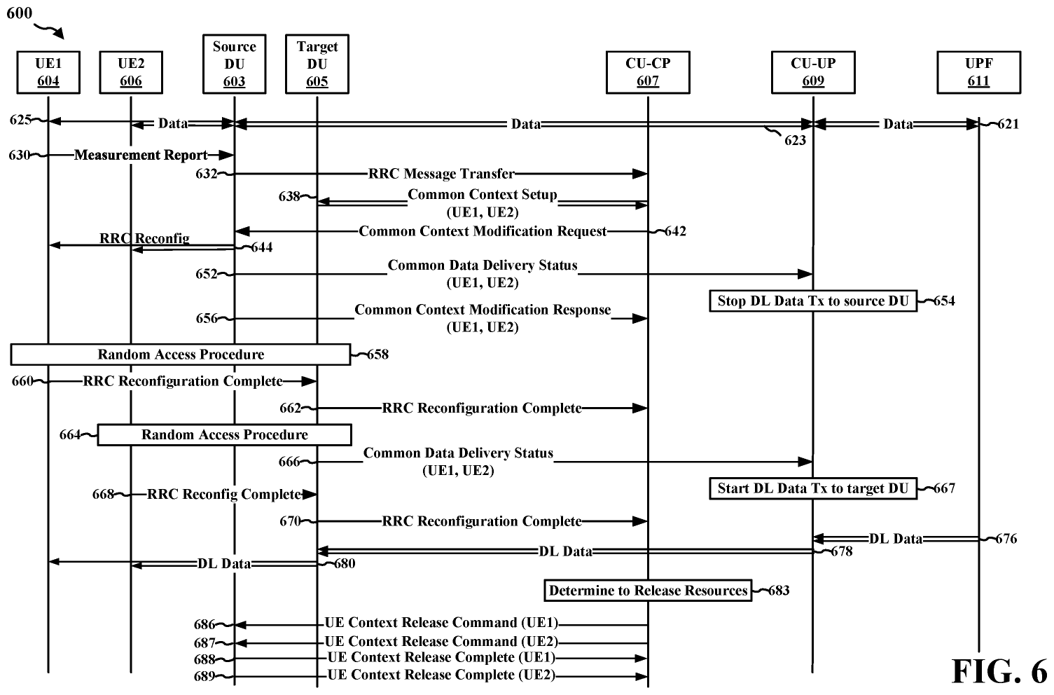

FIG. 6 is a call flow diagram 600 illustrating a method for a joint handover using common messages for a plurality of UEs in a first distributed architecture in accordance with some aspects of the disclosure. FIG. 6 illustrates an example of an intra-CU-CP-intra-CU-UP-inter-DU handover using common messages for multiple UEs served by a multi-modal service, where the source and target DUs have a common CU-CP and CU-UP. The method is illustrated in relation to a first and second UE (e.g., UE1 604 and UE2 606) transferring (e.g., being handed over) from a source DU (sDU 603) to a target DU (tDU 605). The handover may include a handover from a first cell provided by the sDU to a second cell provided by the tDU. Although the example illustrates two UEs, the aspects may be used for a handover of more than two UEs served by a multi-modal service. The method is also illustrated in relation to a network that may include a UPF 611, a CU-CP 607, and a CU-UP 609 common to the sDU 603 and the tDU 605. The functions ascribed to the sDU 603, the tDU 605, the CU-CP 607, the CU-UP 609, or the UPF 611, in some aspects, may be described as being performed by one or more components of a network entity, a network node, or a network device (e.g., a component of a disaggregated network entity/node/device as described above in relation to FIG. 1) of the network, the sDU 603, the tDU 605, the CU-CP 607, the CU-UP 609, or the UPF 611. Accordingly, references to “transmitting” or “outputting” or “providing” in the description below may be understood to refer to a first component of the network, the sDU 603, the tDU 605, the CU-CP 607, the CU-UP 609, or the UPF 611 outputting (or providing) an indication of the content of the transmission to be transmitted by a different component of the network, the sDU 603, the tDU 605, the CU-CP 607, the CU-UP 609, or the UPF 611. Similarly, references to “receiving” or “obtaining” in the description below may be understood to refer to a first component of the network, the sDU 603, the tDU 605, the CU-CP 607, the CU-UP 609, or the UPF 611 receiving a transmitted signal and outputting (or providing) the received signal (or information based on the received signal) to a different component of the network, the sDU 603, the tDU 605, the CU-CP 607, the CU-UP 609, or the UPF 611.

UE1 604 and UE2 606, in some aspects, may be two of a plurality of UEs (or wireless devices) associated with a same multi-modal service (e.g., an XR, AR, VR, or other service providing multiple modes and/or types of input/output via multiple wireless devices). The service, in some aspects, may be associated with multi-modal information including one or more of a service ID (or multi-modal service ID) and a plurality of flows (QOS flows), and a set of relationships between the flows in the plurality of flows. The relationships between flows, in some aspects, may indicate (or define) related flows (e.g., a specific relationship beyond being associated with the same multi-modal service) and inter-flow (or inter-QoS flow) synchronization thresholds for related and/or unrelated flows (e.g., such as described in connection with Table 2).

In order to illustrate the concept, the plurality of UEs may include a headset providing audio/visual output and one or more other wearable devices providing tactile or haptic feedback (e.g., heat/cold and/or vibrations), such as illustrated in the example in FIG. 5B. However, the aspects presented herein are not limited to such examples of UEs and may be used with any plurality of UEs. As shown at 621, 623, and 625, the UE1 604 and the UE2 606 may exchange data with a server via the sDU 603, the CU-UP 609, and the UPF 611. The exchange of data may include any of the aspects described in connection with FIG. 5B, for example. Although not illustrated, the source cell (e.g., via the sDU 603) may provide the UE1 and the UE2 with a measurement configuration, e.g., indicating resources for the UEs to measure and/or indicating for the UEs to report such measurements. In some aspects, the measurement configuration may configure the UEs to measure other potential target cells.

As illustrated, a first UE of the plurality of UEs, e.g., UE1 604, may transmit, and the sDU 603 may receive, a measurement report 630. The measurement report 630, in some aspects may trigger a handover (HO) procedure.

Based on the measurement report the sDU 603 may output, and CU-CP 607 may obtain, the message transfer 632 (e.g., an uplink RRC message transfer of the measurement report). In some aspects, the message transfer 632 may include the information included in the measurement report 630. The CU-CP 607, in some aspects, may determine, based on the message transfer 632, to perform a HO procedure for the plurality of UEs (e.g., including at least UE1 604 and UE2 606) from the sDU 603 to the tDU 605. To initiate the HO procedure, the CU-CP 607 may output, and the tDU 605 may obtain, a first message in a common context setup 638 for the plurality of UEs. For example, the CU-CP 607 may output a common UE context setup request for the plurality of the UEs associated with the (same) service. In some aspects, a “context” may refer to the information used by the network to manage the UE (e.g., managing and/or performing the handover procedure). For example, the context for a UE may include a current state, active connections, supported services, network preferences, etc.

In some aspects, the common UE context setup request may be provided in an updated and/or enhanced UE context setup request that enables the indication of a plurality of UEs in a single UE context setup request. The common UE context setup request (and subsequent “common” messages related to the HO procedure) may include “multi-modal” (or “common”) information. The multi-modal information, in some aspects, may include the multi-modal service ID associated with the plurality of UEs, a list of the UEs associated with the multi-modal service, a list of multi-modal flows associated with the multi-modal service and/or the plurality of UEs, and the relationships between the multi-modal flows associated with the multi-modal service (e.g., the synchronization thresholds associated with related flows). In some aspects, the multi-modal information may indicate which UEs or QoS flows are associated and/or inter-QoS synchronization threshold(s). The tDU 605, in some aspects, may output, and the CU-CP 607 may obtain, a common UE context setup response as part of the common context setup 638. Similarly, the common UE context setup response may be provided in an updated and/or enhanced UE context setup response that enables the indication of a plurality of UEs in a single UE context setup response (e.g., includes all, or part, of the multi-modal information described above). The common context setup request and the common context setup response shown at 638 may be F1-AP messages that are exchanged between the tDU 605 and the CU-CP 607 and include multi-modal information.

Based on the common context setup 638 (e.g., the common UE context setup request obtained from the tDU 605), the CU-CP 607, in some aspects, may output, and the sDU 603 may obtain, a common (UE) context modification request 642. As for the common UE context setup request/response, the common (UE) context modification request 642 may be provided in an updated and/or enhanced format that enables the indication of a plurality of RRC reconfiguration messages for the plurality of UEs and, in some aspects, the multi-modal information described above (or a part thereof), in the common (UE) context modification request 642. In some aspects, the common (UE) context modification request 642 may include multiple RRC reconfiguration messages (e.g., an RRC reconfiguration message for each of the plurality of UEs associated with the service such as an RRC reconfiguration for UE1 604 and an RRC reconfiguration for UE2 606). The sDU 603 may transmit an individual RRC reconfiguration message 644 to the respective UEs such that, e.g., the UE1 604 receives the RRC reconfiguration message for the UE1 604 and the UE2 606 receives the RRC reconfiguration message for the UE2 606. In addition to the common (UE) context modification request 642, the sDU 603 may output, and the CU-UP 609 may obtain, a common data delivery status frame 652 indicating, or associated with, the plurality of UEs. As for the common UE context setup request/response, the common data delivery status frame 652 may be provided in an updated and/or enhanced format that enables the indication of a plurality of UEs in the common data delivery status frame 652 (e.g., may include at least a part of the multi-modal information described above).

At 654, the CU-UP 609 may determine, based on reception of the common data delivery status frame 652 to stop forwarding, routing, and/or directing traffic (from the UPF 611) to the sDU 603. Based on the common (UE) context modification request 642, the sDU 603 may output, and the CU-CP 607 may obtain, a common (UE) context modification response 656. The common (UE) context modification response 656, in some aspects, may indicate the multi-modal service ID and/or the plurality of UEs. The common context modification request and the common context modification response shown at 642 and 656 may be F1-AP messages that are exchanged between the tDU 605 and the CU-CP 607 and include multi-modal information.

Based on the RRC reconfiguration included in the common (UE) context modification request 642, the UE1 604 may perform a random access procedure 658. After performing the procedure 658, the UE1 604 may transmit, and the tDU 605 may receive, the RRC reconfiguration complete message 660. The tDU 605 may forward (or output), and the CU-CP 607 may obtain, the RRC reconfiguration complete message 662, e.g., as an uplink transfer message. Based on the RRC reconfiguration included in the common (UE) context modification request 642, the UE2 606 may perform a random access procedure 664. Additionally, after performing the procedure 658, the UE2 606 may transmit, and the tDU 605 may receive, the RRC reconfiguration complete message 668. The tDU 605 may forward (or output), and the CU-CP 607 may obtain, the RRC reconfiguration complete message 670.

The random access procedure 664 (and the random access procedure 658) may include a first message (e.g., a Msg1), and after receiving at least the first message associated with the random access procedures for each of the plurality of UEs (e.g., each of the multi-modal UEs), the tDU 605 may output, and the CU-UP 609 may obtain, a common data delivery status 666. For example, the tDU 605 may wait for the reception of the Msg1 from both the UE1 and the UE2 before sending the common data delivery status 666. The common data delivery status 666, in some aspects, may identify the plurality of UEs (e.g., via a list of UEs or via the multi-modal service ID associated with the plurality of UEs). Once the CU-UP 609 obtains the common data delivery status 666, the CU-UP 609 may begin, at 667, forwarding, routing, and/or directing traffic (from the UPF 611) to the tDU 605. For example, the UPF 611 may output, and the CU-UP 609 may obtain, DL data 676. The CU-UP 609 may output, and the tDU 605 may obtain, DL data 678 and the tDU 605 may transmit, and the UE1 604 and the UE2 606 may receive, DL data 680.

After obtaining (or receiving) the RRC reconfiguration complete messages from the plurality of UEs (e.g., at least the RRC reconfiguration complete message 662 and the RRC reconfiguration complete message 670), the CU-CP 607 may determine, at 683, to release resources and or UE contexts for the plurality of UEs. Based on the determination at 683, the CU-CP 607 may exchange, with sDU 603, a set of UE context release messages 686 to 689 associated with the UE context release. For example, the CU-CP 607 may output, and the sDU 603 may obtain, a UE context release command message 686 and a UE context release command message 687. The sDU 603 may output, and the CU-CP 607 may obtain, a UE context release complete message 688 and a UE context release complete message 689. In some aspects, a UE context release command/complete message pair may be output/obtained for each of the plurality of UEs.

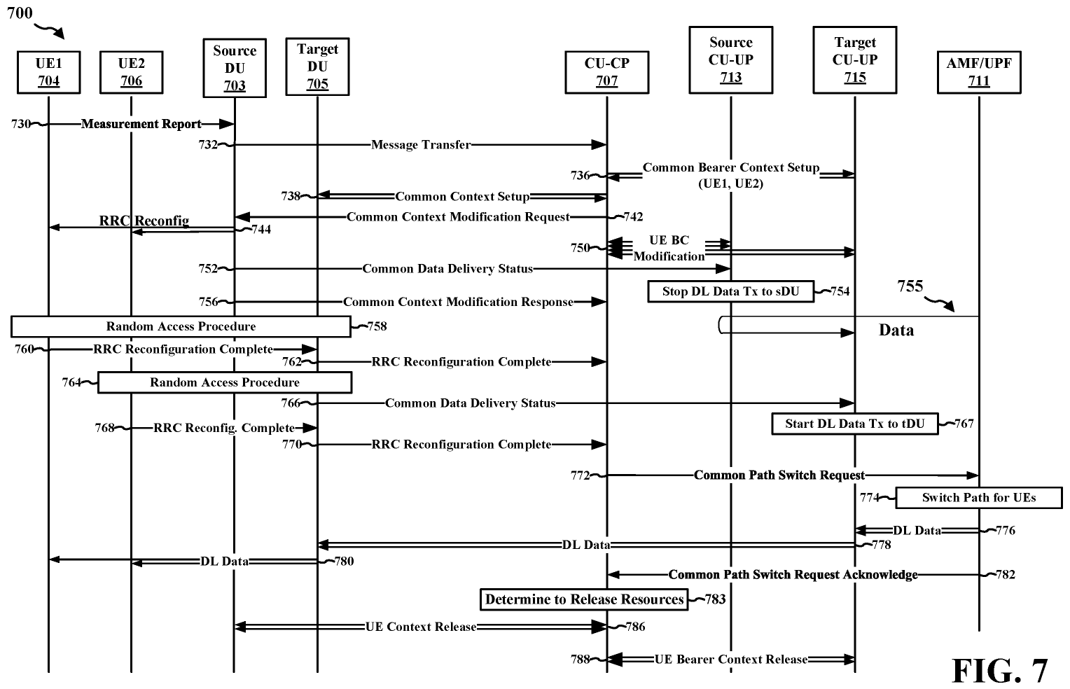

FIG. 7 is a call flow diagram 700 illustrating a method for a joint handover using common messages for a plurality of UEs in a first distributed architecture for an intra-CU-CP-inter-CU-UP-inter-DU handover in accordance with some aspects of the disclosure. The method is illustrated in relation to a first and second UE (e.g., UE1 704 and UE2 706) transferring from a source DU (sDU 703) to a target DU (tDU 705). For example, the handover may be from a first cell provided by the source DU to a second cell provided by the target DU. The method is also illustrated in relation to a network including a CU-CP 707, a source CU-UP 713, a target CU-UP 715, and an AMF/UPF 711 common to the sDU 703 and the tDU 705. The functions ascribed to the network, the sDU 703, the tDU 705, the CU-CP 707, the source CU-UP 713, the target CU-UP 715, or the AMF/UPF 711, in some aspects, may be described as being performed by one or more components of a network entity, a network node, or a network device (e.g., a component of a disaggregated network entity/node/device as described above in relation to FIG. 1) implementing the functionality of the network, the sDU 703, the tDU 705, the CU-CP 707, the source CU-UP 713, the target CU-UP 715, or the AMF/UPF 711. Accordingly, references to “transmitting” or “outputting” in the description below may be understood to refer to a first component of the network, the sDU 703, the tDU 705, the CU-CP 707, the source CU-UP 713, the target CU-UP 715, or the AMF/UPF 711 outputting (or providing) an indication of the content of the transmission to be transmitted by a different component of the network, the sDU 703, the tDU 705, the CU-CP 707, the source CU-UP 713, the target CU-UP 715, or the AMF/UPF 711. Similarly, references to “receiving” or “obtaining” in the description below may be understood to refer to a first component of the network, the sDU 703, the tDU 705, the CU-CP 707, the source CU-UP 713, the target CU-UP 715, or the AMF/UPF 711 receiving a transmitted signal and outputting (or providing) the received signal (or information based on the received signal) to a different component of the network, the sDU 703, the tDU 705, the CU-CP 707, the source CU-UP 713, the target CU-UP 715, or the AMF/UPF 711.

UE1 704 and UE2 706, in some aspects, may be two of a plurality of UEs (or wireless devices) associated with a same multi-modal service (e.g., an XR, AR, VR, or other service providing multiple modes and/or types of input/output via multiple wireless devices), e.g., as described in connection with FIG. 5B. The service, in some aspects, may be associated with multi-modal information including one or more of a service ID (or multi-modal service ID) and a plurality of flows (QOS flows), and a set of relationships between the flows in the plurality of flows. The relationships between flows, in some aspects, may indicate (or define) related flows (e.g., a specific relationship beyond being associated with the same multi-modal service) and inter-flow (or inter-QoS flow) synchronization thresholds for related and/or unrelated flows (see Table 2 above).

As described above, the plurality of UEs may include a headset providing audio/visual output and one or more other wearable devices providing tactile or haptic feedback (e.g., heat/cold and/or vibrations). UE1 704 and UE2 706 may exchange data with a server via the sDU 703, source CU-UP 713, and AMF/UPF 711, e.g., as illustrated in connection with the example in FIG. 6. UE1 704 and UE2 706 may also receive a configuration for a measurement report from the source DU, e.g., as described in connection with FIG. 6.

As illustrated, a first UE of the plurality of UEs, e.g., UE1 704, may transmit, and the sDU 703 may receive, a measurement report 730 in some aspects. The measurement report 730, in some aspects may trigger a handover (HO) procedure to the tDU 705.

Based on the measurement report, the sDU 703 may output, and CU-CP 707 may obtain, the message transfer 732. In some aspects, the message transfer 732 may include the information included in the measurement report 730. The CU-CP 707, in some aspects, may determine, based on the message transfer 732, to perform a HO procedure for the plurality of UEs (e.g., including at least UE1 704 and UE2 706) from the sDU 703 to the tDU 705. To initiate the HO procedure, the CU-CP 707 may output, and the target CU-UP 715 may obtain, a first message in a common bearer context setup 736. For example, the CU-CP 707 may output a common UE bearer context setup request for the plurality of the UEs associated with the multi-modal service. In some aspects, the common UE bearer context setup request may be provided in an updated and/or enhanced UE bearer context setup request that enables the indication of a plurality of UEs in a single UE bearer context setup request. The common UE bearer context setup request (and subsequent “common” messages related to the HO procedure) may include “multi-modal” (or “common”) information, e.g., as described in connection with FIG. 6. The multi-modal information, in some aspects, may include the multi-modal service ID associated with the plurality of UEs, a list of the UEs associated with the multi-modal service, a list of multi-modal flows associated with the multi-modal service and/or the plurality of UEs, and the relationships between the multi-modal flows associated with the multi-modal service (e.g., the synchronization thresholds associated with related flows).

The target CU-UP 715, in some aspects, may output, and the CU-CP 707 may obtain, a common UE bearer context setup response as part of the common bearer context setup 736. In some aspects, the common UE bearer context setup response may be provided in an updated and/or enhanced UE bearer context setup response that enables the indication of a plurality of UEs in a single UE bearer context setup response (e.g., includes all, or part, of the multi-modal information described above). The common bearer context setup request and the common bearer context set response may be E1-AP that include the multi-modal information, e.g., that identifies the UEs to which the common messages are associated.

After exchanging, and based on, the messages associated with the common bearer context setup 736, the CU-CP 707 may output, and the tDU 705 may obtain, a first message in a common context setup 738. For example, the CU-CP 707 may output a common UE context setup request for the plurality of the UEs associated with the (same) service. In some aspects, the common UE context setup request may be provided in an updated and/or enhanced UE context setup request that enables the indication of a plurality of UEs in a single UE context setup request. The common UE context setup request (and subsequent “common” messages related to the HO procedure) may include “multi-modal” (or “common”) information. The tDU 705, in some aspects, may output, and the CU-CP 707 may obtain, a common UE context setup response as part of the common context setup 738. In some aspects, the common UE context setup response may be provided in an updated and/or enhanced UE context setup response that enables the indication of a plurality of UEs in a single UE context setup response (e.g., includes all, or part, of the multi-modal information described above).

Based on the common context setup 738 (e.g., the common UE context setup response obtained from the tDU 705), the CU-CP 707, in some aspects, may output, and the sDU 703 may obtain, a common (UE) context modification request 742. As for the common UE context setup request/response, the common (UE) context modification request 742 may be provided in an updated and/or enhanced format that enables the indication of a plurality of RRC reconfiguration messages for the plurality of UEs and, in some aspects, the multi-modal information described above (or a part thereof), in the common (UE) context modification request 742. In some aspects, the common (UE) context modification request 742 may include multiple RRC reconfiguration messages (e.g., an RRC reconfiguration message for each of the plurality of UEs associated with the service). The sDU 703 may transmit the RRC reconfiguration messages 744 to the respective UEs such that, e.g., the UE1 704 receives the RRC reconfiguration message for the UE1 704 and the UE2 706 receives the RRC reconfiguration message for the UE2 706.

In parallel with the RRC reconfiguration and/or the common context setup 738, the CU-CP 707 may perform a UE bearer context modification (e.g., by exchanging UE bearer context modification messages 750) in association with the source-CU-UP 713 and the target CU-UP 715. For example, the CU-CP 707 may send a bearer context modify request message for UE1 to the source CU-UP 713, and in response, the source CU-UP 713 may send a bearer context modify response message for UE1 to the CU-CP 707. The CU-CP 707 may send a bearer context modify request message for UE2 to the source CU-UP 713, and in response, the source CU-UP 713 may send a bearer context modify response message for UE2 to the CU-CP 707. The CU-CP 707 may send a bearer context modify request message for UE1 to the target CU-UP 715, and in response, the target CU-UP 715 may send a bearer context modify response message for UE1 to the CU-CP 707. The CU-CP 707 may send a bearer context modify request message for UE2 to the target CU-UP 715, and in response, the target CU-UP 715 may send a bearer context modify response message for UE2 to the CU-CP 707.

In addition to the common (UE) context modification request 742, the sDU 703 may output, and the source CU-UP 713 may obtain, a common data delivery status frame 752 indicating, or associated with, the plurality of UEs. As for the common UE context setup request/response, the common data delivery status frame 752 may be provided in an updated and/or enhanced format that enables the indication of a plurality of UEs in the common data delivery status frame 752 (e.g., may include at least a part of the multi-modal information described above).

At 754, the source CU-UP 713 may determine, based on the common data delivery status frame 752 to stop forwarding, routing, and/or directing traffic (from the AMF/UPF 711) to the sDU 703. In some aspects, the source CU-UP 713 may also begin forwarding, routing, and/or directing traffic for UE1 and UE2 (from the AMF/UPF 711) to the target CU-UP 715, e.g., as shown at 755. For example, upon reception of the ‘Common Data Delivery Status’ frame from the sDU 703, the source CU-UP 713 may start forwarding data from downlink Multi-Modal QoS Flows to the target CU-UP 715.

Based on the common (UE) context modification request 742, the sDU 703 may output, and the CU-CP 707 may obtain, a common (UE) context modification response 756. The common (UE) context modification response 756, in some aspects, may indicate the multi-modal service ID and/or the plurality of UEs.

Based on the RRC reconfiguration included in the common (UE) context modification request 742, the UE1 704 may perform a random access procedure 758. After performing the random access procedure 758, the UE1 704 may transmit, and the tDU 705 may receive, the RRC reconfiguration complete message 760. The tDU 705 may forward (or output), and the CU-CP 707 may obtain, the RRC reconfiguration complete message 762. Based on the RRC reconfiguration included in the common (UE) context modification request 742, the UE2 706 may perform a random access procedure 764. Additionally, after performing the random access procedure 758, the UE2 706 may transmit, and the tDU 705 may receive, the RRC reconfiguration complete message 768. The tDU 705 may forward (or output), and the CU-CP 707 may obtain, the RRC reconfiguration complete message 770.

The random access procedure 764 (and the random access procedure 758) may include a first message (e.g., a Msg1), and after receiving at least the first message associated with the random access procedures for each of the plurality of UEs, the tDU 705 may output, and the target CU-UP 715 may obtain, a common data delivery status 766. The common data delivery status 766, in some aspects, may identify the plurality of UEs (e.g., via a list of UEs or via the multi-modal service ID associated with the plurality of UEs). Once the target CU-UP 715 obtains the common data delivery status 766, the target CU-UP 715 may begin, at 767, forwarding, routing, and/or directing traffic (from the AMF/UPF 711) to the tDU 705. As an example, the target CU-UP 715 may forward the data 755 to the tDU 705 once the common data delivery status message is received from the tDU 705. After obtaining (or receiving) the RRC reconfiguration complete messages from the plurality of UEs (e.g., at least the RRC reconfiguration complete message 762 and the RRC reconfiguration complete message 768), the CU-CP 707 may determine to output a common path switch request 772. The common path switch request 772, in some aspects, may include the multi-modal information (at least in part) to identify the plurality of UEs. Based on the common path switch request 772, the AMF/UPF 711 may determine, at 774, to switch the path for the plurality of UEs. For example, the AMF/UPF 711 may output, and the target CU-UP 715 may obtain, DL data 776. The target CU-UP 715 may output, and the tDU 705 may obtain, DL data 778 and the tDU 705 may transmit, and the UE1 704 and the UE2 706 may receive, DL data 780. The AMF/UPF 711, in some aspects, may output, and the CU-CP 707 may obtain, a common path switch request acknowledgment message 782. The common path switch request acknowledgment message 782, in some aspects, may include the multi-modal information (at least in part) to identify the plurality of UEs.

After obtaining (or receiving) the RRC reconfiguration complete messages from the plurality of UEs (e.g., at least the RRC reconfiguration complete message 762 and the RRC reconfiguration complete message 768), the CU-CP 707 may determine, at 783, to release resources and or UE contexts for the plurality of UEs. Based on the determination at 783, the CU-CP 707 may exchange, with sDU 703, a set of UE context release messages 786 associated with the UE context release. For example, the CU-CP 707 may output, and the sDU 703 may obtain, a UE context release command message for UE1 and a UE context release command message for UE2. The sDU 703 may output, and the CU-CP 707 may obtain, a UE context release complete message for UE1 and a UE context release complete message for UE2. In some aspects, a UE context release command/complete message pair may be output/obtained for each of the plurality of UEs. Similarly, the CU-CP 707, may exchange, with target CU-UP 715, a set of UE bearer context release messages 788 associated with UE bearer context release. For example, the CU-CP 707 may output, and the target CU-UP 715 may obtain, a UE bearer context release command message for UE1 and a UE bearer context release command message for UE2, and the target CU-UP 715 may output, and the CU-CP 707 may obtain, a UE bearer context release complete message UE1 and a UE bearer context release complete message for UE2. In some aspects, a UE bearer context release command/complete message pair may be output/obtained for each of the plurality of UEs.

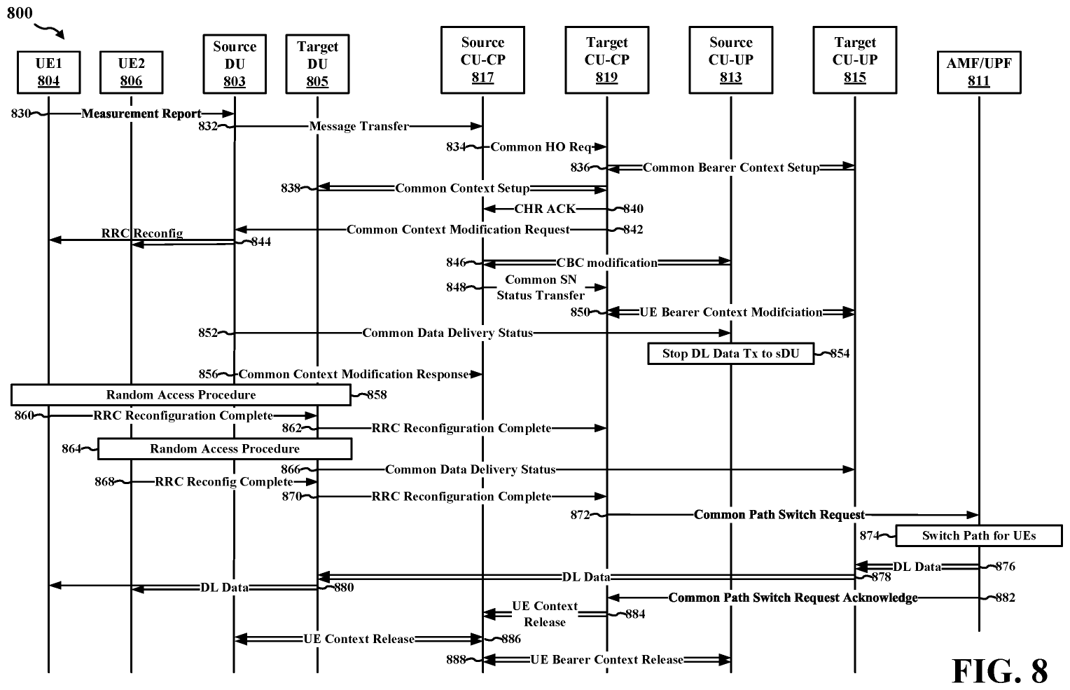

FIG. 8 is a call flow diagram 800 illustrating a method for a joint handover using common messages for a plurality of UEs in a first distributed architecture for an inter-CU-CP-inter-CU-UP-inter-DU handover in accordance with some aspects of the disclosure. The method is illustrated in relation to a first and second UE (e.g., UE1 804 and UE2 806) transferring from a source DU (sDU 803) to a target DU (tDU 805). For example, the handover may be from a first cell provided by the sDU 803 to a second cell provided by the tDU 805. The method is also illustrated in relation to one or more components of a network including a source CU-CP 817, a target CU-CP 819, a source CU-UP 813, a target CU-UP 815, and an AMF/UPF 811 common to the sDU 803 and the tDU 805. The functions ascribed to the network including the source CU-CP 817, the target CU-CP 819, the source CU-UP 813, the target CU-UP 815, or the AMF/UPF 811, in some aspects, may be performed by one or more components of a network entity, a network node, or a network device (e.g., a component of a disaggregated network entity/node/device as described above in relation to FIG. 1) implementing the functionality of the network including the source CU-CP 817, the target CU-CP 819, the source CU-UP 813, the target CU-UP 815, or the AMF/UPF 811. Accordingly, references to “transmitting” or “outputting” in the description below may be understood to refer to a first component of the network including the source CU-CP 817, the target CU-CP 819, the source CU-UP 813, the target CU-UP 815, or the AMF/UPF 811 outputting (or providing) an indication of the content of the transmission to be transmitted by a different component of the network including the source CU-CP 817, the target CU-CP 819, the source CU-UP 813, the target CU-UP 815, or the AMF/UPF 811. Similarly, references to “receiving” or “obtaining” in the description below may be understood to refer to a first component of the network including the source CU-CP 817, the target CU-CP 819, the source CU-UP 813, the target CU-UP 815, or the AMF/UPF 811 receiving a transmitted signal and outputting (or providing) the received signal (or information based on the received signal) to a different component of the network including the source CU-CP 817, the target CU-CP 819, the source CU-UP 813, the target CU-UP 815, or the AMF/UPF 811.

The UE1 804 and the UE2 806 may exchange data with a server via the sDU 803, source CU-UP 813, and AMF/UPF 811, e.g., as described in connection with FIG. 6. The UE1 804 and UE2 806, in some aspects, may be two of a plurality of UEs (or wireless devices) associated with a same multi-modal service (e.g., an XR, AR, VR, or other service providing multiple modes and/or types of input/output via multiple wireless devices). The service, in some aspects, may be associated with multi-modal information including one or more of a service ID (or multi-modal service ID) and a plurality of flows (QOS flows), and a set of relationships between the flows in the plurality of flows. The relationships between flows, in some aspects, may indicate (or define) related flows (e.g., a specific relationship beyond being associated with the same multi-modal service) and inter-flow (or inter-QoS flow) synchronization thresholds for related and/or unrelated flows (see Table 2 above).

As described above, the plurality of UEs may include a headset providing audio/visual output and one or more other wearable devices providing tactile or haptic feedback (e.g., heat/cold and/or vibrations). As illustrated a first UE of the plurality of UEs, e.g., UE1 804, may transmit, and the sDU 803 may receive, a measurement report 830 in some aspects. The measurement report 830, in some aspects may trigger a handover (HO) procedure.

Based on the measurement report, the sDU 803 may output, and source CU-CP 817 may obtain, the message transfer 832. In some aspects, the message transfer 832 may include the information included in the measurement report 830. The source CU-CP 817, in some aspects, may determine, based on the message transfer 832, to perform a HO procedure for the plurality of UEs (e.g., including at least UE1 804 and UE2 806) from the sDU 803 to the tDU 805. To initiate the HO procedure, the source CU-CP 817 may output, and the target CU-CP 819 may obtain, a common HO request that may include the multi-modal information to identify the plurality of UEs. Additionally, the target CU-CP 819 may output, and the target CU-UP 815 may obtain, a first message in a common bearer context setup 836. For example, the target CU-CP 819 may output a common UE bearer context setup request for the plurality of the UEs associated with the multi-modal service. In some aspects, the common UE bearer context setup request may be provided in an updated and/or enhanced UE bearer context setup request that enables the indication of a plurality of UEs in a single UE bearer context setup request. The common UE bearer context setup request (and subsequent “common” messages related to the HO procedure) may include “multi-modal” (or “common”) information. The multi-modal information, in some aspects, may include the multi-modal service ID associated with the plurality of UEs, a list of the UEs associated with the multi-modal service, a list of multi-modal flows associated with the multi-modal service and/or the plurality of UEs, and the relationships between the multi-modal flows associated with the multi-modal service (e.g., the synchronization thresholds associated with related flows).

The target CU-UP 815, in some aspects, may output, and the target CU-CP 819 may obtain, a common UE bearer context setup response as part of the common bearer context setup 836. In some aspects, the common UE bearer context setup response may be provided in an updated and/or enhanced UE bearer context setup response that enables the indication of a plurality of UEs in a single UE bearer context setup response (e.g., includes all, or part, of the multi-modal information described above).

After exchanging the messages associated with the common bearer context setup 836, the target CU-CP 819 may output, and the tDU 805 may obtain, a first message in a common context setup 838. For example, the target CU-CP 819 may output a common UE context setup request for the plurality of the UEs associated with the (same) service. In some aspects, the common UE context setup request may be provided in an updated and/or enhanced UE context setup request that enables the indication of a plurality of UEs in a single UE context setup request. The common UE context setup request (and subsequent “common” messages related to the HO procedure) may include “multi-modal” (or “common”) information. The tDU 805, in some aspects, may output, and the target CU-CP 819 may obtain, a common UE context setup response as part of the common context setup 838. In some aspects, the common UE context setup response may be provided in an updated and/or enhanced UE context setup response that enables the indication of a plurality of UEs in a single UE context setup response (e.g., includes all, or part, of the multi-modal information described above). Additionally, the target CU-CP 819, in some aspects, may output, and the source CU-CP 817 may obtain, a common HO request acknowledgment 840 that may include the multi-modal information or an indication that it is related to the common handover request 834.

Based on the common context setup 838 (e.g., the common UE context setup response obtained from the tDU 805), the target CU-CP 819, in some aspects, may output, and the sDU 803 may obtain, a common (UE) context modification request 842. As for the common UE context setup request/response, the common (UE) context modification request 842 may be provided in an updated and/or enhanced format that enables the indication of a plurality of RRC reconfiguration messages for the plurality of UEs and, in some aspects, the multi-modal information described above (or a part thereof), in the common (UE) context modification request 842. In some aspects, the common (UE) context modification request 842 may include multiple RRC reconfiguration messages (e.g., an RRC reconfiguration message for each of the plurality of UEs associated with the service). The sDU 803 may transmit the RRC reconfiguration messages 844 to the plurality of UEs such that, e.g., the UE1 804 receives the RRC reconfiguration message for the UE1 804 and the UE2 806 receives the RRC reconfiguration message for the UE2 806.

In parallel with the RRC reconfiguration and/or the common context setup 838, the source CU-CP 817 may perform a UE bearer context modification (e.g., by exchanging UE bearer context modification messages 846) in association with the source CU-UP 813 and output a common sequence number (SN) status transfer 848 indicating that the source CU-UP 813 will stop assigning SNs. The target CU-CP 819 may perform a UE bearer context modification (e.g., by exchanging UE bearer context modification messages 850) in association with the target CU-UP 815.

In addition to the common (UE) context modification request 842, the sDU 803 may output, and the source CU-UP 813 may obtain, a common data delivery status frame 852 indicating, or associated with, the plurality of UEs. As for the common UE context setup request/response, the common data delivery status frame 852 may be provided in an updated and/or enhanced format that enables the indication of a plurality of UEs in the common data delivery status frame 852 (e.g., may include at least a part of the multi-modal information described above).

At 854, the source CU-UP 813 may determine, based on the common data delivery status frame 852 to stop forwarding, routing, and/or directing traffic (from the AMF/UPF 811) to the sDU 803. In some aspects, the source CU-UP 813 may also begin forwarding, routing, and/or directing traffic (from the AMF/UPF 811) to the target CU-UP 815. Based on the common (UE) context modification request 842, the sDU 803 may output, and the source CU-CP 817 may obtain, a common (UE) context modification response 856. The common (UE) context modification response 856, in some aspects, may indicate the multi-modal service ID and/or the plurality of UEs.

Based on the RRC reconfiguration included in the common (UE) context modification request 842, the UE1 804 may perform a random access procedure 858. After performing the procedure 858, the UE1 804 may transmit, and the tDU 805 may receive, the RRC reconfiguration complete message 860. The tDU 805 may forward (or output), and the target CU-CP 819 may obtain, the RRC reconfiguration complete message 862. Based on the RRC reconfiguration included in the common (UE) context modification request 842, the UE2 806 may perform a random access procedure 864. Additionally, after performing the procedure 858, the UE2 806 may transmit, and the tDU 805 may receive, the RRC reconfiguration complete message 868. The tDU 805 may forward (or output), and the target CU-CP 819 may obtain, the RRC reconfiguration complete message 870.

The random access procedure 864 (and the random access procedure 858) may include a first message (e.g., a Msg1), and after receiving at least the first message associated with the random access procedures for each of the plurality of UEs, the tDU 805 may output, and the target CU-UP 815 may obtain, a common data delivery status 866. The common data delivery status 866, in some aspects, may identify the plurality of UEs (e.g., via a list of UEs or via the multi-modal service ID associated with the plurality of UEs). Once the target CU-UP 815 obtains the common data delivery status 866, the target CU-UP 815 may begin forwarding, routing, and/or directing traffic (from the AMF/UPF 811) to the tDU 805. After obtaining (or receiving) the RRC reconfiguration complete messages from the plurality of UEs (e.g., at least the RRC reconfiguration complete message 862 and the RRC reconfiguration complete message 868), the target CU-CP 819 may determine to output a common path switch request 872. The common path switch request 872, in some aspects, may include the multi-modal information (at least in part) to identify the plurality of UEs. Based on the common path switch request 872, the AMF/UPF 811 may determine, at 874, to switch the path for the plurality of UEs. For example, the AMF/UPF 811 may output, and the target CU-UP 815 may obtain, DL data 876. The target CU-UP 815 may output, and the tDU 805 may obtain, DL data 878 and the tDU 805 may transmit, and the UE1 804 and the UE2 806 may receive, DL data 880. The AMF/UPF 811, in some aspects, may output, and the target CU-CP 819 may obtain, a common path switch request acknowledgment message 882. The common path switch request acknowledgment message 882, in some aspects, may include the multi-modal information (at least in part) to identify the plurality of UEs.

After obtaining (or receiving) the RRC reconfiguration complete messages from the plurality of UEs (e.g., at least the RRC reconfiguration complete message 862 and the RRC reconfiguration complete message 868), the target CU-CP 819 may determine to release resources and or UE contexts for the plurality of UEs. Based on the determination, the target CU-CP 819 may output, and the source CU-CP 817 may obtain, a set of messages associated with the UE context release 884. The source CU-CP 817, based on the set of messages associated with the UE context release 884, may exchange, with the sDU 803, a set of messages associated with the UE context release 886. For example, the source CU-CP 817 may output, and the sDU 803 may obtain, a UE context release command message. The sDU 803 may output, and the source CU-CP 817 may obtain, a UE context release complete message. In some aspects, a UE context release command/complete message pair may be output/obtained for each of the plurality of UEs. Similarly, the source CU-CP 817 may exchange, with source CU-UP 813, a set of UE bearer context release messages 888 associated with UE bearer context release. For example, the source CU-CP 817 may output, and the source CU-UP 813 may obtain, a UE bearer context release command message and the source CU-UP 813 may output, and the source CU-CP 817 may obtain, a UE bearer context release complete message. In some aspects, a UE bearer context release command/complete message pair may be output/obtained for each of the plurality of UEs.

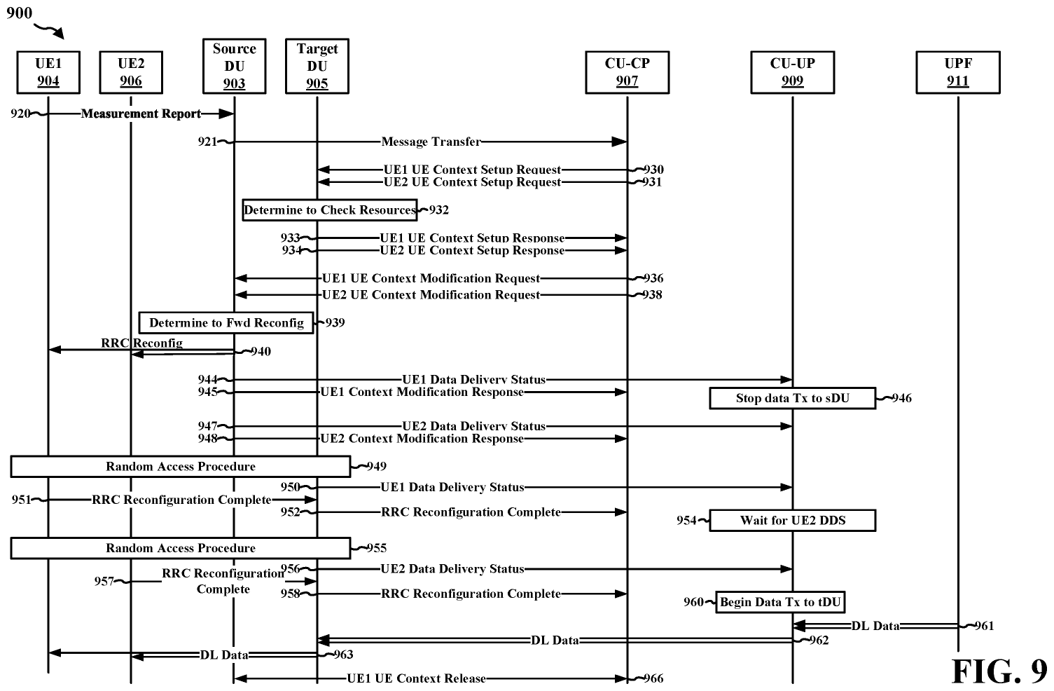

FIG. 9 is a call flow diagram 900 illustrating a method for a joint handover using UE-specific messages for a plurality of UEs in a first distributed architecture in accordance with some aspects of the disclosure. FIG. 9 illustrates an example of an intra-CU-CP-intra-CU-UP-inter-DU handover using UE-specific messages for multiple UEs served by a multi-modal service, where the source and target DUs have a common CU-CP and CU-UP. The method is illustrated in relation to a first and second UE (e.g., UE1 904 and UE2 906) transferring from a source base station (sDU 903) to a target base station (tDU 905). For example, the handover may be from a first cell provided by the source DU to a second cell provided by the target DU. The method is also illustrated in relation to a network including a CU-CP 907, a CU-UP 909 and a UPF 911 common to the sDU 903 and the tDU 905. The functions ascribed to the network, the sDU 903, the tDU 905, the CU-CP 907, the CU-UP 909, or the UPF 911, in some aspects, may be performed by one or more components of a network entity, a network node, or a network device (e.g., a component of a disaggregated network entity/node/device as described above in relation to FIG. 1) implementing the functionality of the network, the sDU 903, the tDU 905, the CU-CP 907, the CU-UP 909, or the UPF 911. Accordingly, references to “transmitting” or “outputting” in the description below may be understood to refer to a first component of the network, the sDU 903, the tDU 905, the CU-CP 907, the CU-UP 909, or the UPF 911 outputting (or providing) an indication of the content of the transmission to be transmitted by a different component of the network, the sDU 903, the tDU 905, the CU-CP 907, the CU-UP 909, or the UPF 911. Similarly, references to “receiving” or “obtaining” in the description below may be understood to refer to a first component of the network, the sDU 903, the tDU 905, the CU-CP 907, the CU-UP 909, or the UPF 911 receiving a transmitted signal and outputting (or providing) the received signal (or information based on the received signal) to a different component of the network, the sDU 903, the tDU 905, the CU-CP 907, the CU-UP 909, or the UPF 911.

UE1 904 and UE2 906, in some aspects, may be two of a plurality of UEs (or wireless devices) associated with a same multi-modal service (e.g., an XR, AR, VR, or other service providing multiple modes and/or types of input/output via multiple wireless devices), e.g., as described in connection with FIG. 5B. The service, in some aspects, may be associated with multi-modal information including one or more of a service ID (or multi-modal service ID) and a plurality of flows (QOS flows), and a set of relationships between the flows in the plurality of flows. The relationships between flows, in some aspects, may indicate (or define) related flows (e.g., a specific relationship beyond being associated with the same multi-modal service) and inter-flow (or inter-QoS flow) synchronization thresholds for related and/or unrelated flows (see Table 2 above).

As described above, the plurality of UEs may include a headset providing audio/visual output and one or more other wearable devices providing tactile or haptic feedback (e.g., heat/cold and/or vibrations). UE1 1004 and UE2 1006 may exchange data with a server via the sDU 1003, source CU-UP 1013, and AMF/UPF 1011, e.g., as illustrated in connection with the example in FIG. 6. UE1 1004 and UE2 1006 may also receive a configuration for a measurement report from the source DU, e.g., as described in connection with FIG. 6.

As illustrated a first UE of the plurality of UEs, e.g., UE1 904, may transmit, and the sDU 903 may receive, a measurement report 920 in some aspects. The measurement report 920, in some aspects may trigger a handover (HO) procedure to the tDU 905.

Based on the measurement report the sDU 903 may output, and CU-CP 907 may obtain, the message transfer 921. In some aspects, the message transfer 921 may include the information included in the measurement report 920. The CU-CP 907, in some aspects, may determine, based on the message transfer 921, to perform a HO procedure for the plurality of UEs (e.g., including at least UE1 904 and UE2 906) from the sDU 903 to the tDU 905. To initiate the HO procedure, the CU-CP 907 may output, and the tDU 905 may obtain, a first UE-specific context setup request 930 message for the UE1 904 and a second UE-specific context setup request 931 for the UE2 906. In some aspects, the UE-specific context setup requests (e.g., the first UE-specific context setup request 930 and the second UE-specific context setup request 931) may be provided in an updated and/or enhanced UE context setup request that enables the indication that the UE-specific context setup request is associated with a joint handover procedure and, in some aspects, the identity of related UEs and other relevant information. The UE-specific context setup requests (and subsequent messages related to the HO procedure) may include “multi-modal” (or “group”) information, e.g., as described in connection with FIG. 6. The multi-modal information, in some aspects, may include the multi-modal service ID associated with the plurality of UEs, a list of the UEs associated with the multi-modal service, a list of multi-modal flows associated with the multi-modal service and/or the plurality of UEs, and the relationships between the multi-modal flows associated with the multi-modal service (e.g., the synchronization thresholds associated with related flows).

The tDU 905, in some aspects, may wait until receiving UE-specific context setup requests from each of the plurality of UEs associated with (or identified by) a first UE-specific context setup request output before determining, at 932, to check resources for the plurality of UEs. For example, the tDU 905 may, upon receiving first UE-specific context setup request 930, identify that the UE1 904 and the UE2 906 are associated with a joint handover procedure and wait until a UE-specific context setup request is received for both the UE1 904 and the UE2 906 before determining to check (and checking) for available resources for both UEs. Checking for resources, in some aspects, may be based at least in part on the relationships and/or synchronization thresholds indicated in the multi-modal information included in the first UE-specific context setup request 930 and/or the second UE-specific context setup request 931.

After checking for available resources, the tDU 905 may output, and the CU-CP 907 may obtain, a first UE-specific context setup response 933 for the UE1 904 and a second UE-specific context setup response 934 for the UE2 906. The UE-specific context setup responses may be provided in an updated and/or enhanced UE context setup response that enables the indication that the UE-specific context setup request is associated with a joint handover procedure and, in some aspects, the identity of related UEs and other relevant information. (e.g., includes all, or part, of the multi-modal information described above). The UE-specific context setup request and the UE-specific context setup response shown at 930, 931, 933, and 934 may be F1-AP messages that are exchanged between the tDU 905 and the CU-CP 907 and include multi-modal information.

Based on the first UE-specific context setup response 933 and the second UE-specific context setup response 934, the CU-CP 907, in some aspects, may output, and the sDU 903 may obtain, a first UE-specific context modification request 936 for the UE1 904 and a second UE-specific context modification request 938 for the UE2 906. Each UE-specific context modification request, in some aspects, may include an RRC reconfiguration message for one UE in the plurality of UEs. As for the UE-specific context setup request/response, a UE-specific context modification request may be provided in an updated and/or enhanced format that enables the indication that the UE-specific context modification request is associated with a joint handover procedure and, in some aspects, the identity of related UEs and other relevant information. (e.g., includes all, or part, of the multi-modal information described above).

The sDU 903 may, upon receiving a UE-specific context modification request for each UE identified as being associated with the joint handover procedure, determine, at 939, to forward the plurality of RRC reconfiguration messages included in the plurality of UE-specific context modification requests to the UEs. Based on the determination at 939, the sDU 903 may output the plurality of RRC reconfigurations 940 such that the UE1 904 and the UE2 906 receive a corresponding RRC reconfiguration message included in the first UE-specific context modification request 936 and the second UE-specific context modification request 938, respectively. The sDU 903 may output, and the CU-UP 909 may obtain, a first UE-specific data delivery status frame 944 for the UE1 904 indicating, or associated with, the plurality of UEs. The first UE-specific data delivery status frame 944 may be provided in an updated and/or enhanced format that enables the indication that the first UE-specific data delivery status frame 944 is associated with a joint handover procedure and, in some aspects, the identity of related UEs and other relevant information. (e.g., includes all, or part, of the multi-modal information described above).

At 946, the CU-UP 909 may determine, based on the first UE-specific data delivery status frame 944 to stop forwarding, routing, and/or directing traffic (from the UPF 911) to the sDU 903. Based on the first UE-specific context modification request 936, the sDU 903 may output, and the CU-CP 907 may obtain, a first UE-specific context modification response 945. The first UE-specific context modification response 945, in some aspects, may indicate the multi-modal service ID and/or the plurality of UEs.

The sDU 903 may output, and the CU-UP 909 may obtain, a second UE-specific data delivery status frame 947 for the UE2 906 indicating, or associated with, the plurality of UEs. The second UE-specific data delivery status frame 947 may be provided in an updated and/or enhanced format that enables the indication that the second UE-specific data delivery status frame 947 is associated with a joint handover procedure and, in some aspects, the identity of related UEs and other relevant information. (e.g., includes all, or part, of the multi-modal information described above). Based on the second UE-specific context modification request 938, the sDU 903 may output, and the CU-CP 907 may obtain, a second UE-specific context modification response 948. The second UE-specific context modification response 948, in some aspects, may indicate the multi-modal service ID and/or the plurality of UEs. The UE-specific context modification requests and the UE-specific context modification responses shown at 936, 938, 945, and 948 may be F1-AP messages that are exchanged between the tDU 905 and the CU-CP 907 and include multi-modal information.

Based on the RRC reconfiguration included in the UE-specific context modification requests, the UE1 904 may perform a random access procedure 949. After performing the random access procedure 949, the UE1 904 may transmit, and the tDU 905 may receive, the RRC reconfiguration complete message 951. The tDU 905 may forward (or output), and the CU-CP 907 may obtain, the RRC reconfiguration complete message 952. Additionally, the tDU 905 may, based on the random access procedure 949, output, and the CU-UP 909 may obtain, a third UE-specific data delivery status 950 for the UE1 904. Based on an indication of additional UEs in the plurality of UEs associated with the joint handover procedure, the CU-UP 909 may wait, at 954, for additional UE-specific data delivery statuses from the additional UEs in the plurality of UEs.

Based on the RRC reconfiguration included in the UE-specific context modification requests, the UE2 906 may perform a random access procedure 955. After performing the random access procedure 955, the UE2 906 may transmit, and the tDU 905 may receive, the RRC reconfiguration complete message 957. The tDU 905 may forward (or output), and the CU-CP 907 may obtain, the RRC reconfiguration complete message 958. Additionally, the tDU 905 may, based on the random access procedure 955, output, and the CU-UP 909 may obtain, a fourth UE-specific data delivery status 956 for the UE2 906. Based on an indication of additional UEs in the plurality of UEs associated with the joint handover procedure, the CU-UP 909 may determine that each UE in the plurality of UEs has completed an RRC reconfiguration and begin, at 960, forwarding, routing, and/or directing traffic (from the UPF 911) to the tDU 905. For example, the UPF 911 may output, and the CU-UP 909 may obtain, DL data 961. The CU-UP 909 may output, and the tDU 905 may obtain, DL data 962 and the tDU 905 may transmit, and the UE1 904 and the UE2 906 may receive, DL data 963. In some aspects, the sDU 903 and the CU-CP 907 may exchange a set of UE-specific context release messages 966. For example, in some aspects, a UE context release command/complete message pair may be output/obtained for each of the plurality of UEs.

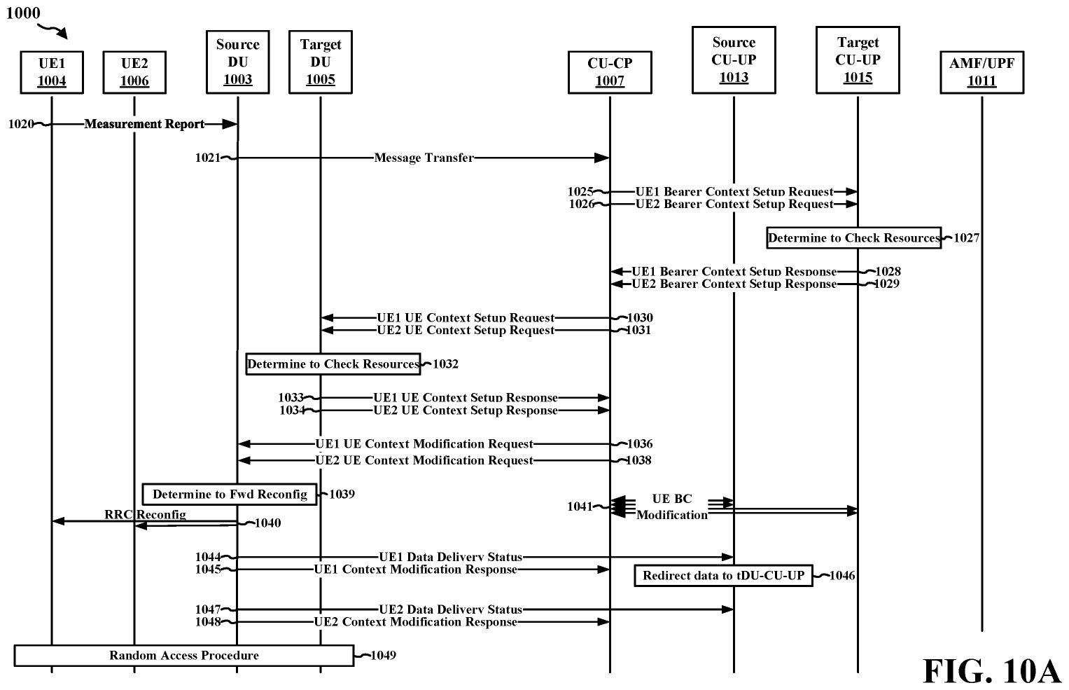

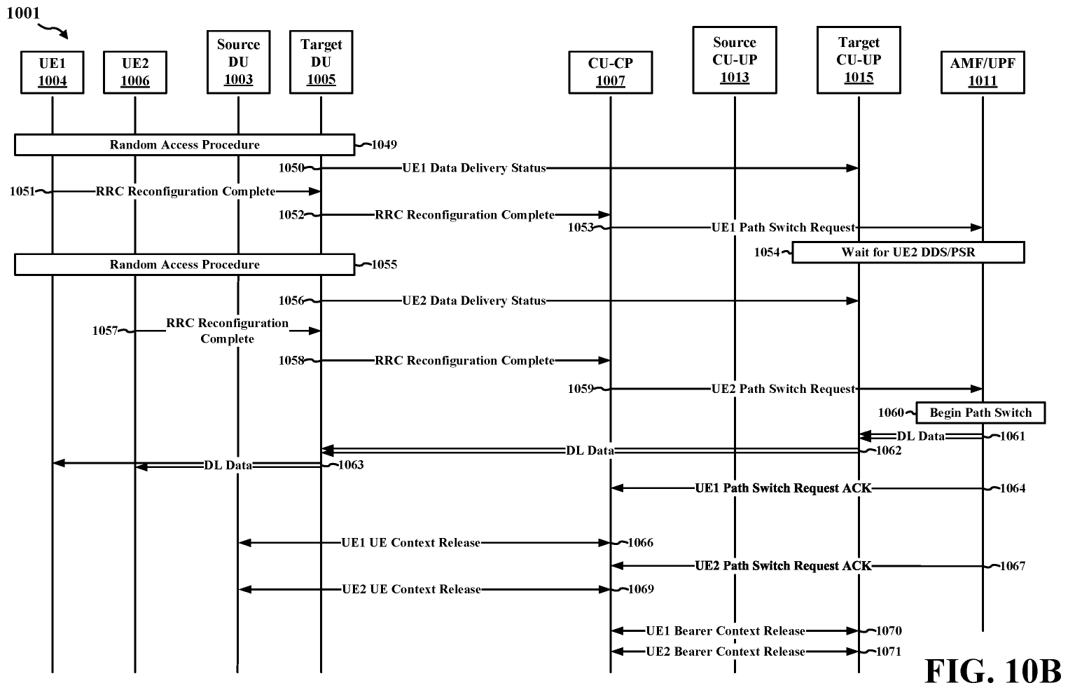

FIG. 10A is a call flow diagram 1000 illustrating a first portion of a method for a joint handover using UE-specific messages for a plurality of UEs in a second distributed architecture for an intra-CU-CP-inter-CU-UP-inter-DU handover in accordance with some aspects of the disclosure. FIG. 10B is a call flow diagram 1001 illustrating a second portion of the method for the joint handover using UE-specific messages for the plurality of UEs in the second distributed architecture in accordance with some aspects of the disclosure. The method is illustrated in relation to a first and second UE (e.g., UE1 1004 and UE2 1006) transferring from a source base station (sDU 1003) to a target base station (tDU 1005). For example, the handover may be from a first cell provided by the source DU to a second cell provided by the target DU. The method is also illustrated in relation to a network including a CU-CP 1007, a source CU-UP 1013, a target CU-UP 1015, and an AMF/UPF 1011 common to the sDU 1003 and the tDU 1005. The functions ascribed to the network, the sDU 1003, the tDU 1005, the CU-CP 1007, the source CU-UP 1013, the target CU-UP 1015, or the AMF/UPF 1011, in some aspects, may be described as being performed by one or more components of a network entity, a network node, or a network device (e.g., a component of a disaggregated network entity/node/device as described above in relation to FIG. 1) implementing the functionality of the network, the sDU 1003, the tDU 1005, the CU-CP 1007, the source CU-UP 1013, the target CU-UP 1015, or the AMF/UPF 1011. Accordingly, references to “transmitting” or “outputting” in the description below may be understood to refer to a first component of the network, the sDU 1003, the tDU 1005, the CU-CP 1007, the source CU-UP 1013, the target CU-UP 1015, or the AMF/UPF 1011 outputting (or providing) an indication of the content of the transmission to be transmitted by a different component of the network, the sDU 1003, the tDU 1005, the CU-CP 1007, the source CU-UP 1013, the target CU-UP 1015, or the AMF/UPF 1011. Similarly, references to “receiving” or “obtaining” in the description below may be understood to refer to a first component of the network, the sDU 1003, the tDU 1005, the CU-CP 1007, the source CU-UP 1013, the target CU-UP 1015, or the AMF/UPF 1011 receiving a transmitted signal and outputting (or providing) the received signal (or information based on the received signal) to a different component of the network, the sDU 1003, the tDU 1005, the CU-CP 1007, the source CU-UP 1013, the target CU-UP 1015, or the AMF/UPF 1011.

UE1 1004 and UE2 1006, in some aspects, may be two of a plurality of UEs (or wireless devices) associated with a same multi-modal service (e.g., an XR, AR, VR, or other service providing multiple modes and/or types of input/output via multiple wireless devices). The service, in some aspects, may be associated with multi-modal information including one or more of a service ID (or multi-modal service ID) and a plurality of flows (QOS flows), and a set of relationships between the flows in the plurality of flows. The relationships between flows, in some aspects, may indicate (or define) related flows (e.g., a specific relationship beyond being associated with the same multi-modal service) and inter-flow (or inter-QoS flow) synchronization thresholds for related and/or unrelated flows (see Table 2 above).

As described above, the plurality of UEs may include a headset providing audio/visual output and one or more other wearable devices providing tactile or haptic feedback (e.g., heat/cold and/or vibrations). As illustrated a first UE of the plurality of UEs, e.g., UE1 1004, may transmit, and the sDU 1003 may receive, a measurement report 1020 in some aspects. The measurement report 1020, in some aspects may trigger a handover (HO) procedure. Based on the measurement report the sDU 1003 may output, and CU-CP 1007 may obtain, the message transfer 1021. In some aspects, the message transfer 1021 may include the information included in the measurement report 1020. The CU-CP 1007, in some aspects, may determine, based on the message transfer 1021, to perform a HO procedure for the plurality of UEs (e.g., including at least UE1 1004 and UE2 1006) from the sDU 1003 to the tDU 1005.

To initiate the HO procedure, the CU-CP 1007 may output, and the target CU-UP 1015 may obtain, a first UE-specific bearer context setup request 1025 for the UE1 1004 and a second UE-specific bearer context setup request 1026 for the UE2 1006. In some aspects, the UE-specific bearer context setup requests may be provided in an updated and/or enhanced UE bearer context setup request that enables the indication that the UE-specific bearer context setup request is associated with a joint handover procedure and, in some aspects, the identity of related UEs and other relevant information. (e.g., includes all, or part, of the multi-modal information described above). For example, the UE-specific bearer context setup requests (and similar messages related to the HO procedure) may include “multi-modal” (or “group”) information. The multi-modal information, in some aspects, may include the multi-modal service ID associated with the plurality of UEs, a list of the UEs associated with the multi-modal service, a list of multi-modal flows associated with the multi-modal service and/or the plurality of UEs, and the relationships between the multi-modal flows associated with the multi-modal service (e.g., the synchronization thresholds associated with related flows).

The target CU-UP 1015 waits, in some aspects, until a UE-specific bearer context setup request is received from each of the plurality of UEs identified in a first UE-specific bearer context setup request to check for resources for the plurality of UEs. In call flow diagram 1000, based on receiving the first UE-specific bearer context setup request 1025 and the second UE-specific bearer context setup request 1026, the target CU-UP 1015 may determine, at 1027, to check for resources (e.g., to determine if sufficient resources are available) for the UE1 1004 and the UE2 1006. If the target CU-UP 1015 determines that the resources are available, the target CU-UP 1015, in some aspects, may output, and the CU-CP 1007 may obtain, a first UE-specific bearer context setup response 1028 for the UE1 1004 and a second UE-specific bearer context setup response 1029 for the UE2 1006. In some aspects, the UE-specific bearer context setup responses may be provided in an updated and/or enhanced UE bearer context setup response that enables the indication that the UE-specific bearer context setup response is associated with a joint handover procedure and, in some aspects, the identity of related UEs and other relevant information. (e.g., includes all, or part, of the multi-modal information described above).

After exchanging the messages associated with the bearer context setup (e.g., first UE-specific bearer context setup response 1028 and the second UE-specific bearer context setup response 1029), the CU-CP 1007 may output, and the tDU 1005 may obtain, a first UE-specific context setup request 1030 message for the UE1 1004 and a second UE-specific context setup request 1031 for the UE2 1006. In some aspects, the UE-specific context setup requests (e.g., the first UE-specific context setup request 1030 and the second UE-specific context setup request 1031) may be provided in an updated and/or enhanced UE context setup request that enables the indication that the UE-specific context setup request is associated with a joint handover procedure and, in some aspects, the identity of related UEs and other relevant information. The UE-specific context setup requests (and subsequent messages related to the HO procedure) may include “multi-modal” (or “group”) information. The multi-modal information, in some aspects, may include the multi-modal service ID associated with the plurality of UEs, a list of the UEs associated with the multi-modal service, a list of multi-modal flows associated with the multi-modal service and/or the plurality of UEs, and the relationships between the multi-modal flows associated with the multi-modal service (e.g., the synchronization thresholds associated with related flows).

The tDU 1005, in some aspects, may wait until receiving UE-specific context setup requests from each of the plurality of UEs associated with (or identified by) a first UE-specific context setup request output before determining, at 1032, to check resources for the plurality of UEs. For example, the tDU 1005 may, upon receiving first UE-specific context setup request 1030, identify that the UE1 1004 and the UE2 1006 are associated with a joint handover procedure and wait until a UE-specific context setup request is received for both the UE1 1004 and the UE2 1006 before determining to check (and checking) for available resources for both UEs. Checking for resources, in some aspects, may be based at least in part on the relationships and/or synchronization thresholds indicated in the multi-modal information included in the first UE-specific context setup request 1030 and/or the second UE-specific context setup request 1031.

After checking for available resources, the tDU 1005 may output, and the CU-CP 1007 may obtain, a first UE-specific context setup response 1033 for the UE1 1004 and a second UE-specific context setup response 1034 for the UE2 1006. The UE-specific context setup responses may be provided in an updated and/or enhanced UE context setup response that enables the indication that the UE-specific context setup request is associated with a joint handover procedure and, in some aspects, the identity of related UEs and other relevant information. (e.g., includes all, or part, of the multi-modal information described above). The UE-specific context setup request and the UE-specific context setup response shown at 1030, 1031, 1033, and 1034 may be F1-AP messages that are exchanged between the tDU 1005 and the CU-CP 1007 and include multi-modal information.

Based on the first UE-specific context setup response 1033 and the second UE-specific context setup response 1034, the CU-CP 1007, in some aspects, may output, and the sDU 1003 may obtain, a first UE-specific context modification request 1036 for the UE1 1004 and a second UE-specific context modification request 1038 for the UE2 1006. Each UE-specific context modification request, in some aspects, may include an RRC reconfiguration message for one UE in the plurality of UEs. As for the UE-specific context setup request/response, a UE-specific context modification request may be provided in an updated and/or enhanced format that enables the indication that the UE-specific context modification request is associated with a joint handover procedure and, in some aspects, the identity of related UEs and other relevant information. (e.g., includes all, or part, of the multi-modal information described above).

The sDU 1003 may, upon receiving a UE-specific context modification request for each UE identified as being associated with the joint handover procedure, determine, at 1039, to forward the plurality of RRC reconfiguration messages included in the plurality of UE-specific context modification requests to the UEs. Based on the determination at 1039, the sDU 1003 may output the plurality of RRC reconfigurations 1040 such that the UE1 1004 and the UE2 1006 receive a corresponding RRC reconfiguration message included in the first UE-specific context modification request 1036 and the second UE-specific context modification request 1038, respectively. Based on the first UE-specific bearer context setup request 1025, the second UE-specific bearer context setup request 1026, the first UE-specific bearer context setup response 1028, and the second UE-specific bearer context setup response 1029, the CU-CP 1007 may exchange, with the source CU-UP 1013 and the target CU-UP 1015, a set of UE bearer context modification messages 1041 (e.g., UE bearer context modification requests and responses). The set of UE bearer context modification messages 1041, in some aspects, may include a UE bearer context modification request and response for each of the plurality of UEs exchanged with each of the source CU-UP 1013 and the target CU-UP 1015.

The sDU 1003 may output, and the source CU-UP 1013 may obtain, a first UE-specific data delivery status frame 1044 for the UE1 1004 indicating, or associated with, the plurality of UEs. The first UE-specific data delivery status frame 1044 may be provided in an updated and/or enhanced format that enables the indication that the first UE-specific data delivery status frame 1044 is associated with a joint handover procedure and, in some aspects, the identity of related UEs and other relevant information. (e.g., includes all, or part, of the multi-modal information described above).

At 1046, the source CU-UP 1013 may determine, based on the first UE-specific data delivery status frame 1044 to redirect (to begin forwarding, routing, and/or directing traffic (from the UPF 1011) to the target CU-UP 1015. Based on the first UE-specific context modification request 1036, the sDU 1003 may output, and the CU-CP 1007 may obtain, a first UE-specific context modification response 1045. The first UE-specific context modification response 1045, in some aspects, may indicate the multi-modal service ID and/or the plurality of UEs.

The sDU 1003 may output, and the source CU-UP 1013 may obtain, a second UE-specific data delivery status frame 1047 for the UE2 1006 indicating, or associated with, the plurality of UEs. The second UE-specific data delivery status frame 1047 may be provided in an updated and/or enhanced format that enables the indication that the second UE-specific data delivery status frame 1047 is associated with a joint handover procedure and, in some aspects, the identity of related UEs and other relevant information. (e.g., includes all, or part, of the multi-modal information described above). Based on the second UE-specific context modification request 1038, the sDU 1003 may output, and the CU-CP 1007 may obtain, a second UE-specific context modification response 1048. The second UE-specific context modification response 1048, in some aspects, may indicate the multi-modal service ID and/or the plurality of UEs. The UE-specific context modification requests and the UE-specific context modification responses shown at 1036, 1038, 1045, and 1048 may be F1-AP messages that are exchanged between the tDU 1005 and the CU-CP 1007 and include multi-modal information.

Based on the RRC reconfiguration included in the UE-specific context modification requests, the UE1 1004 may perform a random access procedure 1049 of FIG. 10A corresponding to the random access procedure 1049 of FIG. 10B. The tDU 1005 may, based on the random access procedure 1049, output, and the target CU-UP 1015 may obtain, a third UE-specific data delivery status 1050 for the UE1 1004. After performing the random access procedure 1049, the UE1 1004 may transmit, and the tDU 1005 may receive, the RRC reconfiguration complete message 1051. The tDU 1005 may forward (or output), and the CU-CP 1007 may obtain, the RRC reconfiguration complete message 1052. Based on the RRC reconfiguration complete message 1052, the CU-CP 1007 may output, and the AMF/UPF 1011 may obtain, a first UE-specific path switch request 1053 for the UE1 1004. In some aspects, the third UE-specific data delivery status 1050 and the first UE-specific path switch request 1053 for the UE1 1004 may include an indication of additional UEs in the plurality of UEs (e.g., at least UE2 1006) associated with the joint handover procedure. Based on the indication of additional UEs in the plurality of UEs associated with the joint handover procedure, the target CU-UP 1015 and the AMF/UPF 1011 may wait, at 1054, for additional UE-specific data delivery statuses and path switch requests from the additional UEs in the plurality of UEs.

Based on the RRC reconfiguration included in the UE-specific context modification requests, the UE2 1006 may perform a random access procedure 1055. The tDU 1005 may, based on the random access procedure 1055, output, and the target CU-UP 1015 may obtain, a fourth UE-specific data delivery status 1056 for the UE2 1006. In some aspects, the fourth UE-specific data delivery status 1056 for the UE2 1006 may include an indication of additional UEs in the plurality of UEs (e.g., at least UE2 1006) associated with the joint handover procedure. Based on the indication of the additional UEs in the plurality of UEs associated with the joint handover procedure in the fourth UE-specific data delivery status 1056, the target CU-UP 1015 may begin forwarding, routing, and/or directing traffic (from the AMF/UPF 1011) to the tDU 1005. After performing the random access procedure 1055, the UE2 1006 may transmit, and the tDU 1005 may receive, the RRC reconfiguration complete message 1057. The tDU 1005 may forward (or output), and the CU-CP 1007 may obtain, the RRC reconfiguration complete message 1058. Based on the RRC reconfiguration complete message 1058, the CU-CP 1007 may output, and the AMF/UPF 1011 may obtain, a second UE-specific path switch request 1059 for the UE2 1006. In some aspects, the second UE-specific path switch request 1059 for the UE2 1006 may include an indication of additional UEs in the plurality of UEs (e.g., at least UE2 1006) associated with the joint handover procedure. Based on the second UE-specific path switch request 1059, the AMF/UPF 1011 may determine, at 1060, to switch the path for the plurality of UEs. For example, based on the determination at 1060, the AMF/UPF 1011 may output, and the target CU-UP 1015 may obtain, DL data 1061. The target CU-UP 1015 may output, and the tDU 1005 may obtain, DL data 1062 and the tDU 1005 may transmit, and the UE1 1004 and the UE2 1006 may receive, DL data 1063.

The AMF/UPF 1011, in some aspects, may output, and the CU-CP 1007 may obtain, a first UE-specific path switch request acknowledgment 1064 for the UE1 1004. The CU-CP 1007 may, based on the first UE-specific path switch request acknowledgment 1064, exchange UE context release messages 1066 for the UE1 1004 with the sDU 1003. UE context release messages 1066, in some aspects, may include a UE context release command message and a UE context release complete message for the UE1 1004. The AMF/UPF 1011, in some aspects, may output, and the CU-CP 1007 may obtain, a second UE-specific path switch request acknowledgment 1067 for the UE2 1006. The CU-CP 1007 may, based on the second UE-specific path switch request acknowledgment 1067, exchange UE context release messages 1069 for the UE2 1006 with the sDU 1003. UE context release messages 1069, in some aspects, may include a UE context release command message and a UE context release complete message for the UE2 1006. Similarly, the CU-CP 1007, may exchange, with target CU-UP 1015, a first set of UE bearer context release messages 1070 for the UE1 1004 and a second set of UE bearer context release messages 1071 for the UE2 1006 associated with UE bearer context release. For example, the CU-CP 1007 may output, and the target CU-UP 1015 may obtain, a UE bearer context release command message and the target CU-UP 1015 may output, and the CU-CP 1007 may obtain, a UE bearer context release complete message for each UE in the plurality of UEs (e.g., for at least UE1 1004 and UE2 1006).

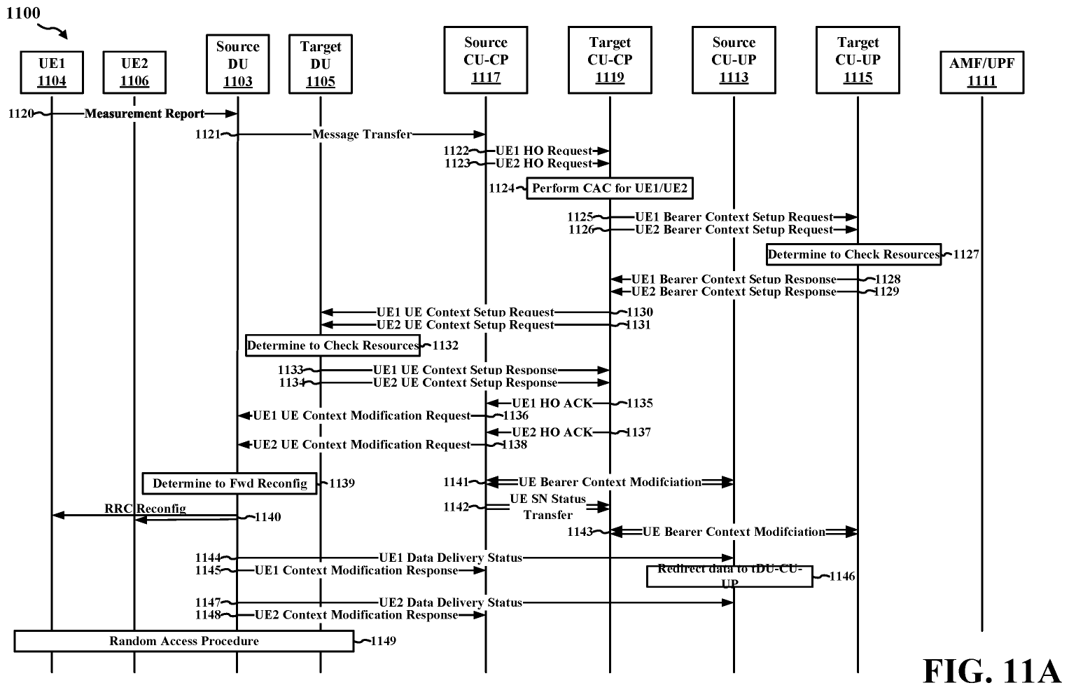

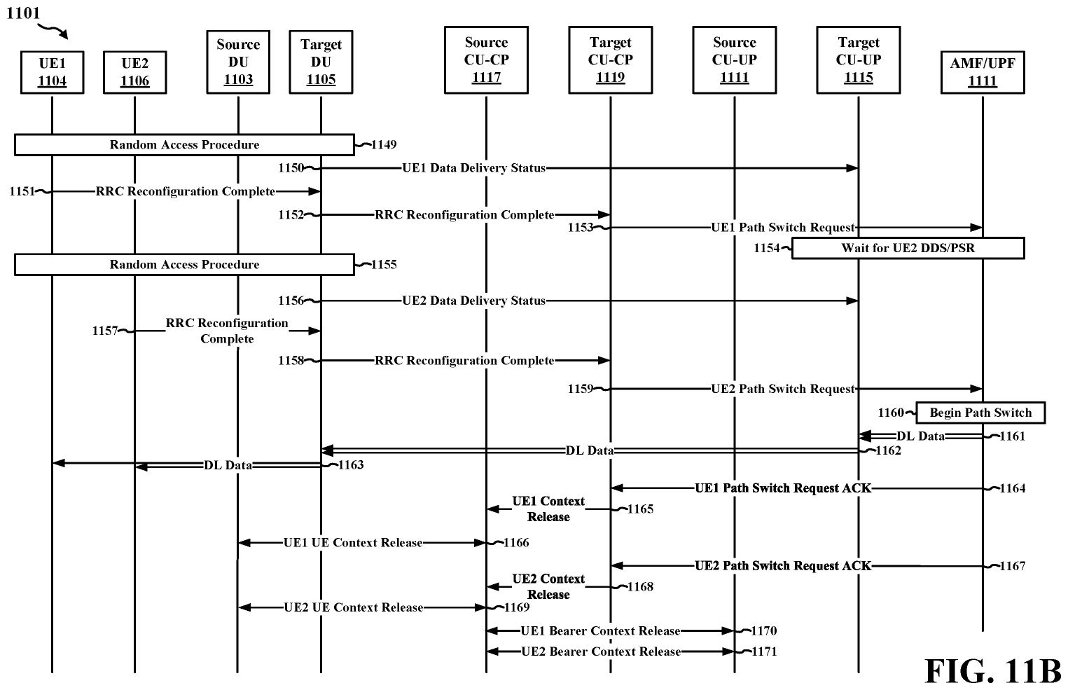

FIG. 11A is a call flow diagram 1100 illustrating a first portion of a method for a joint handover using common messages for a plurality of UEs in a third distributed architecture for an inter-CU-CP-inter-CU-UP-inter-DU handover in accordance with some aspects of the disclosure. FIG. 11B is a call flow diagram 1101 illustrating a second portion of a method for a joint handover using common messages for a plurality of UEs in a third distributed architecture in accordance with some aspects of the disclosure. The method is illustrated in relation to a first and second UE (e.g., UE1 1104 and UE2 1106) transferring from a source base station (sDU 1103) to a target base station (tDU 1105). For example, the handover may be from a first cell provided by the sDU 1103 to a second cell provided by the tDU 1105. The method is also illustrated in relation to a network including a source CU-CP 1117, a target CU-CP 1119, a source CU-UP 1113, a target CU-UP 1115, and an AMF/UPF 1111 common to the sDU 1103 and the tDU 1105. The functions ascribed to the network including the source CU-CP 1117, the target CU-CP 1119, the source CU-UP 1113, the target CU-UP 1115, or the AMF/UPF 1111, in some aspects, may be performed by one or more components of a network entity, a network node, or a network device (e.g., a component of a disaggregated network entity/node/device as described above in relation to FIG. 1) implementing the functionality of the network including the source CU-CP 1117, the target CU-CP 1119, the source CU-UP 1113, the target CU-UP 1115, or the AMF/UPF 1111. Accordingly, references to “transmitting” or “outputting” in the description below may be understood to refer to a first component of the network including the source CU-CP 1117, the target CU-CP 1119, the source CU-UP 1113, the target CU-UP 1115, or the AMF/UPF 1111 outputting (or providing) an indication of the content of the transmission to be transmitted by a different component of the network including the source CU-CP 1117, the target CU-CP 1119, the source CU-UP 1113, the target CU-UP 1115, or the AMF/UPF 1111. Similarly, references to “receiving” or “obtaining” in the description below may be understood to refer to a first component of the network including the source CU-CP 1117, the target CU-CP 1119, the source CU-UP 1113, the target CU-UP 1115, or the AMF/UPF 1111 receiving a transmitted signal and outputting (or providing) the received signal (or information based on the received signal) to a different component of the network including the source CU-CP 1117, the target CU-CP 1119, the source CU-UP 1113, the target CU-UP 1115, or the AMF/UPF 1111.

The UE1 1104 and the UE2 1106 may exchange data with a server via the sDU 1103, source CU-UP 1113, and AMF/UPF 1111, e.g., as described in connection with FIG. 6. The UE1 1104 and UE2 1106, in some aspects, may be two of a plurality of UEs (or wireless devices) associated with a same multi-modal service (e.g., an XR, AR, VR, or other service providing multiple modes and/or types of input/output via multiple wireless devices). The service, in some aspects, may be associated with multi-modal information including one or more of a service ID (or multi-modal service ID) and a plurality of flows (QOS flows), and a set of relationships between the flows in the plurality of flows. The relationships between flows, in some aspects, may indicate (or define) related flows (e.g., a specific relationship beyond being associated with the same multi-modal service) and inter-flow (or inter-QoS flow) synchronization thresholds for related and/or unrelated flows (see Table 2 above). As described above, the plurality of UEs may include a headset providing audio/visual output and one or more other wearable devices providing tactile or haptic feedback (e.g., heat/cold and/or vibrations). As illustrated a first UE of the plurality of UEs, e.g., UE1 1104, may transmit, and the sDU 1103 may receive, a measurement report 1120 in some aspects. The measurement report 1120, in some aspects may trigger a handover (HO) procedure. Based on the measurement report the sDU 1103 may output, and source CU-CP may obtain, the message transfer 1121. In some aspects, the message transfer 1121 may include the information included in the measurement report 1120. The source CU-CP 1117, in some aspects, may determine, based on the message transfer 1121, to perform a HO procedure for the plurality of UEs (e.g., including at least UE1 1104 and UE2 1106) from the sDU 1103 to the tDU 1105. To initiate the HO procedure, the source CU-CP 1117 may output, and the target CU-CP 1119 may obtain, a first UE-specific handover request 1122 for the UE1 1104 and second UE-specific handover request 1123 for the UE2 1106. In some aspects, the first UE-specific handover request 1122 and the second UE-specific handover request 1123 may include the multi-modal information to identify the plurality of UEs. The target CU-CP 1119, in some aspects, may wait to receive UE-specific handover requests from each UE identified in the UE-specific handover requests (e.g., the first UE-specific handover request 1122 and the second UE-specific handover request 1123) before performing, at 1124, a call admission control for the plurality of UEs and requesting the setup of resources in the target CU-UP 1115.

After receiving the UE-specific handover requests from each UE identified in the UE-specific handover requests (e.g., the first UE-specific handover request 1122 and the second UE-specific handover request 1123), the target CU-CP 1119 may output, and the target CU-UP 1115 may obtain, a first UE-specific bearer context setup request 1125 for the UE1 1104 and a second UE-specific bearer context setup request 1126 for the UE2 1106. In some aspects, the UE-specific bearer context setup requests may be provided in an updated and/or enhanced UE bearer context setup request that enables the indication that the UE-specific bearer context setup request is associated with a joint handover procedure and, in some aspects, the identity of related UEs and other relevant information. (e.g., includes all, or part, of the multi-modal information described above). For example, the UE-specific bearer context setup requests (and similar messages related to the HO procedure) may include “multi-modal” (or “group”) information. The multi-modal information, in some aspects, may include the multi-modal service ID associated with the plurality of UEs, a list of the UEs associated with the multi-modal service, a list of multi-modal flows associated with the multi-modal service and/or the plurality of UEs, and the relationships between the multi-modal flows associated with the multi-modal service (e.g., the synchronization thresholds associated with related flows).

The target CU-UP 1115 waits, in some aspects, until a UE-specific bearer context setup request is received from each of the plurality of UEs identified in a first UE-specific bearer context setup request to check for resources for the plurality of UEs. In call flow diagram 1100, based on receiving the first UE-specific bearer context setup request 1125 and the second UE-specific bearer context setup request 1126, the target CU-UP 1115 may determine, at 1127, to check for resources (e.g., to determine if sufficient resources are available) for the UE1 1104 and the UE2 1106. If the target CU-UP 1115 determines that the resources are available, the target CU-UP 1115, in some aspects, may output, and the target CU-CP 1119 may obtain, a first UE-specific bearer context setup response 1128 for the UE1 1104 and a second UE-specific bearer context setup response 1129 for the UE2 1106. In some aspects, the UE-specific bearer context setup responses may be provided in an updated and/or enhanced UE bearer context setup response that enables the indication that the UE-specific bearer context setup response is associated with a joint handover procedure and, in some aspects, the identity of related UEs and other relevant information. (e.g., includes all, or part, of the multi-modal information described above).

After exchanging the messages associated with the bearer context setup (e.g., first UE-specific bearer context setup response 1128 and the second UE-specific bearer context setup response 1129), the target CU-CP 1119 may output, and the tDU 1105 may obtain, a first UE-specific context setup request 1130 message for the UE1 1104 and a second UE-specific context setup request 1131 for the UE2 1106. In some aspects, the UE-specific context setup requests (e.g., the first UE-specific context setup request 1130 and the second UE-specific context setup request 1131) may be provided in an updated and/or enhanced UE context setup request that enables the indication that the UE-specific context setup request is associated with a joint handover procedure and, in some aspects, the identity of related UEs and other relevant information. The UE-specific context setup requests (and subsequent messages related to the HO procedure) may include “multi-modal” (or “group”) information. The multi-modal information, in some aspects, may include the multi-modal service ID associated with the plurality of UEs, a list of the UEs associated with the multi-modal service, a list of multi-modal flows associated with the multi-modal service and/or the plurality of UEs, and the relationships between the multi-modal flows associated with the multi-modal service (e.g., the synchronization thresholds associated with related flows).

The tDU 1105, in some aspects, may wait until receiving UE-specific context setup requests from each of the plurality of UEs associated with (or identified by) a first UE-specific context setup request output before determining, at 1132, to check resources for the plurality of UEs. For example, the tDU 1105 may, upon receiving first UE-specific context setup request 1130, identify that the UE1 1104 and the UE2 1106 are associated with a joint handover procedure and wait until a UE-specific context setup request is received for both the UE1 1104 and the UE2 1106 before determining to check (and checking) for available resources for both UEs. Checking for resources, in some aspects, may be based at least in part on the relationships and/or synchronization thresholds indicated in the multi-modal information included in the first UE-specific context setup request 1130 and/or the second UE-specific context setup request 1131.

After checking for available resources, the tDU 1105 may output, and the target CU-CP 1119 may obtain, a first UE-specific context setup response 1133 for the UE1 1104 and a second UE-specific context setup response 1134 for the UE2 1106. The UE-specific context setup responses may be provided in an updated and/or enhanced UE context setup response that enables the indication that the UE-specific context setup request is associated with a joint handover procedure and, in some aspects, the identity of related UEs and other relevant information. (e.g., includes all, or part, of the multi-modal information described above).

Based on the first UE-specific context setup response 1133 and the second UE-specific context setup response 1134, the target CU-CP 1119 may output, and the source CU-CP 1117 may obtain, a first UE-specific handover request acknowledgment 1135 for the UE1 1104 and a second UE-specific handover request acknowledgment 1137 for the UE2 1106. Based on the first UE-specific handover request acknowledgment 1135 and the second UE-specific handover request acknowledgment 1137, the source CU-CP 1117, in some aspects, may output, and the sDU 1103 may obtain, a first UE-specific context modification request 1136 for the UE1 1104 and a second UE-specific context modification request 1138 for the UE2 1106. Each UE-specific context modification request, in some aspects, may include an RRC reconfiguration message for one UE in the plurality of UEs. As for the UE-specific context setup request/response, a UE-specific context modification request may be provided in an updated and/or enhanced format that enables the indication that the UE-specific context modification request is associated with a joint handover procedure and, in some aspects, the identity of related UEs and other relevant information. (e.g., includes all, or part, of the multi-modal information described above).

The sDU 1103 may, upon receiving a UE-specific context modification request for each UE identified as being associated with the joint handover procedure, determine, at 1139, to forward the plurality of RRC reconfiguration messages included in the plurality of UE-specific context modification requests to the UEs. Based on the determination at 1139, the sDU 1103 may output the plurality of RRC reconfigurations 1140 such that the UE1 1104 and the UE2 1106 receive a corresponding RRC reconfiguration message included in the first UE-specific context modification request 1136 and the second UE-specific context modification request 1138, respectively. Based on the first UE-specific handover request acknowledgment 1135 and the second UE-specific handover request acknowledgment 1137, the source CU-CP 1117 may exchange, with the source CU-UP 1113, a set of UE bearer context modification messages 1141 (e.g., UE bearer context modification requests and responses). The set of UE bearer context modification messages 1141, in some aspects, may include a UE bearer context modification request and response for each of the plurality of UEs exchanged with the source CU-UP 1113.

In parallel with the RRC reconfiguration and/or the UE-specific context modification, the source CU-CP 1117 may, in association with the source CU-UP 1113, perform a UE bearer context modification (e.g., by exchanging UE bearer context modification messages 1141) and may output a set of SN status transfer messages 1142 indicating that the source CU-UP 1113 will stop assigning SNs. The target CU-CP 1119 may, in association with the target CU-UP 1115, perform a UE bearer context modification (e.g., by exchanging UE bearer context modification messages 1143). The bearer context modification for the source CU-UP 1113 and the target CU-UP 1115 may each be associated with a separate UE bearer modification request/response pair for each UE in the plurality of UEs (e.g., a request/response pair for each of the UE1 1104 and the UE2 1106) while the SN status transfer may be associated with a UE-specific SN status transfer for each of the UEs in the plurality of UEs.

The sDU 1103 may output, and the source CU-UP 1113 may obtain, a first UE-specific data delivery status frame 1144 for the UE1 1104 indicating, or associated with, the plurality of UEs. The first UE-specific data delivery status frame 1144 may be provided in an updated and/or enhanced format that enables the indication that the first UE-specific data delivery status frame 1144 is associated with a joint handover procedure and, in some aspects, the identity of related UEs and other relevant information. (e.g., includes all, or part, of the multi-modal information described above).

At 1146, the source CU-UP 1113 may determine, based on the first UE-specific data delivery status frame 1144 to redirect (to begin forwarding, routing, and/or directing traffic (from the UPF 1111) to the target CU-UP 1115. Based on the first UE-specific context modification request 1136, the sDU 1103 may output, and the source CU-CP 1117 may obtain, a first UE-specific context modification response 1145. The first UE-specific context modification response 1145, in some aspects, may indicate the multi-modal service ID and/or the plurality of UEs. Based on the second UE-specific context modification request 1138, the sDU 1103 may output, and the source CU-CP 1117 may obtain, a second UE-specific context modification response 1148. The second UE-specific context modification response 1148, in some aspects, may indicate the multi-modal service ID and/or the plurality of UEs.

The sDU 1103 may output, and the source CU-UP 1113 may obtain, a second UE-specific data delivery status frame 1147 for the UE2 1106 indicating, or associated with, the plurality of UEs. The second UE-specific data delivery status frame 1147 may be provided in an updated and/or enhanced format that enables the indication that the second UE-specific data delivery status frame 1147 is associated with a joint handover procedure and, in some aspects, the identity of related UEs and other relevant information. (e.g., includes all, or part, of the multi-modal information described above).

Based on the RRC reconfiguration included in the UE-specific context modification requests, the UE1 1104 may perform a random access procedure 1149 of FIG. 11A corresponding to the random access procedure 1149 of FIG. 11B. The tDU 1105 may, based on the random access procedure 1149, output, and the target CU-UP 1115 may obtain, a third UE-specific data delivery status 1150 for the UE1 1104. After performing the random access procedure 1149, the UE1 1104 may transmit, and the tDU 1105 may receive, the RRC reconfiguration complete message 1151. The tDU 1105 may forward (or output), and the target CU-CP 1119 may obtain, the RRC reconfiguration complete message 1152. Based on the RRC reconfiguration complete message 1152, the target CU-CP 1119 may output, and the AMF/UPF 1111 may obtain, a first UE-specific path switch request 1153 for the UE1 1104. In some aspects, the third UE-specific data delivery status 1150 and the first UE-specific path switch request 1153 for the UE1 1104 may include an indication of additional UEs in the plurality of UEs (e.g., at least UE2 1106) associated with the joint handover procedure. Based on the indication of additional UEs in the plurality of UEs associated with the joint handover procedure, the target CU-UP 1115 and the AMF/UPF 1111 may wait, at 1154, for additional UE-specific data delivery statuses and path switch requests from the additional UEs in the plurality of UEs.

Based on the RRC reconfiguration included in the UE-specific context modification requests, the UE2 1106 may perform a random access procedure 1155. The tDU 1105 may, based on the random access procedure 1155, output, and the target CU-UP 1115 may obtain, a fourth UE-specific data delivery status 1156 for the UE2 1106. In some aspects, the fourth UE-specific data delivery status 1156 for the UE2 1106 may include an indication of additional UEs in the plurality of UEs (e.g., at least UE2 1106) associated with the joint handover procedure. Based on the indication of the additional UEs in the plurality of UEs associated with the joint handover procedure in the fourth UE-specific data delivery status 1156, the target CU-UP 1115 may begin forwarding, routing, and/or directing traffic (from the AMF/UPF 1111) to the tDU 1105. After performing the random access procedure 1155, the UE2 1106 may transmit, and the tDU 1105 may receive, the RRC reconfiguration complete message 1157. The tDU 1105 may forward (or output), and the target CU-CP 1119 may obtain, the RRC reconfiguration complete message 1158. Based on the RRC reconfiguration complete message 1158, the target CU-CP 1119 may output, and the AMF/UPF 1111 may obtain, a second UE-specific path switch request 1159 for the UE2 1106. In some aspects, the second UE-specific path switch request 1159 for the UE2 1106 may include an indication of additional UEs in the plurality of UEs (e.g., at least UE2 1106) associated with the joint handover procedure. Based on the second UE-specific path switch request 1159, the AMF/UPF 1111 may determine, at 1160, to switch the path for the plurality of UEs. For example, based on the determination at 1160, the AMF/UPF 1111 may output, and the target CU-UP 1115 may obtain, DL data 1161. The target CU-UP 1115 may output, and the tDU 1105 may obtain, DL data 1162 and the tDU 1105 may transmit, and the UE1 1104 and the UE2 1106 may receive, DL data 1163.

The AMF/UPF 1111, in some aspects, may output, and the target CU-CP 1119 may obtain, a first UE-specific path switch request acknowledgment 1164 for the UE1 1104. Based on the first UE-specific path switch request acknowledgment 1164, the target CU-CP 1119 may output, and the source CU-CP 1117 may obtain, a first UE-specific context release 1165 for the UE1 1104. The source CU-CP 1117 may, based on the first UE-specific context release 1165, exchange UE context release messages 1166 for the UE1 1104 with the sDU 1103. UE context release messages 1166, in some aspects, may include a UE context release command message and a UE context release complete message for the UE1 1104.

The AMF/UPF 1111, in some aspects, may output, and the target CU-CP 1119 may obtain, a second UE-specific path switch request acknowledgment 1167 for the UE2 1106. Based on the second UE-specific path switch request acknowledgment 1167, the target CU-CP 1119 may output, and the source CU-CP 1117 may obtain, a second UE-specific context release 1168 for the UE2 1106. The source CU-CP 1117 may, based on the second UE-specific context release 1168, exchange UE context release messages 1169 for the UE1 1104 with the sDU 1103. UE context release messages 1169, in some aspects, may include a UE context release command message and a UE context release complete message for the UE2 1106.

Similarly, the source CU-CP 1117, may exchange, with source CU-UP 1113, a first set of UE bearer context release messages 1170 for the UE1 1104 and a second set of UE bearer context release messages 1171 for the UE2 1106 associated with UE bearer context release. For example, the source CU-CP 1117 may output, and the source CU-UP 1113 may obtain, a UE bearer context release command message and the source CU-UP 1113 may output, and the source CU-CP 1117 may obtain, a UE bearer context release complete message for each UE in the plurality of UEs (e.g., for at least UE1 1104 and UE2 1106).

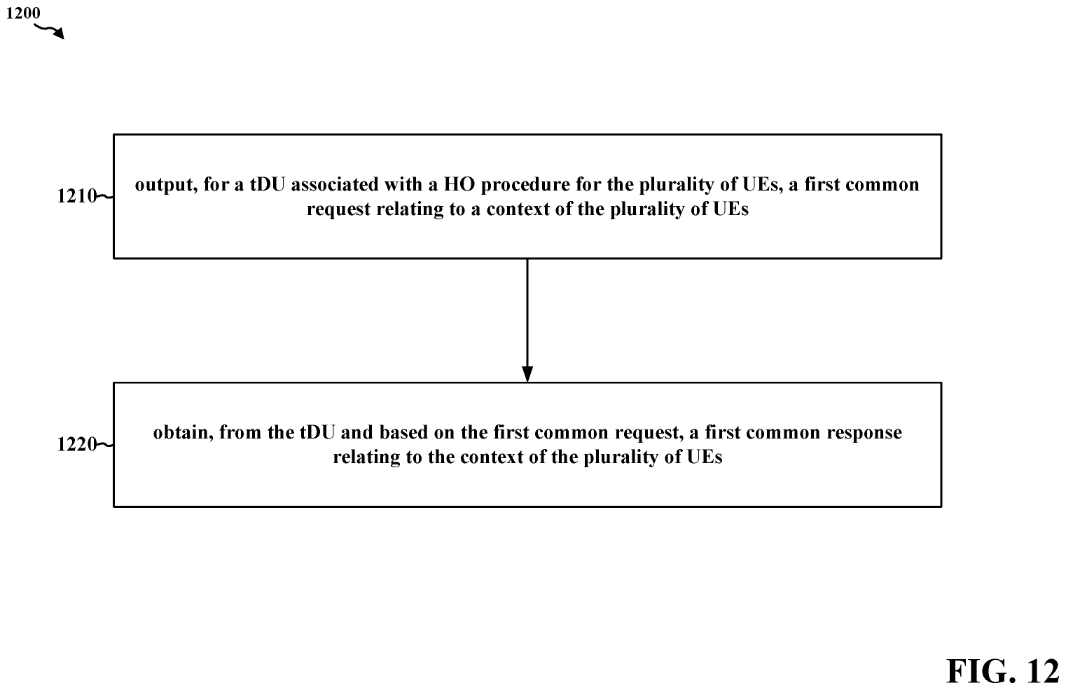

FIG. 12 is a flowchart 1200 of a method of wireless communication. The method may be performed by one or more of a network, a network component, or a network device (e.g., the base station 102; the sDU 603, 703, 803; the tDU 605, 705, 805; the CU-CP 607, 707; the CU-UP 609; the AMF/UPF 711, 811; the source CU-UP 713, 813; the target CU-UP 715, 815; the source CU-CP 817; the target CU-CP 819; the network entity 2602, 2760). In some aspects, the method may be associated with a joint and/or common handover performed for a plurality of UEs (as an example of wireless devices) associated with a multi-modal service in a distributed architecture as discussed in any of FIGS. 6, 7, and 8. The joint and/or common handover, in some aspects, may be for a handover from (1) a source base station or DU (an sBS or sDU) currently serving and/or connected to the plurality of UEs to (2) a target base station or DU (a tBS or tDU). The plurality of UEs may be associated with multi-modal information as discussed above in relation to FIGS. 6, 7, and 8 and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be a CU associated with a CP (a “CU-CP” associated with, or implementing, CP functions), and may receive a measurement report (or information regarding a measurement report) from a sDU associated with the plurality of UEs. The measurement report, in some aspects, may include information triggering the joint and/or common handover procedure for the plurality of UEs. For example, referring to FIGS. 6, 7, and 8, the CU-CP 607, the CU-CP 707, and the source CU-CP 817 may obtain, from sDU 603, 703, and 803 the message transfer 632, 732, and 832.

If the CU-CP for the sDU (e.g., the source CU-CP 817) is not the same as the CU-CP for the tDU (e.g., the target CU-CP 819), the CU-CP for the sDU may output, and the CU-CP for the tDU may obtain, a common handover request for the plurality of UEs. In some aspects, the common handover request may include multi-modal information indicating at least the plurality of UEs. For example, referring to FIG. 8, the source CU-CP 817 may output, and the target CU-CP 819 may obtain, common handover request 834.

In some aspects, the CU-CP for the tDU may, based on the common handover request for the plurality of UEs, output a common bearer context setup message for the plurality of UEs and obtain a common bearer context response for the plurality of UEs. In some aspects, the common bearer context setup message and the common bearer context response may include multi-modal information and may be exchanged with (output to, or obtained from, a CU device associated with a UP (a “CU-UP”) such as a CU-UP associated with the tDU (e.g., a target CU-UP). For example, referring to FIGS. 7, and 8, the CU-CP 707 and the target CU-CP 819 may output, and the target CU-UP 715 and 815 may obtain, a common bearer context setup request and the target CU-UP 715 and 815 may output, and the CU-CP 707 and the target CU-CP 819 may obtain, a common bearer context setup response as part of common context setup 736 or 836.

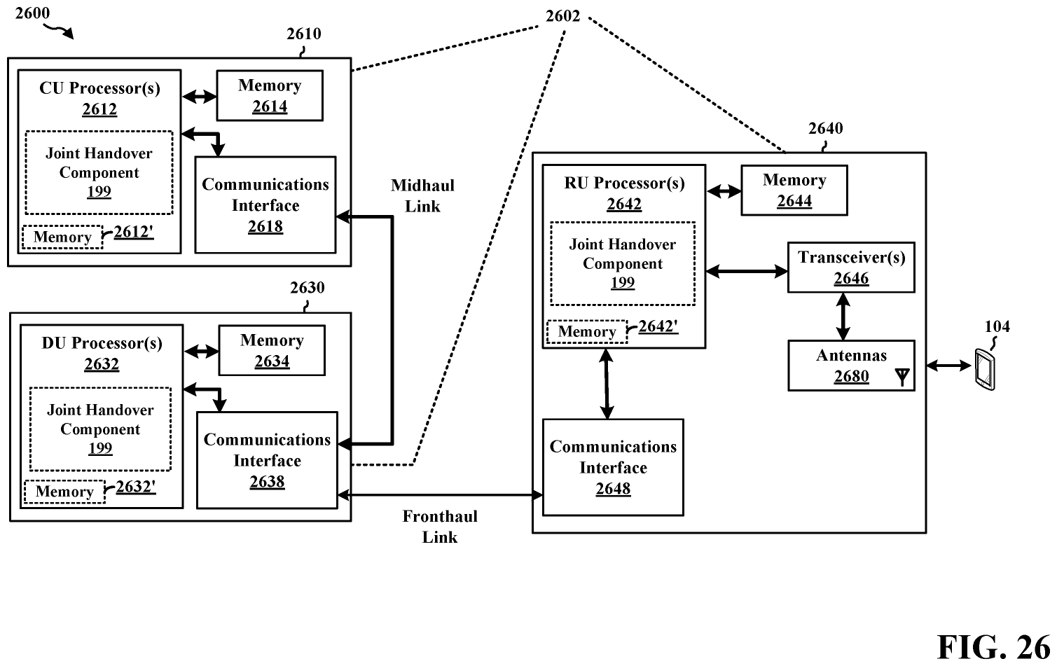

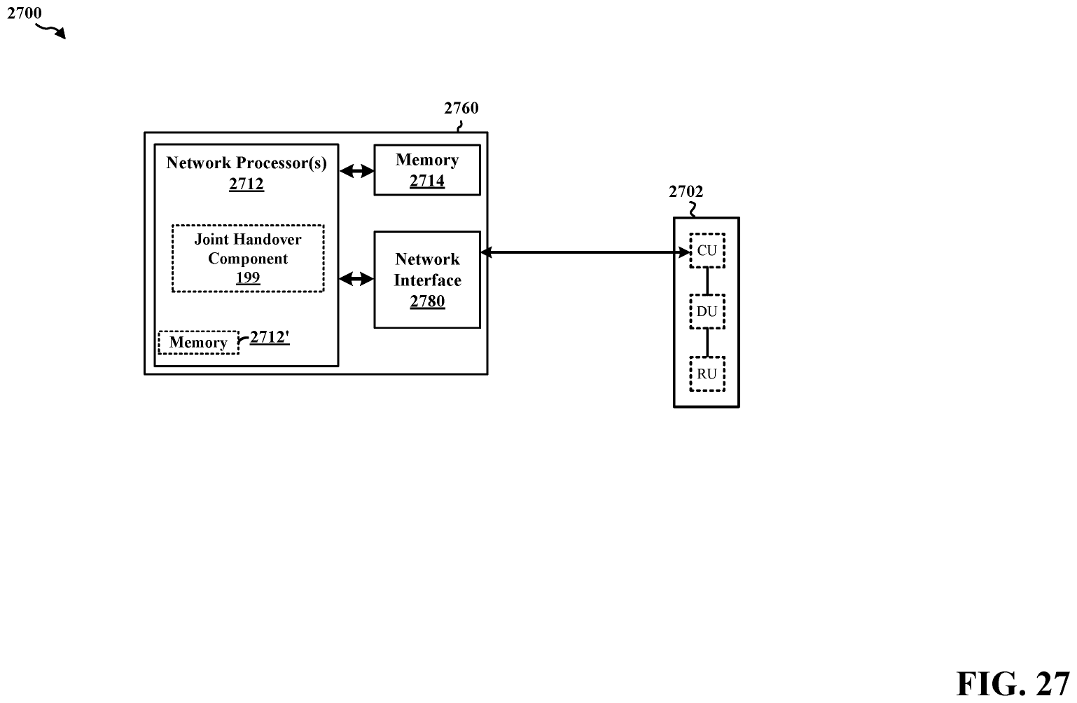

At 1210, the network device may output, for a tDU associated with the handover procedure for the plurality of wireless devices, a first common request relating to a context of the plurality of UEs (where, for a UE, the context may include a current state, active connections, supported services, network preferences, etc.). For example, 1210 may be performed by CU processor(s) 2612, communications interface 2618, network processor 2712, network interface 2780, and/or joint handover component 199 of FIGS. 26 and 27. The first common request, in some aspects, may include the multi-modal information. For example, referring to FIGS. 6, 7, and 8, the CU-CP 607, the CU-CP 707, and the target CU-CP 819 may output a common context setup request as part of common context setup 638, 738, or 838.

At 1220, the network device may obtain, from the tDU associated with the handover procedure for the plurality of wireless devices, a first common response relating to the context of the plurality of UEs. For example, 1220 may be performed by CU processor(s) 2612, communications interface 2618, network processor 2712, network interface 2780, and/or joint handover component 199 of FIGS. 26 and 27. The first common response, in some aspects, may include the multi-modal information or other indication that it is related to the first common request. For example, referring to FIGS. 6, 7, and 8, the CU-CP 607, the CU-CP 707, and the target CU-CP 819 may obtain a common context setup response as part of common context setup 638, 738, or 838.

If the CU-CP for the sDU (e.g., the source CU-CP 817) is not the same as the CU-CP for the tDU (e.g., the target CU-CP 819), the CU-CP for the sDU may obtain, and the CU-CP for the tDU may output, a common handover request acknowledgment in response to the common handover request. In some aspects, the common handover request acknowledgment may include multi-modal information indicating at least the plurality of UEs or other information identifying the common handover request acknowledgment as being related to the common handover request. For example, referring to FIG. 8, the source CU-CP 817 may output, and the target CU-CP 819 may obtain, common handover request 834.

The network device, in some aspects, may output, for the sDU, a common context modification request (a second common request relating to a context modification) for the plurality of UEs. The common context modification request, in some aspects, may include the multi-modal information. In some aspects, the common context modification request may include a plurality of RRC reconfiguration messages for the plurality of UEs. The plurality of RRC reconfiguration messages, in some aspects, including an RRC reconfiguration message for each of the plurality of UEs. For example, referring to FIGS. 6, 7, and 8, the CU-CP 607, the CU-CP 707, and the target CU-CP 819 may output, the context modification request 842 for the sDU 603, 703, or 803.

If the CU-CP for the sDU (e.g., the source CU-CP 817) is not the same as the CU-CP for the tDU (e.g., the target CU-CP 819), the CU-CP for the sDU may output, and the CU-UP associated with the sDU (e.g., a source CU-UP) may obtain, a common bearer context modification request and the source CU-UP may output, and the CU-CP for the sDU may obtain a common bearer context modification response. In some aspects, the common bearer context modification request and/or the common bearer context modification response may include multi-modal information. For example, referring to FIG. 8, the source CU-CP 817 may output, and the source CU-UP 813 may obtain, a common bearer context modification request and the source CU-UP 813 may output, and the source CU-CP 817 may obtain a common bearer context modification response in association with the UE bearer context modification messages 846.

If the CU-CP for the sDU (e.g., the source CU-CP 817) is not the same as the CU-CP for the tDU (e.g., the target CU-CP 819), the CU-CP for the sDU may output, and the CU-CP for the tDU may obtain, a common SN status transfer message for the plurality of the UEs. In some aspects, the common SN status transfer message may include multi-modal information indicating at least the plurality of UEs. For example, referring to FIG. 8, the source CU-CP 817 may output, and the target CU-CP 819 may obtain, common SN status transfer 848.

Based on the common context modification request, the CU-CP (or a CU-CP for the sDU), in some aspects, may obtain, from an sDU, a common context modification response for the plurality of UEs. The common context modification response, in some aspects, may include multi-modal information. For example, referring to FIGS. 6, 7, and 8, the CU-CP 607, the CU-CP 707, and the source CU-CP 817 may obtain, the context modification response 656, 756, or 856 from the sDU 603, 703, or 803.

In some aspects, the CU-CP (or the CU-CP for the tDU) may obtain an RRC reconfiguration complete message from each of the plurality UEs. In some aspects, based on obtaining the RRC reconfiguration complete message from each of the plurality UEs, the CU-UP (or the CU-CP for the tDU) may output, for an AMF and/or a UPF, a common path switch request for the plurality of UEs and obtain, in response to the common path switch request, a common path switch request acknowledgment. In some aspects, the common path switch request and/or the common path switch request acknowledgment may include the multi-modal information. In some aspects, based on obtaining the RRC reconfiguration complete message from each of the plurality UEs, the CU-UP (or the CU-CP for the tDU) may release the UE context for the plurality of UEs. For example, referring to FIGS. 6, 7, and 8, the CU-CP 607, the CU-CP 707, and the target CU-CP 819 may obtain, the RRC reconfiguration complete message 662, 762, and 862 and the RRC reconfiguration complete message 670, 770, and 870 and may output a common path switch request 772 or 872 and obtain a common path switch request acknowledgment message 782 or 882 and/or may determine at 683 or 783 to release the UE contexts for the plurality of UEs.

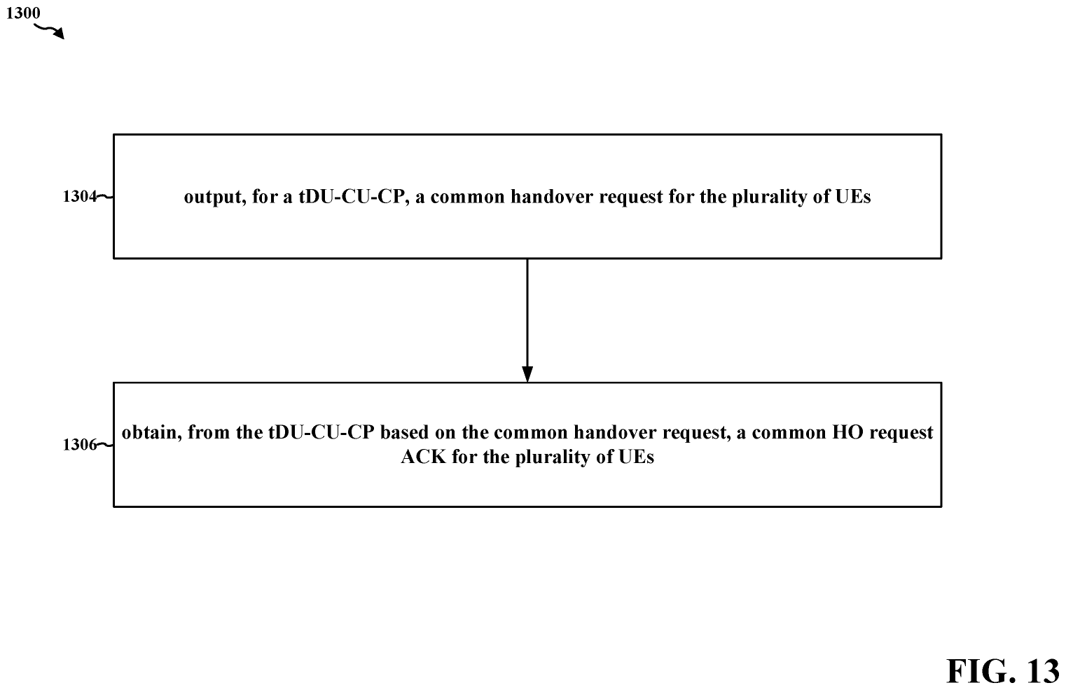

FIG. 13 is a flowchart 1300 of a method of wireless communication. The method may be performed by one or more of a network, a network component, or a network device (e.g., the base station 102; the sDU 603, 703, 803; the tDU 605, 705, 805; the CU-CP 607, 707; the CU-UP 609; the AMF/UPF 711, 811; the source CU-UP 713, 813; the target CU-UP 715, 815; the source CU-CP 817; the target CU-CP 819; the network entity 2602, 2760). In some aspects, the method may be associated with a joint and/or common handover performed for a plurality of UEs (as an example of wireless devices) associated with a multi-modal service in a distributed architecture as discussed in any of FIGS. 6, 7, and 8. The joint and/or common handover, in some aspects, may be for a handover from (1) a source base station or DU (an sBS or sDU) currently serving and/or connected to the plurality of UEs to (2) a target base station or DU (a tBS or tDU). The plurality of UEs may be associated with multi-modal information as discussed above in relation to FIGS. 6, 7, and 8 and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be a CU associated with a CP (a “CU-CP” associated with, or implementing, CP functions), and may receive a measurement report (or information regarding a measurement report) from a sDU associated with the plurality of UEs. The measurement report, in some aspects, may include information triggering the joint and/or common handover procedure for the plurality of UEs. For example, referring to FIGS. 6, 7, and 8, the CU-CP 607, the CU-CP 707, and the source CU-CP 817 may obtain, from sDU 603, 703, and 803 the message transfer 632, 732, and 832.

If the CU-CP for the sDU (e.g., the source CU-CP 817) is not the same as the CU-CP for the tDU (e.g., the target CU-CP 819), at 1304, the CU-CP for the sDU may output, and the CU-CP for the tDU may obtain, a common handover request for the plurality of UEs. For example, 1304 may be performed by CU processor(s) 2612, communications interface 2618, network processor 2712, network interface 2780, and/or joint handover component 199 of FIGS. 26 and 27. In some aspects, the common handover request may include multi-modal information indicating at least the plurality of UEs. For example, referring to FIG. 8, the source CU-CP 817 may output, and the target CU-CP 819 may obtain, common handover request 834.

In some aspects, the CU-CP for the tDU may, based on the common handover request for the plurality of UEs, output a common bearer context setup message for the plurality of UEs and obtain a common bearer context response for the plurality of UEs. In some aspects, the common bearer context setup message and the common bearer context response may include multi-modal information and may be exchanged with (output to, or obtained from, a CU device associated with a UP (a “CU-UP”) such as a CU-UP associated with the tDU (e.g., a target CU-UP). For example, referring to FIGS. 7, and 8, the CU-CP 707 and the target CU-CP 819 may output, and the target CU-UP 715 and 815 may obtain, a common bearer context setup request and the target CU-UP 715 and 815 may output, and the CU-CP 707 and the target CU-CP 819 may obtain, a common bearer context setup response as part of common context setup 736 or 836.

If the CU-CP for the sDU (e.g., the source CU-CP 817) is not the same as the CU-CP for the tDU (e.g., the target CU-CP 819), at 1306, the CU-CP for the sDU may obtain, and the CU-CP for the tDU may output, a common handover request acknowledgment in response to the common handover request. For example, 1306 may be performed by CU processor(s) 2612, communications interface 2618, network processor 2712, network interface 2780, and/or joint handover component 199 of FIGS. 26 and 27. In some aspects, the common handover request acknowledgment may include multi-modal information indicating at least the plurality of UEs or other information identifying the common handover request acknowledgment as being related to the common handover request. For example, referring to FIG. 8, the source CU-CP 817 may output, and the target CU-CP 819 may obtain, common handover request 834.

If the CU-CP for the sDU (e.g., the source CU-CP 817) is not the same as the CU-CP for the tDU (e.g., the target CU-CP 819), the CU-CP for the sDU may output, and the CU-UP associated with the sDU (e.g., a source CU-UP) may obtain, a common bearer context modification request and the source CU-UP may output, and the CU-CP for the sDU may obtain a common bearer context modification response. In some aspects, the common bearer context modification request and/or the common bearer context modification response may include multi-modal information. For example, referring to FIG. 8, the source CU-CP 817 may output, and the source CU-UP 813 may obtain, a common bearer context modification request and the source CU-UP 813 may output, and the source CU-CP 817 may obtain a common bearer context modification response in association with the UE bearer context modification messages 846.

If the CU-CP for the sDU (e.g., the source CU-CP 817) is not the same as the CU-CP for the tDU (e.g., the target CU-CP 819), the CU-CP for the sDU may output, and the CU-CP for the tDU may obtain, a common SN status transfer message for the plurality of the UEs. In some aspects, the common SN status transfer message may include multi-modal information indicating at least the plurality of UEs. For example, referring to FIG. 8, the source CU-CP 817 may output, and the target CU-CP 819 may obtain, common SN status transfer 848.

Based on the common context modification request, the CU-CP for the sDU, in some aspects, may obtain, from an sDU, a common context modification response for the plurality of UEs. The common context modification response, in some aspects, may include multi-modal information. For example, referring to FIGS. 6, 7, and 8, the CU-CP 607, the CU-CP 707, and the source CU-CP 817 may obtain, the context modification response 656, 756, or 856 from the sDU 603, 703, or 803.

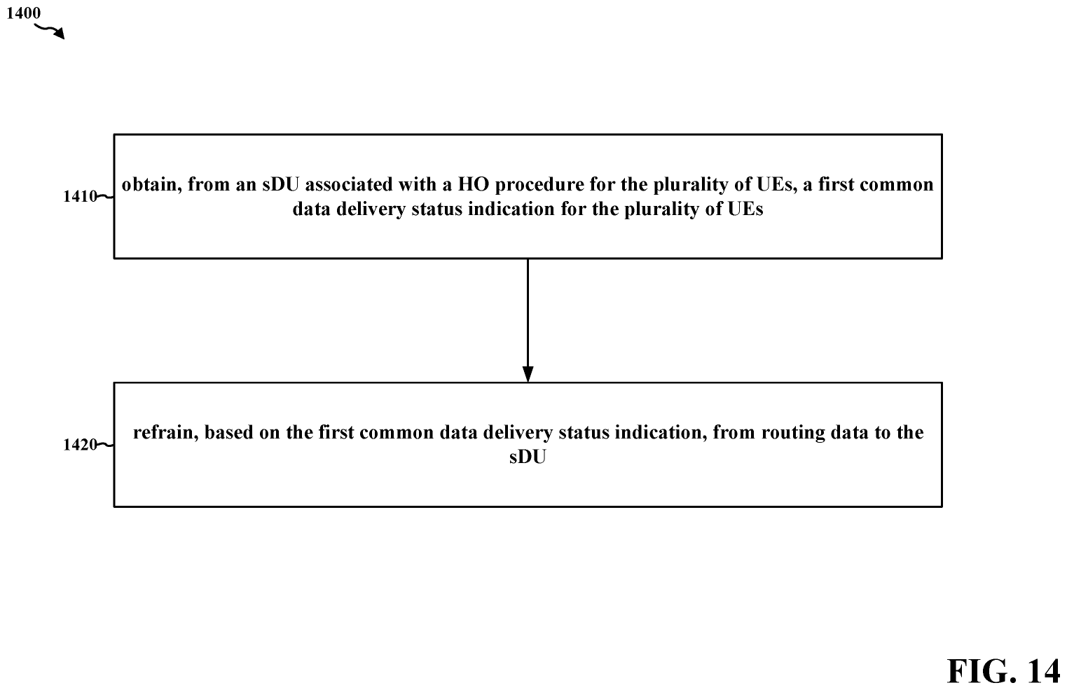

FIG. 14 is a flowchart 1400 of a method of wireless communication. The method may be performed by one or more of a network, a network component, or a network device (e.g., the base station 102; the sDU 603, 703, 803; the tDU 605, 705, 805; the CU-CP 607, 707; the CU-UP 609; the AMF/UPF 711, 811; the source CU-UP 713, 813; the target CU-UP 715, 815; the source CU-CP 817; the target CU-CP 819; the network entity 2602, 2760). In some aspects, the method may be associated with a joint and/or common handover performed for a plurality of UEs (as an example of wireless devices) associated with a multi-modal service in a distributed architecture as discussed in any of FIGS. 6, 7, and 8. The joint and/or common handover, in some aspects, may be for a handover from (1) a source base station or DU (an sBS or sDU) currently serving and/or connected to the plurality of UEs to (2) a target base station or DU (a tBS or tDU). The plurality of UEs may be associated with multi-modal information as discussed above in relation to FIGS. 6, 7, and 8 and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be a CU associated with a UP (a “CU-UP” associated with, or implementing, UP functions). If the CU-UP for the sDU (e.g., an source CU-UP such as the source CU-UP 713 or 813) is not the same as the CU-UP for the tDU (e.g., a target CU-UP such as the target CU-UP 715 or 815), the target CU-UP may obtain, and the CU-CP or the target CU-CP may output, a common bearer context setup request for the plurality of UEs and the target CU-UP may output, and the CU-CP or the target CU-CP may obtain, a common bearer context setup response. In some aspects, the common bearer context setup request and the common bearer context setup response may include multi-modal information indicating at least the plurality of UEs. For example, referring to FIGS. 7, and 8, the CU-CP 707 and the target CU-CP 819 may output, and the target CU-UP 715 and 815 may obtain, a common bearer context setup request and the target CU-UP 715 and 815 may output, and the CU-CP 707 and the target CU-CP 819 may obtain, a common bearer context setup response as part of common bearer context setup 736 or 836.

If the CU-CP for the sDU (e.g., the source CU-CP 817) is not the same as the CU-CP for the tDU (e.g., the target CU-CP 819), the CU-CP for the sDU may output, and the CU-UP associated with the sDU (e.g., a source CU-UP) may obtain, a common bearer context modification request and the source CU-UP may output, and the CU-CP for the sDU may obtain a common bearer context modification response. In some aspects, the common bearer context modification request and/or the common bearer context modification response may include multi-modal information. For example, referring to FIG. 8, the source CU-CP 817 may output, and the source CU-UP 813 may obtain, a common bearer context modification request and the source CU-UP 813 may output, and the source CU-CP 817 may obtain a common bearer context modification response in association with the UE bearer context modification messages 846.

At 1410, the network device (e.g., the CU-UP or the source CU-UP) may obtain, from the sDU associated with the handover procedure for the plurality of UEs, a first common data delivery status indication for the plurality of UEs. For example, 1410 may be performed by CU processor(s) 2612, communications interface 2618, network processor 2712, network interface 2780, and/or joint handover component 199 of FIGS. 26 and 27. The first common data delivery status, in some aspects, may include the multi-modal information. For example, referring to FIGS. 6, 7, and 8, the CU-UP 609, the source CU-UP 713, and the source CU-UP 813 may obtain, the common data delivery status frame 652, 752, and 852 from the sDU 603, 703, and 803.

At 1420, the network device (e.g., the CU-UP or the source CU-UP) may refrain, based on the first common data delivery status indication for the plurality of UEs, from routing data for the plurality of UEs to the sDU. For example, 1420 may be performed by CU processor(s) 2612, communications interface 2618, network processor 2712, network interface 2780, and/or joint handover component 199 of FIGS. 26 and 27. For example, referring to FIGS. 6, 7, and 8, the CU-UP 609, the source CU-UP 713, and the source CU-UP 813 may refrain, at 654, 754, and 854 from routing DL data from the UPF 611, or the AMF/UPF 711 and 811 to the sDU 603, 703, and 803.

In some aspects, the network device (e.g., the CU-UP or the target CU-UP) may obtain, from the tDU associated with the handover procedure for the plurality of UEs, a second common data delivery status indication for the plurality of UEs. The second common data delivery status, in some aspects, may include the multi-modal information. For example, referring to FIGS. 6, 7, and 8, the CU-UP 609, the source CU-UP 713, and the source CU-UP 813 may obtain, the common data delivery status 666, 766, and 866 from the sDU 603, 703, and 803. In some aspects, the network device (e.g., the CU-UP or the source CU-UP) may begin, based on the second common data delivery status indication for the plurality of UEs, routing data for the plurality of UEs to the tDU. For example, referring to FIGS. 6, 7, and 8, the CU-UP 609, the target CU-UP 715, and the target CU-UP 815 may begin, at 667, 767, and 867 routing DL data from the UPF 611, or the AMF/UPF 711 and 811 to the tDU 605, 705, and 805.

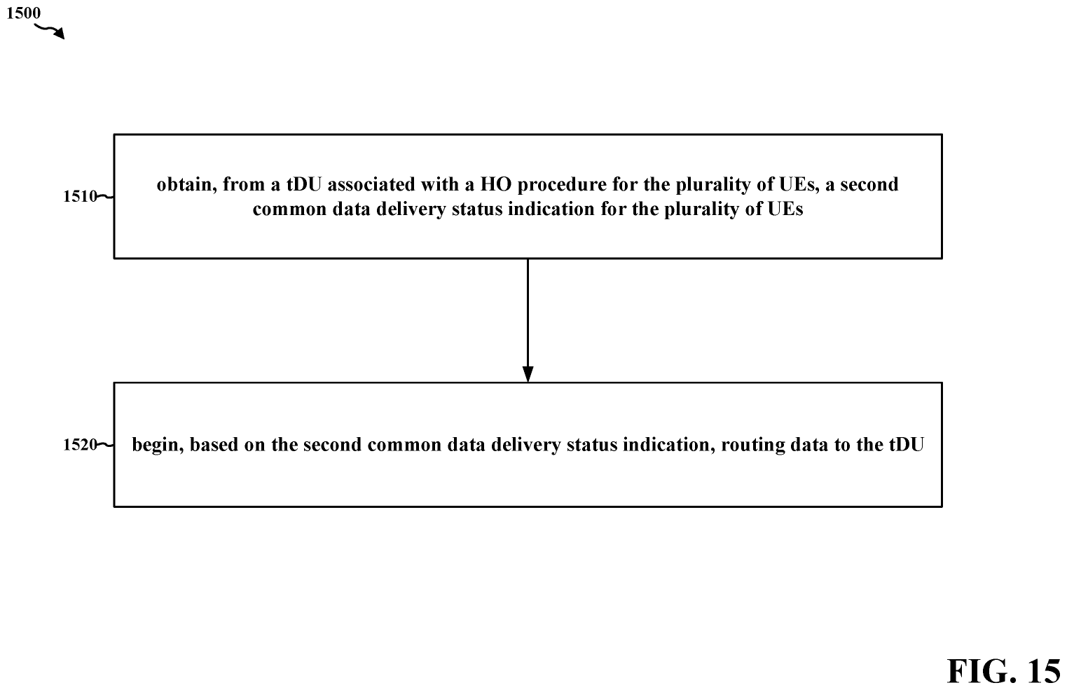

FIG. 15 is a flowchart 1500 of a method of wireless communication. The method may be performed by one or more of a network, a network component, or a network device (e.g., the base station 102; the sDU 603, 703, 803; the tDU 605, 705, 805; the CU-CP 607, 707; the CU-UP 609; the AMF/UPF 711, 811; the source CU-UP 713, 813; the target CU-UP 715, 815; the source CU-CP 817; the target CU-CP 819; the network entity 2602, 2760). In some aspects, the method may be associated with a joint and/or common handover performed for a plurality of UEs (as an example of wireless devices) associated with a multi-modal service in a distributed architecture as discussed in any of FIGS. 6, 7, and 8. The joint and/or common handover, in some aspects, may be for a handover from (1) a source base station or DU (an sBS or sDU) currently serving and/or connected to the plurality of UEs to (2) a target base station or DU (a tBS or tDU). The plurality of UEs may be associated with multi-modal information as discussed above in relation to FIGS. 6, 7, and 8 and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be a CU associated with a UP (a “CU-UP” associated with, or implementing, UP functions). If the CU-UP for the sDU (e.g., an source CU-UP such as the source CU-UP 713 or 813) is not the same as the CU-UP for the tDU (e.g., a target CU-UP such as the target CU-UP 715 or 815), the target CU-UP may obtain, and the CU-CP or the target CU-CP may output, a common bearer context setup request for the plurality of UEs and the target CU-UP may output, and the CU-CP or the target CU-CP may obtain, a common bearer context setup response. In some aspects, the common bearer context setup request and the common bearer context setup response may include multi-modal information indicating at least the plurality of UEs. For example, referring to FIGS. 7, and 8, the CU-CP 707 and the target CU-CP 819 may output, and the target CU-UP 715 and 815 may obtain, a common bearer context setup request and the target CU-UP 715 and 815 may output, and the CU-CP 707 and the target CU-CP 819 may obtain, a common bearer context setup response as part of common bearer context setup 736 or 836.

If the CU-CP for the sDU (e.g., the source CU-CP 817) is not the same as the CU-CP for the tDU (e.g., the target CU-CP 819), the CU-CP for the sDU may output, and the CU-UP associated with the sDU (e.g., a source CU-UP) may obtain, a common bearer context modification request and the source CU-UP may output, and the CU-CP for the sDU may obtain a common bearer context modification response. In some aspects, the common bearer context modification request and/or the common bearer context modification response may include multi-modal information. For example, referring to FIG. 8, the source CU-CP 817 may output, and the source CU-UP 813 may obtain, a common bearer context modification request and the source CU-UP 813 may output, and the source CU-CP 817 may obtain a common bearer context modification response in association with the UE bearer context modification messages 846.

In some aspects, the network device (e.g., the CU-UP or the source CU-UP) may refrain, based on the first common data delivery status indication for the plurality of UEs, from routing data for the plurality of UEs to the sDU. For example, referring to FIGS. 6, 7, and 8, the CU-UP 609, the source CU-UP 713, and the source CU-UP 813 may refrain, at 654, 754, and 854 from routing DL data from the UPF 611, or the AMF/UPF 711 and 811 to the sDU 603, 703, and 803.

At 1510, the network device (e.g., the CU-UP or the target CU-UP) may obtain, from the tDU associated with the handover procedure for the plurality of UEs, a second common data delivery status indication for the plurality of UEs. For example, 1510 may be performed by CU processor(s) 2612, communications interface 2618, network processor 2712, network interface 2780, and/or joint handover component 199 of FIGS. 26 and 27. The second common data delivery status, in some aspects, may include the multi-modal information. For example, referring to FIGS. 6, 7, and 8, the CU-UP 609, the source CU-UP 713, and the source CU-UP 813 may obtain, the common data delivery status 666, 766, and 866 from the sDU 603, 703, and 803.

At 1520, the network device (e.g., the CU-UP or the target CU-UP) may begin, based on the second common data delivery status indication for the plurality of UEs, routing data for the plurality of UEs to the tDU. For example, 1520 may be performed by CU processor(s) 2612, communications interface 2618, network processor 2712, network interface 2780, and/or joint handover component 199 of FIGS. 26 and 27. For example, referring to FIGS. 6, 7, and 8, the CU-UP 609, the target CU-UP 715, and the target CU-UP 815 may begin, at 667, 767, and 867 routing DL data from the UPF 611, or the AMF/UPF 711 and 811 to the tDU 605, 705, and 805.

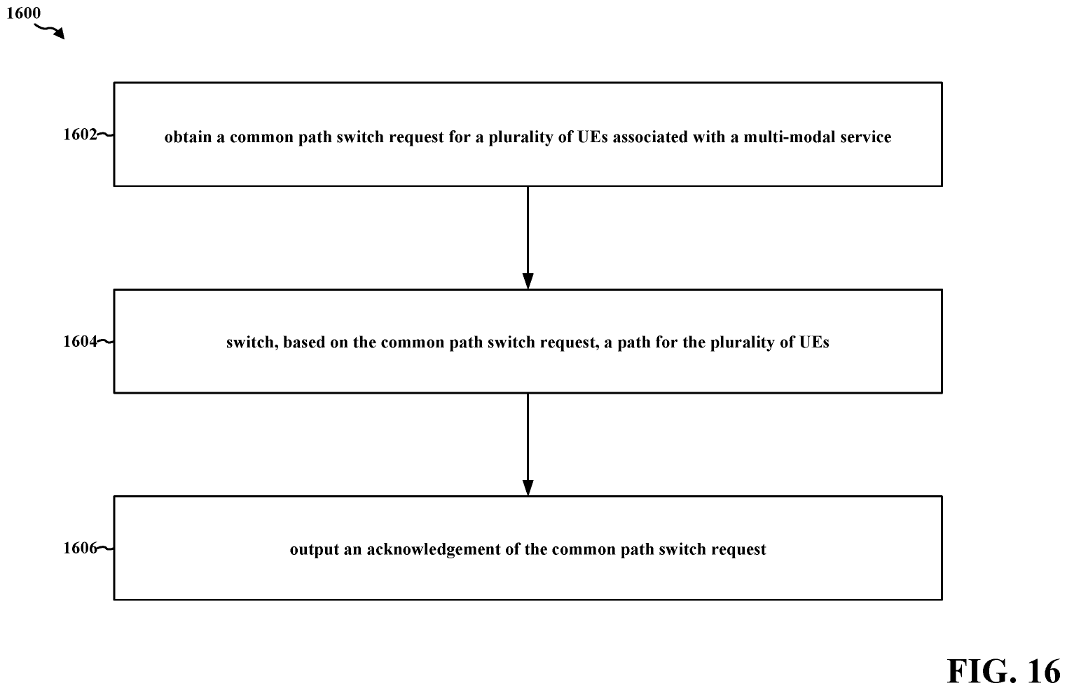

FIG. 16 is a flowchart 1600 of a method of wireless communication. The method may be performed by one or more of a network, a network component, or a network device (e.g., the base station 102; the sDU 603, 703, 803; the tDU 605, 705, 805; the CU-CP 607, 707; the CU-UP 609; the AMF/UPF 711, 811; the source CU-UP 713, 813; the target CU-UP 715, 815; the source CU-CP 817; the target CU-CP 819; the network entity 2602, 2760). In some aspects, the method may be associated with a joint and/or common handover performed for a plurality of UEs (as an example of wireless devices) associated with a multi-modal service in a distributed architecture as discussed in any of FIGS. 6, 7, and 8. The joint and/or common handover, in some aspects, may be for a handover from (1) a source base station or DU (an sBS or sDU) currently serving and/or connected to the plurality of UEs to (2) a target base station or DU (a tBS or tDU). The plurality of UEs may be associated with multi-modal information as discussed above in relation to FIGS. 6, 7, and 8 and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be an AMF/UPF associated with the handover procedure and/or the plurality of UEs. At 1602, the network device may obtain a common path switch request for the plurality of UEs. In some aspects, the common path switch request may be obtained from a CU-UP (or the CU-CP for a tDU). For example, 1602 may be performed by network processor 2712, network interface 2780, and/or joint handover component 199 of FIG. 27. The first common path switch request, in some aspects, may include the multi-modal information. For example, referring to FIGS. 7, and 8, the AMF/UPF 711 and 811 may obtain, from the CU-CP 707 or the target CU-CP 819, the common path switch request 772 and 872.

At 1604, the network device may switch, based on the common path switch request for the plurality of UEs, a path for the plurality of UEs. For example, 1604 may be performed by network processor 2712, network interface 2780, and/or joint handover component 199 of FIG. 27. For example, referring to FIGS. 7, and 8, the AMF/UPF 711 and 811 may switch, at 774 and 874.

At 1606, the network device may, in response to the common path switch request, output a common path switch request acknowledgment. For example, 1606 may be performed by network processor 2712, network interface 2780, and/or joint handover component 199 of FIG. 27. In some aspects, the common path switch request acknowledgment may include the multi-modal information. For example, referring to FIGS. 7, and 8, the AMF/UPF 711 and 811 may output a common path switch request acknowledgment message 782 or 882.

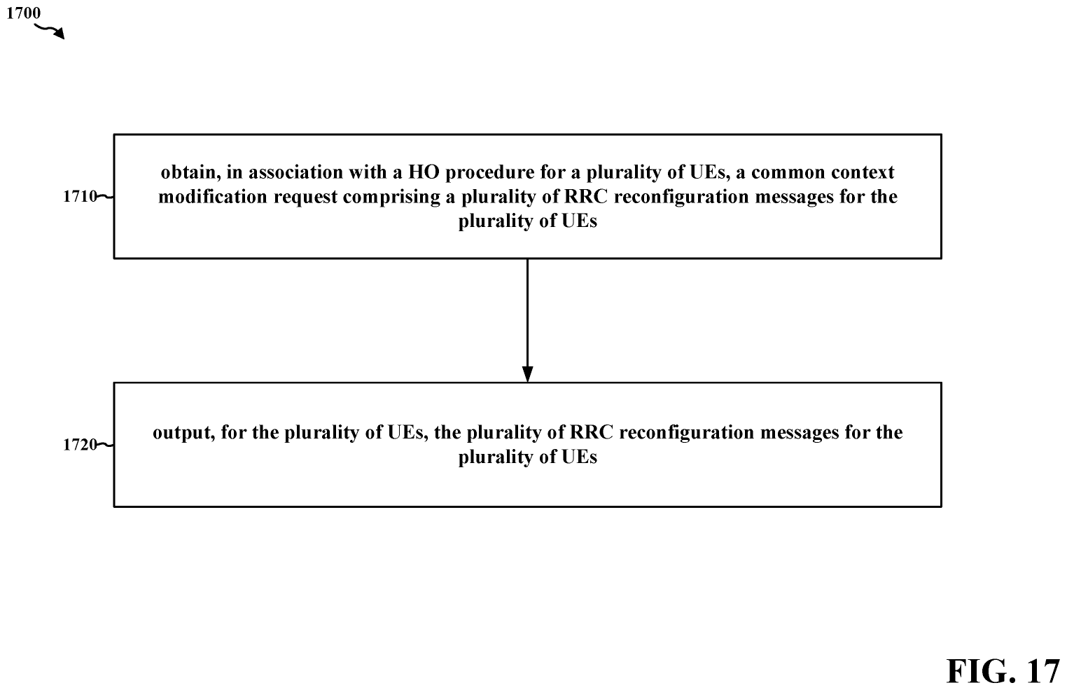

FIG. 17 is a flowchart 1700 of a method of wireless communication. The method may be performed by one or more of a network, a network component, or a network device (e.g., the base station 102; the sDU 603, 703, 803; the tDU 605, 705, 805; the CU-CP 607, 707; the CU-UP 609; the AMF/UPF 711, 811; the source CU-UP 713, 813; the target CU-UP 715, 815; the source CU-CP 817; the target CU-CP 819; the network entity 2602, 2760). In some aspects, the method may be associated with a joint and/or common handover performed for a plurality of UEs (as an example of wireless devices) associated with a multi-modal service in a distributed architecture as discussed in any of FIGS. 6, 7, and 8. The joint and/or common handover, in some aspects, may be for a handover from (1) a source base station or DU (an sBS or sDU) currently serving and/or connected to the plurality of UEs to (2) a target base station or DU (a tBS or tDU). The plurality of UEs may be associated with multi-modal information as discussed above in relation to FIGS. 6, 7, and 8 and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be the source DU. The source DU, in some aspects, may output a measurement report (or information regarding a measurement report) to a CU-CP or source CU-CP. The measurement report, in some aspects, may include information triggering the joint and/or common handover procedure for the plurality of UEs. For example, referring to FIGS. 6, 7, and 8, the CU-CP 607, the CU-CP 707, and the source CU-CP 817 may obtain, from sDU 603, 703, and 803 the message transfer 632, 732, and 832.

At 1710 The network device, in some aspects, may obtain, from the CU-CP or the source CU-CP, a common context modification request (a common request relating to a context modification) for the plurality of UEs. The common context modification request, in some aspects, may include the multi-modal information. For example, 1710 may be performed by DU processor(s) 2632, transceiver(s) 2646, antenna(s) 2680, and/or joint handover component 199 of FIG. 26. In some aspects, the common context modification request may include a plurality of RRC reconfiguration messages for the plurality of UEs. The plurality of RRC reconfiguration messages, in some aspects, including an RRC reconfiguration message for each of the plurality of UEs. For example, referring to FIGS. 6, 7, and 8, the CU-CP 607, the CU-CP 707, and the target CU-CP 819 may output, the common context modification request 842 for the sDU 603, 703, or 803.

At 1720, the network device, in some aspects, may output, for the plurality of UEs, the plurality of RRC reconfiguration messages for the plurality of UEs included in the common context modification request. The common context modification request, in some aspects, may include the multi-modal information. For example, 1720 may be performed by DU processor(s) 2632, transceiver(s) 2646, antenna(s) 2680, and/or joint handover component 199 of FIG. 26. The plurality of RRC reconfiguration messages, in some aspects, including an RRC reconfiguration message for each of the plurality of UEs. For example, referring to FIGS. 6, 7, and 8, the CU-CP 607, the sDU 603, 703, or 803 may output, an individual RRC reconfiguration message 644 to each of the UE1 604, 704, or 804 and the UE2 606, 706, or 806.

In some aspects, the network device may output, for a CU-UP (e.g., the CU-UP or the source CU-UP) associated with the handover procedure for the plurality of UEs, a first common data delivery status indication for the plurality of UEs. The first common data delivery status, in some aspects, may include the multi-modal information. For example, referring to FIGS. 6, 7, and 8, the CU-UP 609, the source CU-UP 713, and the source CU-UP 813 may obtain, the common data delivery status frame 652, 752, and 852 from the sDU 603, 703, and 803.

Based on the common context modification request, the sDU, may output, for a CU-CP or a source CU-CP, a common context modification response for the plurality of UEs. The common context modification response, in some aspects, may include multi-modal information. For example, referring to FIGS. 6, 7, and 8, the sDU 603, 703, or 803 may output, and the CU-CP 607, the CU-CP 707, and the source CU-CP 817 may obtain, the context modification response 656, 756, or 856.

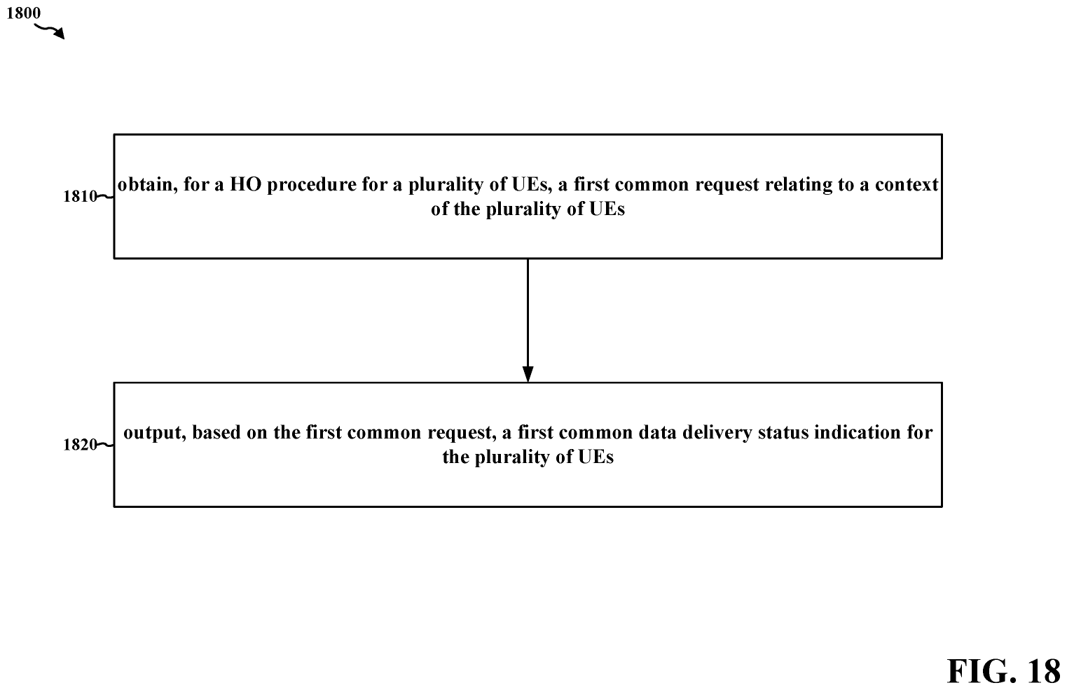

FIG. 18 is a flowchart 1800 of a method of wireless communication. The method may be performed by one or more of a network, a network component, or a network device (e.g., the base station 102; the sDU 603, 703, 803; the tDU 605, 705, 805; the CU-CP 607, 707; the CU-UP 609; the AMF/UPF 711, 811; the source CU-UP 713, 813; the target CU-UP 715, 815; the source CU-CP 817; the target CU-CP 819; the network entity 2602, 2760). In some aspects, the method may be associated with a joint and/or common handover performed for a plurality of UEs (as an example of wireless devices) associated with a multi-modal service in a distributed architecture as discussed in any of FIGS. 6, 7, and 8. The joint and/or common handover, in some aspects, may be for a handover from (1) a source base station or DU (an sBS or sDU) currently serving and/or connected to the plurality of UEs to (2) a target base station or DU (a tBS or tDU). The plurality of UEs may be associated with multi-modal information as discussed above in relation to FIGS. 6, 7, and 8 and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be the target DU. At 1810, the network device, in some aspects, may obtain, from the CU-CP or the target CU-CP, a common context setup request for the plurality of UEs. For example, 1810 may be performed by DU processor(s) 2632, transceiver(s) 2646, antenna(s) 2680, and/or joint handover component 199 of FIG. 26. The common context setup request, in some aspects, may include the multi-modal information. For example, referring to FIGS. 6, 7, and 8, the tDU 605, 705, and 805 may obtain, from the CU-CP 607, the CU-CP 707, and the target CU-CP 819, a common context setup request in association with the common context setup 838.

In some aspects, the network device may be the target DU. The network device, in some aspects, may output, for the CU-CP or the target CU-CP, a common context setup response for the plurality of UEs. The common context setup request, in some aspects, may include the multi-modal information. For example, referring to FIGS. 6, 7, and 8, the tDU 605, 705, and 805 may output, for the CU-CP 607, the CU-CP 707, and the target CU-CP 819, a common context setup response in association with the common context setup 838.

At 1820, the network device may output, for a CU-UP (e.g., the CU-UP or the target CU-UP) associated with the handover procedure for the plurality of UEs, a (second) common data delivery status indication for the plurality of UEs. For example, 1820 may be performed by DU processor(s) 2632, transceiver(s) 2646, antenna(s) 2680, and/or joint handover component 199 of FIG. 26. The (second) common data delivery status, in some aspects, may include the multi-modal information. For example, referring to FIGS. 6, 7, and 8, the CU-UP 609, the source CU-UP 713, and the source CU-UP 813 may obtain, the common data delivery status 666, 766, and 866 from the tDU 605, 705, and 805.

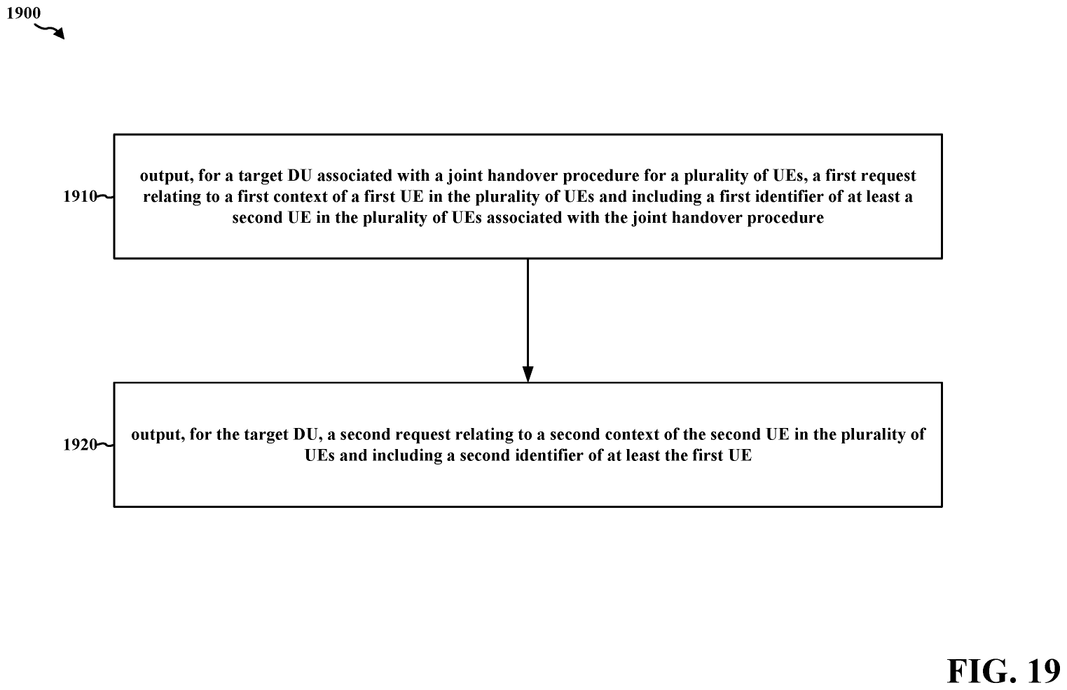

FIG. 19 is a flowchart 1900 of a method of wireless communication. The method may be performed by one or more of a network, a network component, or a network device (e.g., the base station 102; the sDU 903, 1003, 1103; the tDU 905, 1005, 1105; the CU-CP 907, 1007; the CU-UP 909; the AMF/UPF 1011, 1111; the source CU-UP 1013, 1113; the target CU-UP 1015, 1115; the source CU-CP 1117; the target CU-CP 1119; the network entity 2602, 2760). In some aspects, the method may be associated with a joint and/or common handover performed for a plurality of UEs (as an example of wireless devices) associated with a multi-modal service in a distributed architecture as discussed in any of FIG. 9, 10A, 10B, 11A, or 11B. The joint and/or common handover, in some aspects, may be for a handover from (1) a source base station or DU (an sDU or sDU) currently serving and/or connected to the plurality of UEs to (2) a target base station or DU (a tDU or tDU). The plurality of UEs may be associated with multi-modal information as discussed above in relation to FIG. 9, 10A, 10B, 11A, or 11B and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be a CU associated with a CP (a “CU-CP” associated with, or implementing, CP functions), and may receive a measurement report (or information regarding a measurement report) from a sDU associated with the plurality of UEs. The measurement report, in some aspects, may include information triggering the joint and/or common handover procedure for the plurality of UEs. For example, referring to FIGS. 9, 10A, and 11A, the CU-CP 907, the CU-CP 1007, and the source CU-CP 1117 may obtain, from sDU 903, 1003, and 1103 the message transfer 921, 1021, and 1121.

If the CU-CP for the sDU (e.g., a source CU-CP such as the source CU-CP 1117) is not the same as the CU-CP for the tDU (e.g., a target CU-CP such as the target CU-CP 1119), the source CU-CP may output, and the target CU-CP may obtain, a first UE-specific handover request for a first UE in the plurality of UEs. In some aspects, the source CU-CP may output, and the target CU-CP may obtain, a second UE-specific handover request for a second UE in the plurality of UEs. In some aspects, the first UE-specific handover request and the second UE-specific handover request may include the multi-modal information (e.g., information identifying the plurality of UEs as being related for the joint handover procedure). For example, referring to FIG. 11A, the source CU-CP 1117 may output, and the target CU-CP 1119 may obtain, first UE-specific handover request 1122 and second UE-specific handover request 1123.

In some aspects, the target CU-CP may, after receiving the first UE-specific handover request, wait to receive UE-specific handover requests from each of the UEs indicated in the first UE-specific handover request. Once the UE-specific handover requests from each of the UEs indicated in the first UE-specific handover request have been received, the target CU-CP may perform a call admission control for the plurality of UEs and request the setup of resources in, or at, the target CU-UP via a first UE-specific bearer context setup request for a first UE in the plurality of UEs and a second UE-specific bearer context setup request for a second UE in the plurality of UEs. The UE-specific bearer context setup requests, in some aspects, may include the multi-modal information. For example, referring to FIG. 11A, the target CU-CP 1119 may wait until the first UE-specific handover request 1122 and the second UE-specific handover request 1123 are received and then perform the call admission control at 1124 and output the first UE-specific bearer context setup request 1125 and the second UE-specific bearer context setup request 1126.

In some aspects, the CU-CP for the tDU may, based on the UE-specific bearer context setup requests for the plurality of UEs, obtain a UE-specific bearer context setup response for each of the plurality of UEs. The UE-specific bearer context setup responses, in some aspects, may include the multi-modal information. In some aspects, the UE-specific bearer context setup requests may be output for, or provided to, a target CU-UP and the UE-specific bearer context setup responses may be obtained from the target CU-UP. For example, referring to FIGS. 10A, 10B, 11A, and 11B, the CU-CP 1007 and the target CU-CP 1119 may output, and the target CU-UP 1015 and 1115 may obtain, the first UE-specific bearer context setup request 1125 and the second UE-specific bearer context setup request 1126 and the target CU-UP 1015 and 1115 may output, and the CU-CP 1007 and the target CU-CP 1119 may obtain, the first UE-specific bearer context setup response 1128 and the second UE-specific bearer context setup response 1129.

At 1910, the network device may output, for a target DU associated with the handover procedure for the plurality of UEs, a first UE-specific request relating to a context of a first UE (where, for a UE, the context may include a current state, active connections, supported services, network preferences, etc.). For example, 1910 may be performed by CU processor(s) 2612, communications interface 2618, network processor 2712, network interface 2780, and/or joint handover component 199 of FIGS. 26 and 27. The first UE-specific request, in some aspects, may include a first identifier of at least a second UE in the plurality of UEs and/or the multi-modal information. For example, referring to FIGS. 9, 10A, 10B, 11A, and 11B, the CU-CP 907, the CU-CP 1007, and the target CU-CP 1119 may output a first UE-specific context setup request 930, 1030, and 1130.

At 1920, the network device may output, for a target DU associated with the handover procedure for the plurality of UEs, a second UE-specific request relating to a context of the second UE (where, for a UE, the context may include a current state, active connections, supported services, network preferences, etc.). For example, 1920 may be performed by CU processor(s) 2612, communications interface 2618, network processor 2712, network interface 2780, and/or joint handover component 199 of FIGS. 26 and 27. The second UE-specific request, in some aspects, may include a second identifier of at least a first UE in the plurality of UEs and/or the multi-modal information. For example, referring to FIGS. 9, 10A, 10B, 11A, and 11B, the CU-CP 907, the CU-CP 1007, and the target CU-CP 1119 may output a second UE-specific context setup request 931, 1031, and 1131.

In some aspects, the network device may obtain, from the target DU associated with the handover procedure for the plurality of UEs, a first UE-specific response relating to a context of the first UE (where, for a UE, the context may include a current state, active connections, supported services, network preferences, etc.). In some aspects, the first UE-specific response may be obtained based on outputting the first UE-specific request. The first UE-specific response, in some aspects, may include a first identifier of at least the second UE in the plurality of UEs and/or the multi-modal information. For example, referring to FIGS. 9, 10A, 10B, 11A, and 11B, the CU-CP 907, the CU-CP 1007, and the target CU-CP 1119 may obtain a first UE-specific context setup response 933, 1033, and 1133.

In some aspects, the network device may obtain, from the target DU associated with the handover procedure for the plurality of UEs, a second UE-specific response relating to a context of the second UE (where, for a UE, the context may include a current state, active connections, supported services, network preferences, etc.). In some aspects, the second UE-specific response may be obtained based on outputting the second UE-specific request. The second UE-specific response, in some aspects, may include a second identifier of at least the first UE in the plurality of UEs and/or the multi-modal information. For example, referring to FIGS. 9, 10A, 10B, 11A, and 11B, the CU-CP 907, the CU-CP 1007, and the target CU-CP 1119 may obtain a second UE-specific context setup response 934, 1034, and 1134.

If the CU-CP for the sDU (e.g., the source CU-CP 1117) is not the same as the CU-CP for the tDU (e.g., the target CU-CP 1119), the CU-CP for the sDU may obtain, and the CU-CP for the tDU may output, a first and second UE-specific handover request acknowledgments in response to the first and second UE-specific handover requests. In some aspects, the first and second UE-specific handover request acknowledgments may include multi-modal information indicating at least the plurality of UEs or other information identifying the first and second UE-specific handover request acknowledgments as being related to the first and second UE-specific handover requests. For example, referring to FIG. 11A, the source CU-CP 1117 may output, and the target CU-CP 1119 may obtain, the first UE-specific handover request acknowledgment 1135 and the second UE-specific handover request acknowledgment 1137.

The network device, in some aspects, may output, for the sDU, a first and second UE-specific context modification requests (a second set of requests relating to a context modification) for the first and second UEs, respectively. The first and second UE-specific context modification requests, in some aspects, may include the multi-modal information. For example, referring to FIGS. 9, 10A, 10B, 11A, and 11B, the CU-CP 907, the CU-CP 1007, and the target CU-CP 1119 may output, the first UE-specific context modification request 1136 and the second UE-specific context modification request 1138.

Based on the first and second UE-specific context modification requests, the CU-CP (or a CU-CP for the sDU), in some aspects, may obtain, from an sDU, first and second UE-specific context modification responses for the plurality of UEs. The UE-specific context modification responses, in some aspects, may include multi-modal information. For example, referring to FIGS. 9, 10A, 10B, 11A, and 11B, the CU-CP 907, the CU-CP 1007, and the source CU-CP 1117 may obtain, the first UE-specific context modification response 945, 1045, 1145 and the second UE-specific context modification response 948, 1048, and 1148 from the sDU 903, 1003, or 1103.

In some aspects, the CU-CP (or the CU-CP for the tDU) may obtain a first RRC reconfiguration complete message for the first UE and output, for an AMF/UPF based on the first RRC reconfiguration complete message, a first UE-specific path switch request for the first UE in the plurality of UEs. The first UE-specific path switch request for the first UE, in some aspects, may include the multi-modal information including an indication of the second UE in the plurality of UEs. For example, referring to FIGS. 9, 10A, 10B, 11A, and 11B, the CU-CP 907, the CU-CP 1007, and the target CU-CP 1119 may obtain, the RRC reconfiguration complete message 952, 1052, and 1152 and the CU-CP 1007 and the target CU-CP 1119 may output a first UE-specific path switch request 1053 or 1153.

In some aspects, the CU-CP (or the CU-CP for the tDU) may obtain a second RRC reconfiguration complete message for the first UE and output, for an AMF/UPF based on the second RRC reconfiguration complete message, a second UE-specific path switch request for the second UE in the plurality of UEs. The second UE-specific path switch request for the second UE, in some aspects, may include the multi-modal information including an indication (e.g., an identifier) of the first UE in the plurality of UEs. For example, referring to FIGS. 9, 10A, 10B, 11A, and 11B, the CU-CP 907, the CU-CP 1007, and the target CU-CP 1119 may obtain, the RRC reconfiguration complete message 958, 1058, and 1158 and the CU-CP 1007 and the target CU-CP 1119 may output a second UE-specific path switch request 1059 or 1159.

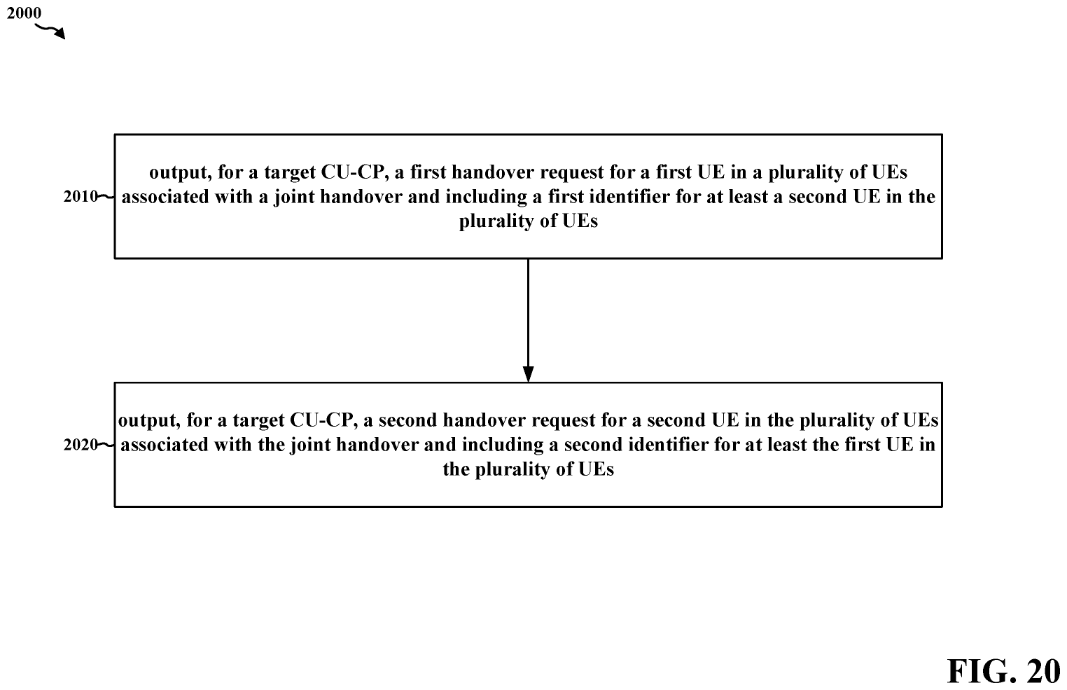

FIG. 20 is a flowchart 2000 of a method of wireless communication. The method may be performed by one or more of a network, a network component, or a network device (e.g., the base station 102; the sDU 903, 1003, 1103; the tDU 905, 1005, 1105; the CU-CP 907, 1007; the CU-UP 909; the AMF/UPF 1011, 1111; the source CU-UP 1013, 1113; the target CU-UP 1015, 1115; the source CU-CP 1117; the target CU-CP 1119; the network entity 2602, 2760). In some aspects, the method may be associated with a joint and/or common handover performed for a plurality of UEs (as an example of wireless devices) associated with a multi-modal service in a distributed architecture as discussed in any of FIG. 9, 10A, 10B, 11A, or 11B. The joint and/or common handover, in some aspects, may be for a handover from (1) a source base station or DU (an sDU or sDU) currently serving and/or connected to the plurality of UEs to (2) a target base station or DU (a tDU or tDU). The plurality of UEs may be associated with multi-modal information as discussed above in relation to FIG. 9, 10A, 10B, 11A, or 11B and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be a CU associated with a CP (a “CU-CP” associated with, or implementing, CP functions), and may receive a measurement report (or information regarding a measurement report) from a sDU associated with the plurality of UEs. The measurement report, in some aspects, may include information triggering the joint and/or common handover procedure for the plurality of UEs. For example, referring to FIG. 11A, the source CU-CP 1117 may obtain, and sDU 1103 may output, the message transfer 1121.

If the CU-CP for the sDU (e.g., the source CU-CP 1117) is not the same as the CU-CP for the tDU (e.g., the target CU-CP 1119), at 2010, the source CU-CP may output, and the target CU-CP may obtain, a first UE-specific handover request for a first UE in the plurality of UEs associated with a joint handover and including a first identifier for at least a second UE in the plurality of UEs. For example, 2010 may be performed by CU processor(s) 2612, communications interface 2618, network processor 2712, network interface 2780, and/or joint handover component 199 of FIGS. 26 and 27. In some aspects, the first UE-specific handover request may include multi-modal information indicating at least the second UE in the plurality of UEs. For example, referring to FIG. 11A, the source CU-CP 1117 may output, and the target CU-CP 1119 may obtain, the first UE-specific handover request 1122.

At 2020, the source CU-CP may output, and the target CU-CP may obtain, a second UE-specific handover request for a second UE in the plurality of UEs associated with a joint handover and including a second identifier for at least the first UE in the plurality of UEs. For example, 2020 may be performed by CU processor(s) 2612, communications interface 2618, network processor 2712, network interface 2780, and/or joint handover component 199 of FIGS. 26 and 27. In some aspects, the second UE-specific handover request may include multi-modal information indicating at least the first UE in the plurality of UEs. For example, referring to FIG. 11A, the source CU-CP 1117 may output, and the target CU-CP 1119 may obtain, the second UE-specific handover request 1123.

In some aspects, the CU-CP for the tDU may, based on the first and second UE-specific handover requests for the first and second UEs, output a first and second UE-specific bearer context setup message for the first and second UEs and obtain a first and second UE-specific bearer context response for the first and second UEs. In some aspects, the first and second UE-specific bearer context setup message and the first and second UE-specific bearer context response may include multi-modal information and may be exchanged with (output to, or obtained from, a CU device associated with a UP (a “CU-UP”) such as a CU-UP associated with the tDU (e.g., a target CU-UP). For example, referring to FIGS. 10A, 10B, 11A, and 11B, the CU-CP 1007 and the target CU-CP 1119 may output, and the target CU-UP 1015 and 1115 may obtain, the first UE-specific bearer context setup request 1125, the second UE-specific bearer context setup request 1126 and the target CU-UP 1015 and 1115 may output, and the CU-CP 1007 and the target CU-CP 1119 may obtain, the first UE-specific bearer context setup response 1128 and the second UE-specific bearer context setup response 1129.

If the CU-CP for the sDU (e.g., the source CU-CP 1117) is not the same as the CU-CP for the tDU (e.g., the target CU-CP 1119), the CU-CP for the sDU may obtain, and the CU-CP for the tDU may output, a first UE-specific handover request acknowledgment and a second UE-specific handover request acknowledgment in response to the first and second UE-specific handover requests, respectively. In some aspects, the first and second UE-specific handover request acknowledgment may include multi-modal information indicating at least the second UE and the first UE, respectively or other information identifying the first and second UE-specific handover request acknowledgments as being related to the first and second UE-specific handover requests. For example, referring to FIG. 11A, the source CU-CP 1117 may output, and the target CU-CP 1119 may obtain, the first UE-specific handover request acknowledgment 1135 and the second UE-specific handover request acknowledgment 1137.

If the CU-CP for the sDU (e.g., the source CU-CP 1117) is not the same as the CU-CP for the tDU (e.g., the target CU-CP 1119), the CU-CP for the sDU may output, and the sDU may obtain, a first and second UE-specific context modification request. In some aspects, the first and second UE-specific context modification requests may include multi-modal information. For example, referring to FIG. 11A, the source CU-CP 1117 may output, and the sDU 1103 may obtain, the first UE-specific context modification request 1136 and the second UE-specific context modification request 1138.

Based on the first and second UE-specific context modification requests, the CU-CP for the sDU, in some aspects, may obtain, from an sDU, a first and second UE-specific context modification response for the plurality of UEs. The first and second UE-specific context modification response, in some aspects, may include multi-modal information. For example, referring to FIGS. 9, 10A, 10B, 11A, and 11B, the CU-CP 907, the CU-CP 1007, and the source CU-CP 1117 may obtain, the first UE-specific context modification response 945, 1045, 1145 and the second UE-specific context modification response 948, 1048, 1148 from the sDU 903, 1003, or 1103.

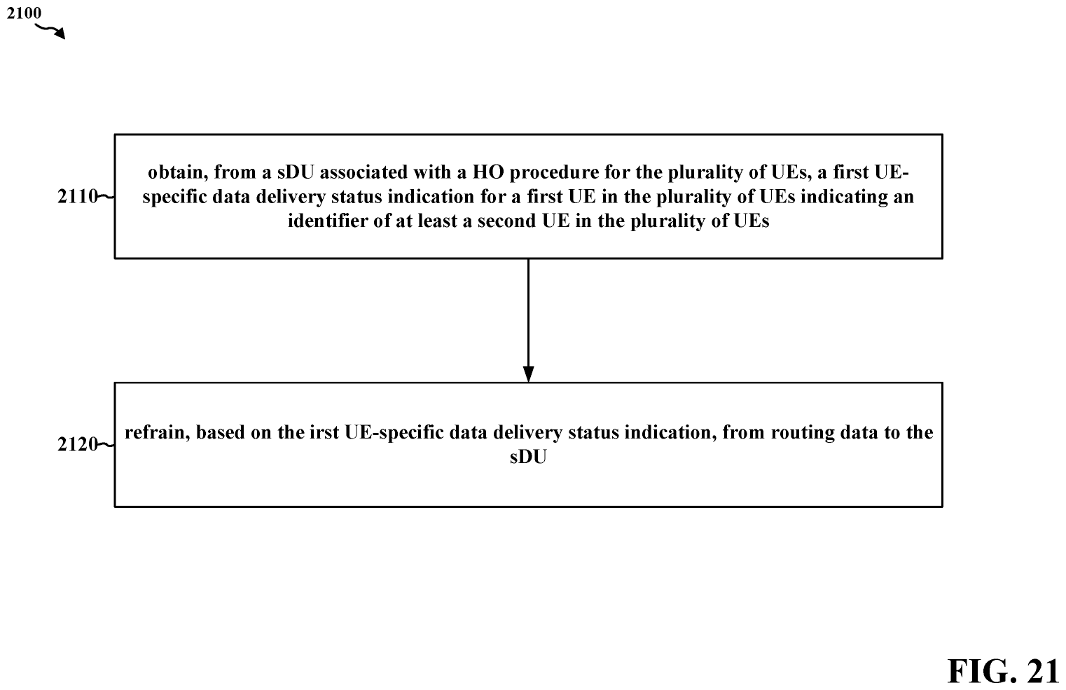

FIG. 21 is a flowchart 2100 of a method of wireless communication. The method may be performed by one or more of a network, a network component, or a network device (e.g., the base station 102; the sDU 903, 1003, 1103; the tDU 905, 1005, 1105; the CU-CP 907, 1007; the CU-UP 909; the AMF/UPF 1011, 1111; the source CU-UP 1013, 1113; the target CU-UP 1015, 1115; the source CU-CP 1117; the target CU-CP 1119; the network entity 2602, 2760). In some aspects, the method may be associated with a joint and/or common handover performed for a plurality of UEs (as an example of wireless devices) associated with a multi-modal service in a distributed architecture as discussed in any of FIG. 9, 10A, 10B, 11A, or 11B. The joint and/or common handover, in some aspects, may be for a handover from (1) a source base station or DU (an sDU or sDU) currently serving and/or connected to the plurality of UEs to (2) a target base station or DU (a tDU or tDU). The plurality of UEs may be associated with multi-modal information as discussed above in relation to FIG. 9, 10A, 10B, 11A, or 11B and if a message includes or indicates multi-modal information, it may include all, or part, of the multi-modal information including one or more of a service ID (or multi-modal service ID) and a plurality of flows (QOS flows), and a set of relationships between the flows in the plurality of flows.

At 2110, the network device (e.g., the CU-UP or a source CU-UP if the CU-UP is different for the source and target DUs) may obtain, from the sDU associated with the handover procedure for the plurality of UEs, a first UE-specific data delivery status indication for a first UE in the plurality of UEs. For example, 2110 may be performed by CU processor(s) 2612, communications interface 2618, network processor 2712, network interface 2780, and/or joint handover component 199 of FIGS. 26 and 27. The first UE-specific data delivery status, in some aspects, may include the multi-modal information indicating at least a second UE in the plurality of UEs. If more than two UEs are involved in the joint handover procedure, the first UE-specific data delivery status, in some aspects, indicates each of the additional UEs (e.g., besides the first UE) and or the plurality of UEs (e.g., including the first UE) as being associated with the joint handover procedure. For example, referring to FIGS. 9, 10A, 10B, 11A, and 11B, the CU-UP 909, the source CU-UP 1013, and the source CU-UP 1113 may obtain, the first UE-specific data delivery status frame 944, 1044, or 1144 from the sDU 903, 1003, and 1103.

At 2120, the network device (e.g., the CU-UP or the source CU-UP) may refrain, based on the first UE-specific data delivery status indication for the first UE in the plurality of UEs, from routing data for the plurality of UEs to the sDU. In some aspects, a source CU-UP may further begin routing and/or redirecting data (e.g., DL data from the AMF and/or UPF) to a target CU-UP. For example, 2120 may be CU processor(s) 2612, communications interface 2618, network processor 2712, network interface 2780, and/or joint handover component 199 of FIGS. 26 and 27. For example, referring to FIGS. 9, 10A, 10B, 11A, and 11B, the CU-UP 909, the source CU-UP 1013, and the source CU-UP 1113 may refrain, at 946, 1046, and 1146 from routing DL data from the UPF 911, or the AMF/UPF 1011 and 1111 to the sDU 903, 1003, and 1103. Additionally, the source CU-UP 1013 and the source CU-UP 1113 may begin, at 1046 and 1146, redirecting data to the target CU-UP 1015 and target CU-UP 1115, respectively.

The network device (e.g., the CU-UP or a source CU-UP) may obtain, from the sDU associated with the handover procedure for the plurality of UEs, a second UE-specific data delivery status indication for the second UE in the plurality of UEs. The second UE-specific data delivery status, in some aspects, may include the multi-modal information indicating at least the first UE in the plurality of UEs. If more than two UEs are involved in the joint handover procedure, the second UE-specific data delivery status, in some aspects, indicates each of the additional UEs (e.g., besides the second UE) and or the plurality of UEs (e.g., including the second UE) as being associated with the joint handover procedure. For example, referring to FIGS. 9, 10A, 10B, 11A, and 11B, the CU-UP 909, the source CU-UP 1013, and the source CU-UP 1113 may obtain, the second UE-specific data delivery status frame 947, 1047, or 1147 from the sDU 903, 1003, and 1103.

In some aspects, the network device may obtain, from a tDU associated with the handover procedure for the plurality of UEs, a third UE-specific data delivery status indication for a first UE in the plurality of UEs. The third UE-specific data delivery status, in some aspects, may include the multi-modal information indicating at least a second UE in the plurality of UEs. If more than two UEs are involved in the joint handover procedure, the third UE-specific data delivery status, in some aspects, indicates each of the additional UEs (e.g., besides the first UE) and or the plurality of UEs (e.g., including the first UE) as being associated with the joint handover procedure. For example, referring to FIGS. 9, 10A, 10B, 11A, and 11B, the CU-UP 909, the source CU-UP 1013, and the source CU-UP 1113 may obtain, the third UE-specific data delivery status 950, 1050, 1150 from the tDU 905, 1005, and 1105.

In some aspects, the network device may wait for UE-specific data delivery statuses or UE-specific data delivery status messages from each of the plurality of UEs indicated in the third UE-specific data delivery status before routing data for the plurality of UEs to a tDU. For example, referring to FIG. 9, the CU-UP 909 may wait, at 954, for at least the fourth UE-specific data delivery status 956 before beginning, at 960, to route data from the UPF 911 to the tDU 905.

The network device may obtain, from the tDU associated with the handover procedure for the plurality of UEs, a fourth UE-specific data delivery status indication for the second UE in the plurality of UEs. The fourth UE-specific data delivery status, in some aspects, may include the multi-modal information indicating at least the first UE in the plurality of UEs. If more than two UEs are involved in the joint handover procedure, the fourth UE-specific data delivery status, in some aspects, indicates each of the additional UEs (e.g., besides the second UE) and or the plurality of UEs (e.g., including the second UE) as being associated with the joint handover procedure. For example, referring to FIG. 9 the CU-UP 909 may obtain, the fourth UE-specific data delivery status 956 from the tDU 905.

The network device may begin, based on the fourth UE-specific data delivery status indication for the second UE in the plurality of UEs, routing data for the plurality of UEs to the tDU. For example, referring to FIG. 9, the CU-UP 909 may begin, at 960, routing DL data from the UPF 911 to the tDU 905.

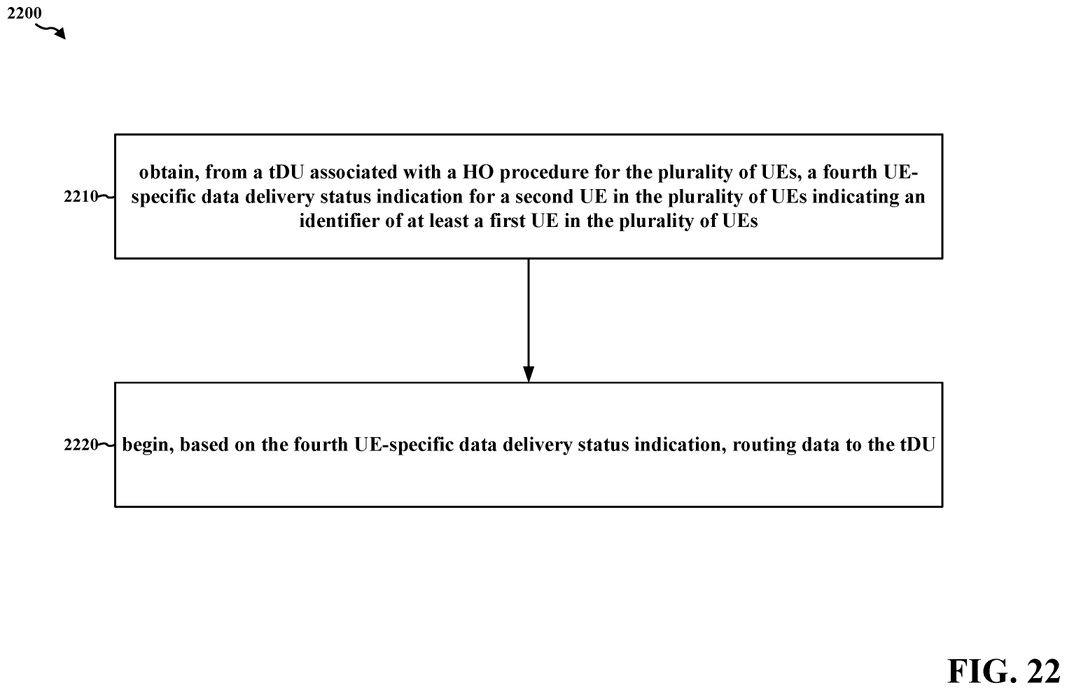

FIG. 22 is a flowchart 2200 of a method of wireless communication. The method may be performed by one or more of a network, a network component, or a network device (e.g., the base station 102; the sDU 903, 1003, 1103; the tDU 905, 1005, 1105; the CU-CP 907, 1007; the CU-UP 909; the AMF/UPF 1011, 1111; the source CU-UP 1013, 1113; the target CU-UP 1015, 1115; the source CU-CP 1117; the target CU-CP 1119; the network entity 2602, 2760). In some aspects, the method may be associated with a joint and/or common handover performed for a plurality of UEs (as an example of wireless devices) associated with a multi-modal service in a distributed architecture as discussed in any of FIG. 9, 10A, 10B, 11A, or 11B. The joint and/or common handover, in some aspects, may be for a handover from (1) a source base station or DU (an sDU or sDU) currently serving and/or connected to the plurality of UEs to (2) a target base station or DU (a tDU or tDU). The plurality of UEs may be associated with multi-modal information as discussed above in relation to FIG. 9, 10A, 10B, 11A, or 11B and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be a CU associated with a UP (a “CU-UP” associated with, or implementing, UP functions). If the CU-UP for the sDU (e.g., a source CU-UP such as the source CU-UP 1013 or 1113) is not the same as the CU-UP for the tDU (e.g., a target CU-UP such as the target CU-UP 1015 or 1115), the target CU-UP may obtain, from a target CU-CP, a first UE-specific bearer context setup request for a first UE in the plurality of UEs and a second UE-specific bearer context setup request for the second UE. The first and second UE-specific bearer context setup requests, in some aspects, may include the multi-modal information. For example, referring to FIGS. 10A and 11A, the target CU-UP 1015 and 1115 may obtain, from target CU-CP 1019 and 1119, respectively, the first UE-specific bearer context setup request 1025 and 1125 and the second UE-specific bearer context setup request 1026 and 1126.

The target CU-UP, in some aspects, may determine based on receiving the first and second UE-specific bearer context setup requests (if the plurality of UEs includes only the first and second UEs) to check resources for the plurality of UEs. The target CU-UP may determine that it has available resources to support the plurality of UEs and may, based on the UE-specific bearer context setup requests for the plurality of UEs, output a UE-specific bearer context setup response for each of the plurality of UEs. The UE-specific bearer context setup responses, in some aspects, may include the multi-modal information. In some aspects, the UE-specific bearer context setup responses may be output for, or provided to, a target CU-CP. For example, referring to FIGS. 10A, 10B, 11A, and 11B, the target CU-CP 1019 and 1119 may wait for the first UE-specific bearer context setup request 1025 and 1125 and the second UE-specific bearer context setup request 1026 and 1126 to be received before determining at 1027 and 1127, to check for available resources and output, the first UE-specific bearer context setup response 1028 and 1128 and the second UE-specific bearer context setup response 1029 and 1129.

In some aspects, the network device may obtain, from a tDU associated with the handover procedure for the plurality of UEs, a third UE-specific data delivery status indication for a first UE in the plurality of UEs. The third UE-specific data delivery status, in some aspects, may include the multi-modal information indicating at least a second UE in the plurality of UEs. If more than two UEs are involved in the joint handover procedure, the third UE-specific data delivery status, in some aspects, indicates each of the additional UEs (e.g., besides the first UE) and or the plurality of UEs (e.g., including the first UE) as being associated with the joint handover procedure. For example, referring to FIGS. 9, 10A, 10B, 11A, and 11B, the CU-UP 909, the source CU-UP 1013, and the source CU-UP 1113 may obtain, the third UE-specific data delivery status 950, 1050, 1150 from the tDU 905, 1005, and 1105.

In some aspects, the network device may wait for UE-specific data delivery statuses or UE-specific data delivery status messages from each of the plurality of UEs indicated in the third UE-specific data delivery status before routing data for the plurality of UEs to a tDU. For example, referring to FIGS. 10B and 11B, the target CU-UP 1015 and 1115 may wait, at 1054 and 1154, for at least the fourth UE-specific data delivery status 1056 and 1156 before beginning to route data (e.g., pending the path switch at 1060) from the AMF/UPF 1011 and 1111 to the tDU 905.

At 2210, the network device may obtain, from the tDU associated with the handover procedure for the plurality of UEs, a fourth UE-specific data delivery status indication for the second UE in the plurality of UEs. For example, 2210 may be performed by CU processor(s) 2612, communications interface 2618, network processor 2712, network interface 2780, and/or joint handover component 199 of FIGS. 26 and 27. The fourth UE-specific data delivery status, in some aspects, may include the multi-modal information indicating at least the first UE in the plurality of UEs. If more than two UEs are involved in the joint handover procedure, the fourth UE-specific data delivery status, in some aspects, indicates each of the additional UEs (e.g., besides the second UE) and or the plurality of UEs (e.g., including the second UE) as being associated with the joint handover procedure. For example, referring to FIGS. 10B and 11B the target CU-UP 1015 and 1115 may obtain, the fourth UE-specific data delivery status 1056 and the 1156 from the tDU 905.

At 2220, the network device may begin, based on the fourth UE-specific data delivery status indication for the second UE in the plurality of UEs, routing data for the plurality of UEs to the tDU. For example, 2220 may be performed by CU processor(s) 2612, communications interface 2618, network processor 2712, network interface 2780, and/or joint handover component 199 of FIGS. 26 and 27. For example, referring to FIGS. 10B and 11B, the target CU-UP 1015 and 1115 may obtain the fourth UE-specific data delivery status 1056 and 1156 and begin routing data for the plurality of UEs (e.g., pending the path switch at 1060) from the AMF/UPF 1011 and 1111 to the tDU 905.

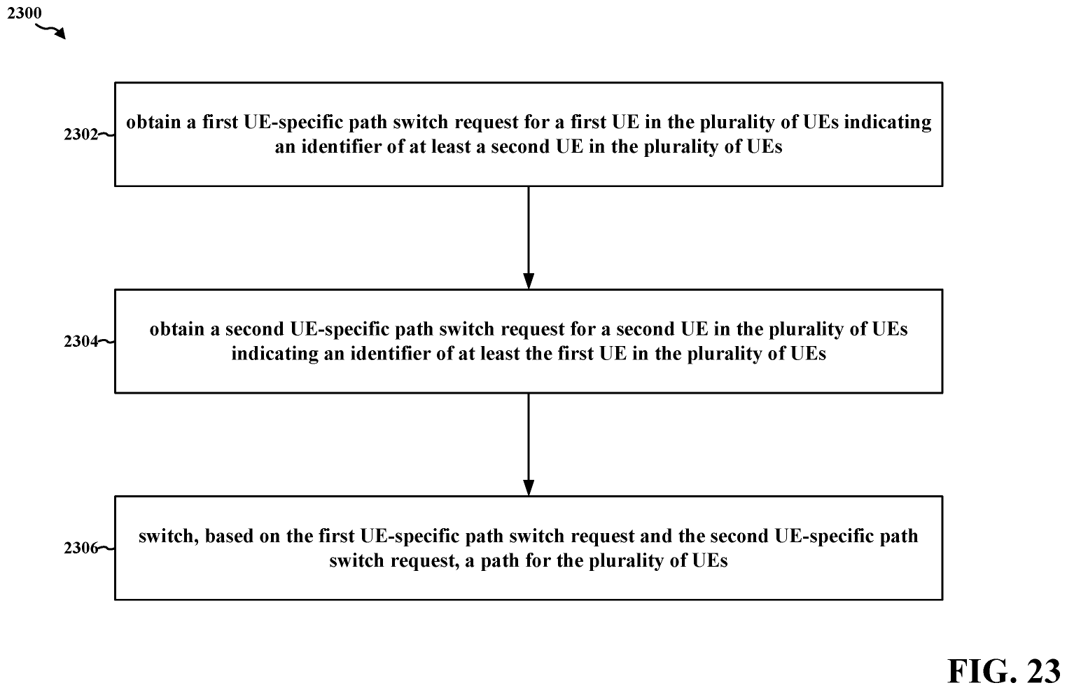

FIG. 23 is a flowchart 2300 of a method of wireless communication. The method may be performed by one or more of a network, a network component, or a network device (e.g., the base station 102; the sDU 903, 1003, 1103; the tDU 905, 1005, 1105; the CU-CP 907, 1007; the CU-UP 909; the AMF/UPF 1011, 1111; the source CU-UP 1013, 1113; the target CU-UP 1015, 1115; the source CU-CP 1117; the target CU-CP 1119; the network entity 2602, 2760). In some aspects, the method may be associated with a joint and/or common handover performed for a plurality of UEs (as an example of wireless devices) associated with a multi-modal service in a distributed architecture as discussed in any of FIG. 9, 10A, 10B, 11A, or 11B. The joint and/or common handover, in some aspects, may be for a handover from (1) a source base station or DU (an sDU or sDU) currently serving and/or connected to the plurality of UEs to (2) a target base station or DU (a tDU or tDU). The plurality of UEs may be associated with multi-modal information as discussed above in relation to FIG. 9, 10A, 10B, 11A, or 11B and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be an AMF/UPF associated with the handover procedure and/or the plurality of UEs. At 2302, the network device may obtain a first UE-specific path switch request for the first UE in the plurality of UEs.

For example, 2302 may be performed by network processor 2712, network interface 2780, and/or joint handover component 199 of FIG. 27. The first UE-specific path switch request for the first UE, in some aspects, may include the multi-modal information including an indication of the second UE in the plurality of UEs. For example, referring to FIGS. 10B and 11B, the AMF/UPF 1011 and the 1111 may obtain, the first UE-specific path switch request 1053 or 1153.

At 2304, the network device may obtain a second UE-specific path switch request for the second UE in the plurality of UEs. For example, 2304 may be performed by network processor 2712, network interface 2780, and/or joint handover component 199 of FIG. 27. The second UE-specific path switch request for the second UE, in some aspects, may include the multi-modal information including an indication of the first UE in the plurality of UEs. For example, referring to FIGS. 10B and 11B, the AMF/UPF 1011 and the 1111 may obtain, the second UE-specific path switch request 1059 or 1159.

At 2306, the network device may switch, based on the first and second UE-specific path switch requests, a path for the plurality of UEs. For example, 2306 may be performed by network processor 2712, network interface 2780, and/or joint handover component 199 of FIG. 27. For example, referring to FIGS. 10A, 10B, 11A, and 11B, the AMF/UPF 1011 and 1111 may switch, at 1074 and 1174.

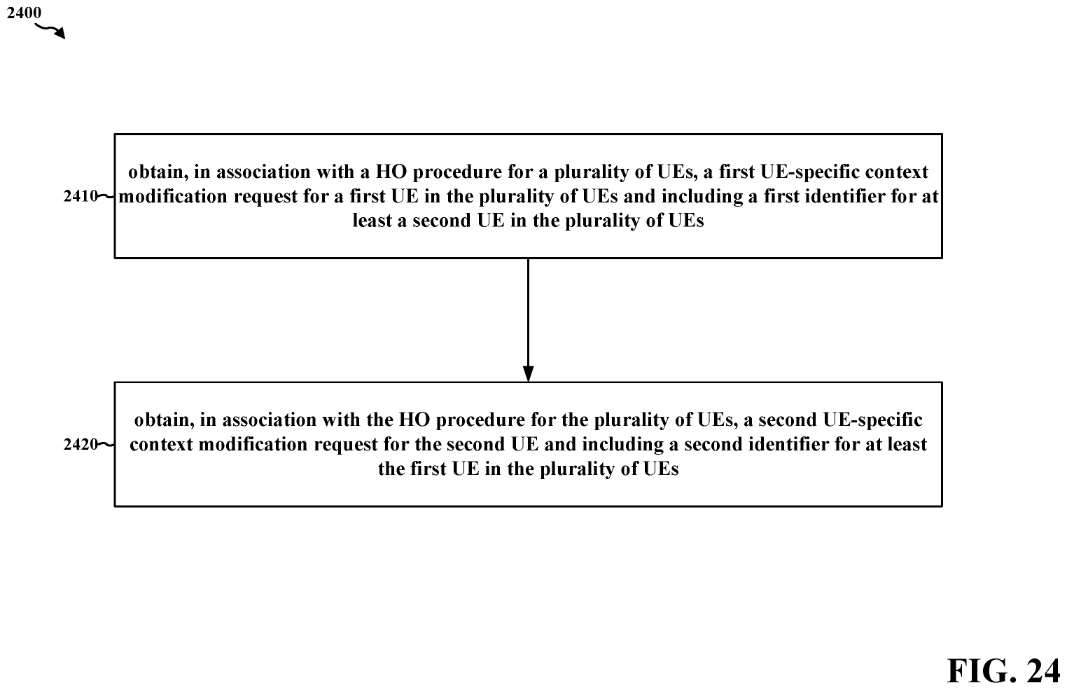

FIG. 24 is a flowchart 2400 of a method of wireless communication. The method may be performed by one or more of a network, a network component, or a network device (e.g., the base station 102; the sDU 903, 1003, 1103; the tDU 905, 1005, 1105; the CU-CP 907, 1007; the CU-UP 909; the AMF/UPF 1011, 1111; the source CU-UP 1013, 1113; the target CU-UP 1015, 1115; the source CU-CP 1117; the target CU-CP 1119; the network entity 2602, 2760). In some aspects, the method may be associated with a joint and/or common handover performed for a plurality of UEs (as an example of wireless devices) associated with a multi-modal service in a distributed architecture as discussed in any of FIG. 9, 10A, 10B, 11A, or 11B. The joint and/or common handover, in some aspects, may be for a handover from (1) a source base station or DU (an sDU or sDU) currently serving and/or connected to the plurality of UEs to (2) a target base station or DU (a tDU or tDU). The plurality of UEs may be associated with multi-modal information as discussed above in relation to FIG. 9, 10A, 10B, 11A, or 11B and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be the source DU. The source DU, in some aspects, may output a measurement report (or information regarding a measurement report) to a CU-CP or source CU-CP. The measurement report, in some aspects, may include information triggering the joint and/or group handover procedure for the plurality of UEs. For example, referring to FIGS. 9, 10A, and 11A, the sDU 903, 1003, and 1103, may output the message transfer 921, 1021, and 1121.

At 2410 The network device, in some aspects, may obtain, from the CU-CP or the source CU-CP, a first UE-specific context modification request (a UE-specific request relating to a context modification) for a first UE in the plurality of UEs. For example, 2410 may be performed by DU processor(s) 2632, transceiver(s) 2646, antenna(s) 2680, and/or joint handover component 199 of FIG. 26. The first UE-specific context modification request, in some aspects, may include the multi-modal information including an indication of the second UE in the plurality of UEs. In some aspects, the first UE-specific context modification request may include an RRC reconfiguration message (or RRC reconfiguration parameters) for the first UE. For example, referring to FIGS. 9, 10A, and 11A, the sDU 903, 1003, and 1103, may obtain the first UE-specific context modification request 936, 1036, 1136.

At 2420, the network device, in some aspects, may obtain, from the CU-CP or the source CU-CP, a second UE-specific context modification request (a UE-specific request relating to a context modification) for the second UE in the plurality of UEs. For example, 2420 may be performed by DU processor(s) 2632, transceiver(s) 2646, antenna(s) 2680, and/or joint handover component 199 of FIG. 26. The second UE-specific context modification request, in some aspects, may include the multi-modal information including an indication of the first UE in the plurality of UEs. In some aspects, the second UE-specific context modification request may include an RRC reconfiguration message (or RRC reconfiguration parameters) for the second UE. For example, referring to FIGS. 9, 10A, and 11A, the sDU 903, 1003, and 1103, may obtain the second UE-specific context modification request 938, 1038, 1138.

In some aspects, the network device may determine, based on receiving a UE-specific context modification request for each of the plurality of UEs, to forward the RRC reconfigurations for the plurality of UEs received in the plurality of UE-specific context modification requests. For example, referring to FIGS. 9, 10A, and 11A, the sDU 903, 1003, and 1103, may determine at 939, 1039, and 1139, to forward the plurality of RRC reconfigurations 940, 1040, and 1140 included in the first UE-specific context modification request 936, 1036, and 1136 and the second UE-specific context modification request 938, 1038, 1138. The network device may output (or transmit) the plurality of RRC reconfiguration messages received in the plurality of UE-specific context modification requests (e.g., at least the first and second UE-specific context modification requests). For example, referring to FIGS. 9, 10A, and 11A, the sDU 903, 1003, and 1103, may output the plurality of RRC reconfigurations 940, 1040, and 1140.

In some aspects, the network device may output, for a CU-UP (e.g., the CU-UP or the source CU-UP) associated with the handover procedure for the plurality of UEs, a first UE-specific data delivery status indication for the first UE in the plurality of UEs. The first UE-specific data delivery status, in some aspects, may include the multi-modal information including an indication of the second UE in the plurality of UEs. For example, referring to FIGS. 9, 10A, and 11A, the sDU 903, 1003, and 1103, may output the first UE-specific data delivery status frame 944, 1044, and 1144.

Based on the first UE-specific context modification request, the sDU, may output, for a CU-CP or a source CU-CP, a first UE-specific context modification response for the first UE in the plurality of UEs. The first UE-specific context modification response, in some aspects, may include the multi-modal information including an indication of the second UE in the plurality of UEs. For example, referring to FIGS. 9, 10A, and 11A, the sDU 903, 1003, and 1103, may output the first UE-specific context modification response 945, 1045, and 1145.

In some aspects, the network device may output, for a CU-UP (e.g., the CU-UP or the source CU-UP) associated with the handover procedure for the plurality of UEs, a second UE-specific data delivery status indication for the second UE in the plurality of UEs. The second UE-specific data delivery status, in some aspects, may include the multi-modal information including an indication of the first UE in the plurality of UEs. For example, referring to FIGS. 9, 10A, and 11A, the sDU 903, 1003, and 1103, may output the second UE-specific data delivery status frame 947, 1047, and 1147.

Based on the second UE-specific context modification request, the sDU, may output, for a CU-CP or a source CU-CP, a second UE-specific context modification response for the second UE in the plurality of UEs. The second UE-specific context modification response, in some aspects, may include the multi-modal information including an indication of the first UE in the plurality of UEs. For example, referring to FIGS. 9, 10A, and 11A, the sDU 903, 1003, and 1103, may output the second UE-specific context modification response 948, 1048, and 1148.

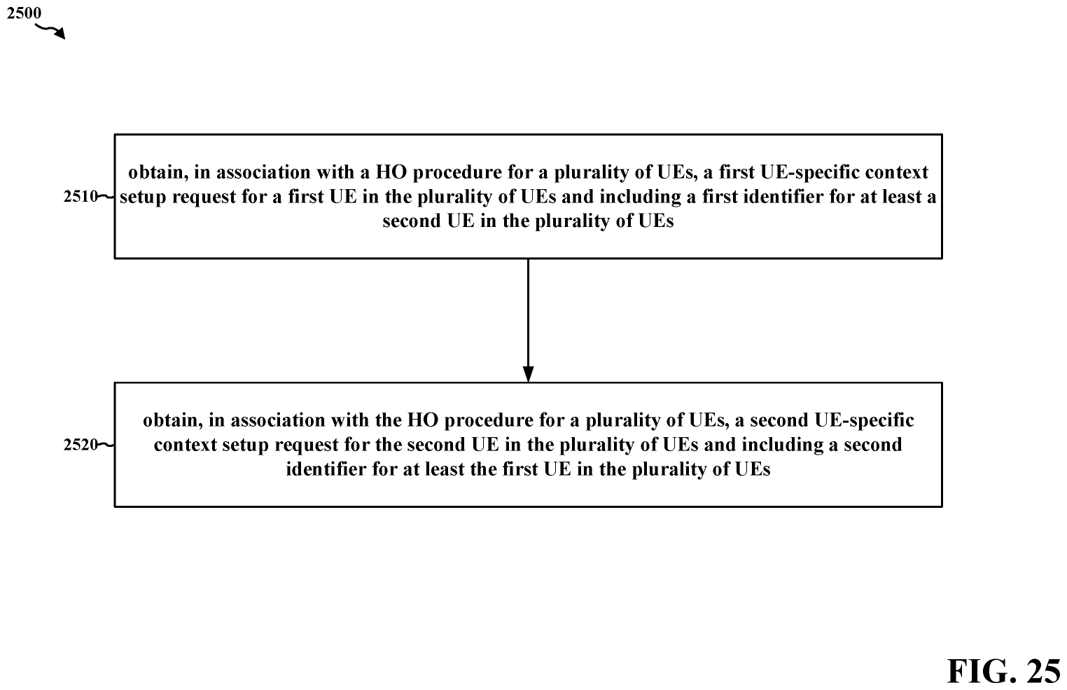

FIG. 25 is a flowchart 2500 of a method of wireless communication. The method may be performed by one or more of a network, a network component, or a network device (e.g., the base station 102; the sDU 903, 1003, 1103; the tDU 905, 1005, 1105; the CU-CP 907, 1007; the CU-UP 909; the AMF/UPF 1011, 1111; the source CU-UP 1013, 1113; the target CU-UP 1015, 1115; the source CU-CP 1117; the target CU-CP 1119; the network entity 2602, 2760). In some aspects, the method may be associated with a joint and/or common handover performed for a plurality of UEs (as an example of wireless devices) associated with a multi-modal service in a distributed architecture as discussed in any of FIG. 9, 10A, 10B, 11A, or 11B. The joint and/or common handover, in some aspects, may be for a handover from (1) a source base station or DU (an sDU or sDU) currently serving and/or connected to the plurality of UEs to (2) a target base station or DU (a tDU or tDU). The plurality of UEs may be associated with multi-modal information as discussed above in relation to FIG. 9, 10A, 10B, 11A, or 11B and if a message includes or indicates multi-modal information, it may include all, or part, of the multi-modal information including one or more of a service ID (or multi-modal service ID) and a plurality of flows (QOS flows), and a set of relationships between the flows in the plurality of flows.

In some aspects, the network device may be the target DU. At 2510 The network device, in some aspects, may obtain, from the CU-CP or the target CU-CP, a first UE-specific context setup request for the first UE in the plurality of UEs. For example, 2510 may be performed by DU processor(s) 2632, transceiver(s) 2646, antenna(s) 2680, and/or joint handover component 199 of FIG. 26. The first UE-specific context setup request, in some aspects, may include the multi-modal information including an indication of the second UE in the plurality of UEs. For example, referring to FIGS. 9, 10A, and 11A, the tDU 905, 1005, and 1105, may obtain the first UE-specific context setup request 930, 1030, 1130.

At 2520, the network device, in some aspects, may obtain, from the CU-CP or the target CU-CP, a second UE-specific context setup request for the second UE in the plurality of UEs. For example, 2520 may be performed by DU processor(s) 2632, transceiver(s) 2646, antenna(s) 2680, and/or joint handover component 199 of FIG. 26. The second UE-specific context setup request, in some aspects, may include the multi-modal information including an indication of the first UE in the plurality of UEs. For example, referring to FIGS. 9, 10A, and 11A, the tDU 905, 1005, and 1105, may obtain the second UE-specific context setup request 931, 1031, 1131.

In some aspects, the network device may, based on receiving the plurality of UE-specific context setup requests, determine to check for available resources for the joint handover. For example, referring to FIGS. 9, 10A, and 11A, the tDU 905, 1005, and 1105, may determine, at 932, 0132, and 1132, to check for resources for the plurality of UEs. Based on checking for the resources, the network device may output, for the CU-CP or the target CU-CP, a first UE-specific context setup response for the first UE in the plurality of UEs. The first UE-specific context setup response, in some aspects, may include the multi-modal information including an indication of the second UE in the plurality of UEs. For example, referring to FIGS. 9, 10A, and 11A, the tDU 905, 1005, and 1105, may output the first UE-specific context setup response 933, 1033, 1133.

In some aspects, the network device, in some aspects, may output, for the CU-CP or the target CU-CP, a second UE-specific context setup response for the second UE in the plurality of UEs. The second UE-specific context setup response, in some aspects, may include the multi-modal information including an indication of the first UE in the plurality of UEs. For example, referring to FIGS. 9, 10A, and 11A, the tDU 905, 1005, and 1105, may output the second UE-specific context setup response 934, 1034, 1134.

In some aspects, the network device may output, for a CU-UP (e.g., the CU-UP or the target CU-UP) associated with the handover procedure for the plurality of UEs, a third UE-specific data delivery status indication for the first UE in the plurality of UEs. The third UE-specific data delivery status, in some aspects, may include the multi-modal information including an indication of the second UE in the plurality of UEs. For example, referring to FIGS. 9, 10A, and 11A, the tDU 905, 1005, and 1105, may output the third UE-specific data delivery status 950, 1050, and 1150.

In some aspects, the network device may output, for a CU-UP (e.g., the CU-UP or the target CU-UP) associated with the handover procedure for the plurality of UEs, a fourth UE-specific data delivery status indication for the second UE in the plurality of UEs. The fourth UE-specific data delivery status, in some aspects, may include the multi-modal information including an indication of the first UE in the plurality of UEs. For example, referring to FIGS. 9, 10A, and 11A, the tDU 905, 1005, and 1105, may output the fourth UE-specific data delivery status 956, 1056, and 1156.

FIG. 26 is a diagram 2600 illustrating an example of a hardware implementation for a network entity 2602. The network entity 2602 may be a BS, a component of a BS, or may implement BS functionality. The network entity 2602 may include at least one of a CU 2610, a DU 2630, or an RU 2640. For example, depending on the layer functionality handled by the joint handover component 199, the network entity 2602 may include the CU 2610; both the CU 2610 and the DU 2630; each of the CU 2610, the DU 2630, and the RU 2640; the DU 2630; both the DU 2630 and the RU 2640; or the RU 2640. The CU 2610 may include at least one CU processor 2612. The CU processor(s) 2612 may include on-chip memory 2612′. In some aspects, the CU 2610 may further include additional memory modules 2614 and a communications interface 2618. The CU 2610 communicates with the DU 2630 through a midhaul link, such as an F1 interface. The DU 2630 may include at least one DU processor 2632. The DU processor(s) 2632 may include on-chip memory 2632′. In some aspects, the DU 2630 may further include additional memory modules 2634 and a communications interface 2638. The DU 2630 communicates with the RU 2640 through a fronthaul link. The RU 2640 may include at least one RU processor 2642. The RU processor(s) 2642 may include on-chip memory 2642′. In some aspects, the RU 2640 may further include additional memory modules 2644, one or more transceivers 2646, one or more antennas 2680, and a communications interface 2648. The RU 2640 communicates with the UE 104. The on-chip memory 2612′, 2632′, 2642′ and the additional memory modules 2614, 2634, 2644 may each be considered a computer-readable medium/memory. Each computer-readable medium/memory may be non-transitory. Each of the processors 2612, 2632, 2642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the joint handover component 199 may be configured to output, for a target DU associated with a handover procedure for the plurality of wireless devices, a first common request relating to a context of the plurality of wireless devices and obtain, from the target DU and based on the first common request, a first common response relating to the context of the plurality of wireless devices. In some aspects the joint handover component 199 may be configured to obtaining, for a handover procedure for the plurality of wireless devices from the source DU to a target DU, a common context modification request relating to modifying a context of the plurality of wireless devices and output, based on the common context modification request, a first common data delivery status indication for the plurality of wireless devices. In some aspects the joint handover component 199 may be configured to obtain, for a handover procedure for the plurality of wireless devices from a source DU to a target DU, a common context setup request relating to modifying a context of the plurality of wireless devices and output, based on the common context setup request, a common context setup response for the plurality of wireless devices. In some aspects the joint handover component 199 may be configured to obtain, from a source DU associated with a handover procedure for the plurality of wireless devices, a first common data delivery status indication relating to the plurality of wireless devices refrain, based on the first common data delivery status indication, from routing data for the plurality of wireless devices to the source DU. In some aspects the joint handover component 199 may be configured to obtain, from a target DU associated with the handover procedure for the plurality of wireless devices, a common data delivery status indication relating to the plurality of wireless devices and route, based on the common data delivery status indication, data to the target DU. In some aspects the joint handover component 199 may be configured to output, for a target distributed unit (DU) associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure, and output, for the target DU, a second request relating to a second context of the second wireless device in the plurality of wireless devices, wherein the second request comprises a second identifier of at least the first wireless device. In some aspects the joint handover component 199 may be configured to obtain, in association with a handover procedure for the plurality of wireless devices, a first context modification request for a first wireless device in the plurality of wireless devices, wherein the first context modification request comprises a first identifier for at least a second wireless device in the plurality of wireless devices and obtain, in association with the handover procedure for the plurality of wireless devices, a second context modification request for the second wireless device, wherein the second context modification request comprises a second identifier for at least the first wireless device in the plurality of wireless devices. In some aspects the joint handover component 199 may be configured to obtain, in association with a handover procedure for the plurality of wireless devices, a first context setup request for a first wireless device in the plurality of wireless devices, wherein the first context setup request comprises a first identifier for at least a second wireless device in the plurality of wireless devices and obtain, in association with the handover procedure for the plurality of wireless devices, a second context setup request for the second wireless device, wherein the second context setup request comprises a second identifier for at least the first wireless device in the plurality of wireless devices. In some aspects the joint handover component 199 may be configured to obtain, from a source DU associated with a handover procedure for the plurality of wireless devices, a first data delivery status indication, wherein the first data delivery status indication comprises a first identifier for at least a second wireless device in the plurality of wireless devices and refrain, based on the first data delivery status indication, from routing data for the plurality of wireless devices to the source DU. In some aspects the joint handover component 199 may be configured to obtain, from a target DU associated with the handover procedure for the plurality of wireless devices, a last data delivery status indication in a plurality of data delivery status indications for the plurality of wireless devices, wherein each data delivery status indication is for a different wireless device in the plurality of wireless devices and comprises at least one identifier for at least one other wireless device in the plurality of wireless devices and route, based on the last data delivery status indication, data for the plurality of wireless devices to the target DU. The joint handover component 199 may be within one or more processors of one or more of the CU 2610, DU 2630, and the RU 2640. The joint handover component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination.

The network entity 2602 may include a variety of components configured for various functions. In one configuration, the network entity 2602 may include means for outputting, for a target distributed unit (DU) associated with a handover procedure for the plurality of wireless devices, a first common request relating to a context of the plurality of wireless devices. The network entity 2602 may include means for obtaining, from the target DU and based on the first common request, a first common response relating to the context of the plurality of wireless devices. The network entity 2602 may include means for outputting, for a source DU associated with the handover procedure for the plurality of wireless devices, a second common request to modify the context of the plurality of wireless devices based on the first common response. The network entity 2602 may include means for obtaining, from the source DU and based on the second common request, a second common response relating to the context of the plurality of wireless devices. The network entity 2602 may include means for obtaining a plurality of individual indications that a radio resource control (RRC) reconfiguration has completed for each wireless device in the plurality of wireless devices. The network entity 2602 may include means for outputting, based on the plurality of individual indications, a common path switch request to an access and mobility management function (AMF) for the plurality of wireless devices. The network entity 2602 may include means for obtaining a common path switch request acknowledgment for the plurality of wireless devices. The network entity 2602 may include means for releasing, based on at least one of the plurality of individual indications and the common path switch request acknowledgment, contexts associated with the plurality of wireless devices at a source DU. The network entity 2602 may include means for obtaining a measurement report triggering the handover procedure for the plurality of wireless devices, wherein outputting the first common request is based on the measurement report. The network entity 2602 may include means for outputting, for a user plane (UP) of a second CU associated with the target DU and based on the measurement report, a third common request associated with a bearer context setup for the plurality of wireless devices. The network entity 2602 may include means for obtaining, from the UP of the second CU, a third common response associated with the bearer context setup, wherein the first common request is output based on the third common response. The network entity 2602 may include means for obtaining a common handover procedure request for the plurality of wireless devices. The network entity 2602 may include means for outputting, based on the common handover procedure request, a common handover procedure request acknowledgment for the plurality of wireless devices. The network entity 2602 may include means for outputting, for a user plane (UP) of a second CU associated with the target DU and based on the common handover procedure request, a third common request associated with a bearer context setup for the plurality of wireless devices. The network entity 2602 may include means for obtaining, from the UP of the second CU, a third common response associated with the bearer context setup, wherein the first common request is output based on the third common response. The network entity 2602 may include means for obtaining a common sequence number (SN) status transfer message indicating that a second CP of a third CU will stop assigning SNs. The network entity 2602 may include means for obtaining, for a handover procedure for the plurality of wireless devices from the source DU to a target DU, a common context modification request relating to modifying a context of the plurality of wireless devices. The network entity 2602 may include means for outputting, based on the common context modification request, a first common data delivery status indication for the plurality of wireless devices. The network entity 2602 may include means for outputting, for each of the plurality of wireless devices, one of the plurality of individual RRC reconfiguration messages corresponding to the wireless device. The network entity 2602 may include means for outputting, based on the common context modification request, a common context modification response for the plurality of wireless devices. The network entity 2602 may include means for obtaining, for a handover procedure for the plurality of wireless devices from a source DU to a target DU, a common context setup request relating to modifying a context of the plurality of wireless devices. The network entity 2602 may include means for outputting, based on the common context setup request, a common context setup response for the plurality of wireless devices. The network entity 2602 may include means for outputting, based on the common context setup request, a first common data delivery status indication for the plurality of wireless devices. The network entity 2602 may include means for receiving, from the plurality of wireless devices, at least a first message of a random access procedure for each of the plurality of wireless devices, wherein outputting the first common data delivery status indication is further based on the first message of the random access procedure for each of the plurality of wireless devices. The network entity 2602 may include means for obtaining, from a source DU associated with a handover procedure for the plurality of wireless devices, a first common data delivery status indication relating to the plurality of wireless devices. The network entity 2602 may include means for refraining, based on the first common data delivery status indication, from routing data for the plurality of wireless devices to the source DU. The network entity 2602 may include means for obtaining, from a target DU associated with the handover procedure for the plurality of wireless devices, a common data delivery status indication relating to the plurality of wireless devices. The network entity 2602 may include means for routing, based on the common data delivery status indication, data to the target DU. The network entity 2602 may include means for outputting, for a target distributed unit (DU) associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure. The network entity 2602 may include means for outputting, for the target DU, a second request relating to a second context of the second wireless device in the plurality of wireless devices, wherein the second request comprises a second identifier of at least the first wireless device. The network entity 2602 may include means for obtaining, from a second CP of a second CU associated with the joint handover procedure for the plurality of wireless devices, a first handover request for the first wireless device in the plurality of wireless devices, wherein the first request comprises the first identifier of at least the second wireless device in the plurality of wireless devices. The network entity 2602 may include means for obtaining, from the second CP of the second CU, a second handover request for the second wireless device in the plurality of wireless devices, wherein the second request comprises the second identifier of at least the first wireless device. The network entity 2602 may include means for outputting, for the second CP of the second CU, a first handover request acknowledgment for the first wireless device in the plurality of wireless devices, wherein the first handover request acknowledgment comprises the first identifier of at least the second wireless device in the plurality of wireless devices. The network entity 2602 may include means for outputting, from the second CP of the second CU, a second handover request acknowledgment for the second wireless device in the plurality of wireless devices, wherein the second handover request acknowledgment comprises the second identifier of at least the first wireless device. The network entity 2602 may include means for performing, based on the first handover request and the second handover request, a call admission control for the first wireless device and the second wireless device. The network entity 2602 may include means for outputting, based on the first handover request and the second handover request, a first bearer context setup request for the first wireless device, wherein the first bearer context setup request comprises the first identifier of at least the second wireless device in the plurality of wireless devices. The network entity 2602 may include means for outputting, based on the first handover request and the second handover request, a second bearer context setup request for the second wireless device, wherein the second bearer context setup request comprises the second identifier of at least the first wireless device. The network entity 2602 may include means for obtaining, based on the first bearer context setup request, a first bearer context setup response for the first wireless device, wherein the first bearer context setup response comprises the first identifier of at least the second wireless device in the plurality of wireless devices. The network entity 2602 may include means for obtaining, based on the second bearer context setup request, a second bearer context setup response for the second wireless device, wherein the second bearer context setup request comprises the second identifier of at least the first wireless device. The network entity 2602 may include means for obtaining, from the target DU, a first context setup response relating to the first context of the first wireless device in the plurality of wireless devices, wherein the first context setup response comprises the first identifier of at least the second wireless device in the plurality of wireless devices associated with the joint handover procedure. The network entity 2602 may include means for obtaining, from the target DU, a second context setup response relating to the second context of the second wireless device in the plurality of wireless devices, wherein the second context setup response comprises the second identifier of at least the first wireless device in the plurality of wireless devices associated with the joint handover procedure. The network entity 2602 may include means for obtaining a first indication of a completion of a radio resource control (RRC) reconfiguration for the first wireless device. The network entity 2602 may include means for outputting, based on the first indication, a first path switch request for the first wireless device, wherein the first path switch request comprises the first identifier of at least the second wireless device in the plurality of wireless devices. The network entity 2602 may include means for obtaining a second indication of an additional completion of an additional RRC reconfiguration for the second wireless device. The network entity 2602 may include means for outputting, based on the second indication, a second path switch request for the second wireless device, wherein the second path switch request comprises the second identifier of at least the first wireless device in the plurality of wireless devices. The network entity 2602 may include means for obtaining, in association with a handover procedure for the plurality of wireless devices, a first context modification request for a first wireless device in the plurality of wireless devices, wherein the first context modification request comprises a first identifier for at least a second wireless device in the plurality of wireless devices. The network entity 2602 may include means for obtaining, in association with the handover procedure for the plurality of wireless devices, a second context modification request for the second wireless device, wherein the second context modification request comprises a second identifier for at least the first wireless device in the plurality of wireless devices. The network entity 2602 may include means for outputting, based on obtaining the first context modification request and the second context modification request, the first individual RRC reconfiguration message for the first wireless device and the second individual RRC reconfiguration message for the second wireless device. The network entity 2602 may include means for outputting, based on the first context modification request, a first context modification response for the first wireless device, wherein the first context modification response comprises the first identifier for at least the second wireless device in the plurality of wireless devices. The network entity 2602 may include means for outputting, based on the second context modification request, a second context modification response for the second wireless device, wherein the second context modification response comprises the second identifier for at least the first wireless device in the plurality of wireless devices. The network entity 2602 may include means for outputting, based on the first context modification request, a first data delivery status indication for the first wireless device, wherein the first data delivery status indication comprises the first identifier for at least the second wireless device in the plurality of wireless devices. The network entity 2602 may include means for outputting, based on the second context modification request, a second data delivery status indication for the second wireless device, wherein the second data delivery status indication comprises the second identifier for at least the first wireless device in the plurality of wireless devices. The network entity 2602 may include means for obtaining, in association with a handover procedure for the plurality of wireless devices, a first context setup request for a first wireless device in the plurality of wireless devices, wherein the first context setup request comprises a first identifier for at least a second wireless device in the plurality of wireless devices. The network entity 2602 may include means for obtaining, in association with the handover procedure for the plurality of wireless devices, a second context setup request for the second wireless device, wherein the second context setup request comprises a second identifier for at least the first wireless device in the plurality of wireless devices. The network entity 2602 may include means for checking, based on obtaining the first context setup request and the second context setup request, for resources for the first wireless device and the second wireless device. The network entity 2602 may include means for outputting, based on the first context setup request and the checking for the resources, a first context setup response for the first wireless device in the plurality of wireless devices, wherein the first context setup response comprises the first identifier for at least the second wireless device in the plurality of wireless devices. The network entity 2602 may include means for outputting, based on the second context setup request and the checking for the resources, a second context setup response for the second wireless device in the plurality of wireless devices, wherein the second context setup response comprises the second identifier for at least the first wireless device in the plurality of wireless devices. The network entity 2602 may include means for performing, based on the first context setup request and the second context setup request, a random access procedure for the plurality of wireless devices. The network entity 2602 may include means for outputting, based on the random access procedure for the first wireless device, a first data delivery status indication for the first wireless device, wherein the first data delivery status indication comprises the first identifier for at least the second wireless device in the plurality of wireless devices. The network entity 2602 may include means for outputting, based on the random access procedure for the second wireless device, a second data delivery status indication for the second wireless device, wherein the second data delivery status indication comprises the second identifier for at least the first wireless device in the plurality of wireless devices. The network entity 2602 may include means for obtaining, from a source DU associated with a handover procedure for the plurality of wireless devices, a first data delivery status indication, wherein the first data delivery status indication comprises a first identifier for at least a second wireless device in the plurality of wireless devices. The network entity 2602 may include means for refraining, based on the first data delivery status indication, from routing data for the plurality of wireless devices to the source DU. The network entity 2602 may include means for obtaining, from a target DU associated with the handover procedure for the plurality of wireless devices, a last data delivery status indication in a plurality of data delivery status indications for the plurality of wireless devices, wherein each data delivery status indication is for a different wireless device in the plurality of wireless devices and comprises at least one identifier for at least one other wireless device in the plurality of wireless devices. The network entity 2602 may include means for routing, based on the last data delivery status indication, data for the plurality of wireless devices to the target DU. The network entity 2602 may further include means for performing any of the aspects described in connection with the flowcharts in FIGS. 12-25, and/or performed by the DU, CU, or AMF elements in the communication flow of FIGS. 6, 7, 8, 9, 10A, 10B, 11A, and 11B. The means may be the joint handover component 199 of the network entity 2602 configured to perform the functions recited by the means. As described supra, the network entity 2602 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 6, 7, 8, 9, 10A, 10B, 11A, 11B, and 12-25.

FIG. 27 is a diagram 2700 illustrating an example of a hardware implementation for a network entity 2760. In one example, the network entity 2760 may be within the core network 120. The network entity 2760 may include at least one network processor 2712. The network processor(s) 2712 may include on-chip memory 2712′. In some aspects, the network entity 2760 may further include additional memory modules 2714. The network entity 2760 communicates via the network interface 2780 directly (e.g., backhaul link) or indirectly (e.g., through a RIC) with the CU 2702. The on-chip memory 2712′ and the additional memory modules 2714 may each be considered a computer-readable medium/memory. Each computer-readable medium/memory may be non-transitory. The network processor(s) 2712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the joint handover component 199 may be configured to obtain, from a CP of a CU associated with a target DU associated with the plurality of wireless devices, a common request associated with a path switch for the plurality of wireless devices, switch, based on the common request, a path for the plurality of wireless devices, and output, for the CP of the CU, a common response acknowledging the path switch for the plurality of wireless devices. In some aspects the joint handover component 199 may be configured to obtain, from a CP of a CU associated with a target DU associated with the plurality of wireless devices, a first path switch request for a first wireless device, wherein the first path switch request comprises a first identifier for at least a second wireless device in the plurality of wireless devices, obtain, from the CP of the CU, a second path switch request for the second wireless device, wherein the second path switch request comprises a second identifier for at least the first wireless device in the plurality of wireless devices, and switch, based on the first and second path switch requests, a path for the plurality of wireless devices. The joint handover component 199 may be within the network processor(s) 2712. The joint handover component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2760 may include a variety of components configured for various functions. In one configuration, the network entity 2760 may include means for obtaining, from a control plane (CP) of a centralized unit (CU) associated with a target distributed unit (DU) associated with the plurality of wireless devices, a common request associated with a path switch for the plurality of wireless devices. The network entity 2760 may include means for switching, based on the common request, a path for the plurality of wireless devices. The network entity 2760 may include means for outputting, for the CP of the CU, a common response acknowledging the path switch for the plurality of wireless devices. The network entity 2760 may include means for obtaining, from a control plane (CP) of a centralized unit (CU) associated with a target distributed unit (DU) associated with the plurality of wireless devices, a first path switch request for a first wireless device, wherein the first path switch request comprises a first identifier for at least a second wireless device in the plurality of wireless devices. The network entity 2760 may include means for obtaining, from the CP of the CU, a second path switch request for the second wireless device, wherein the second path switch request comprises a second identifier for at least the first wireless device in the plurality of wireless devices. The network entity 2760 may include means for switching, based on the first and second path switch requests, a path for the plurality of wireless devices. The network entity 2760 may further include means for performing any of the aspects described in connection with the flowcharts in FIGS. 16 and 23, and/or performed by the AMF elements in the communication flow of FIGS. 6, 7, 8, 9, 10A, 10B, 11A, and 11B. The means may be the joint handover component 199 of the network entity 2760 configured to perform the functions recited by the means or as described in relation to FIGS. 6, 7, 8, 9, 10A, 10B, 11A, 11B, 16 and 23.

Particular aspects of the subject matter described in this disclosure can be implemented to realize one or more of the following potential advantages. In some examples, by introducing network signaling for UEs that are grouped together for serving a common service, the described techniques can be used to provide movement and/or transfer between cells for multiple UEs associated with a multi-modal service without interruption.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a CP of a CU associated with a plurality of wireless devices associated with a multi-modal service, comprising: outputting, for a target distributed unit (DU) associated with a handover procedure for the plurality of wireless devices, a first common request relating to a context of the plurality of wireless devices; and obtaining, from the target DU and based on the first common request, a first common response relating to the context of the plurality of wireless devices.

Aspect 2 is the method of aspect 1, further comprising: outputting, for a source DU associated with the handover procedure for the plurality of wireless devices, a second common request to modify the context of the plurality of wireless devices based on the first common response; and obtaining, from the source DU and based on the second common request, a second common response relating to the context of the plurality of wireless devices.

Aspect 3 is the method of aspect 2, wherein the second common request comprises a plurality of radio resource control (RRC) reconfiguration messages for the plurality of wireless devices, wherein the plurality of RRC reconfiguration messages comprises an RRC reconfiguration message for each of the plurality of wireless devices.

Aspect 4 is the method of any of aspects 1 to 3, wherein the first common request relating to the context of the plurality of wireless devices comprises one or more of a multi-modal service identifier (ID) associated with the multi-modal service, an ID of each of the plurality of wireless devices, and an indication of characteristics of flows associated with the plurality of wireless devices.

Aspect 5 is the method of any of aspects 1 to 4, further comprising: obtaining a plurality of individual indications that a radio resource control (RRC) reconfiguration has completed for each wireless device in the plurality of wireless devices; outputting, based on the plurality of individual indications, a common path switch request to an access and mobility management function (AMF) for the plurality of wireless devices; obtaining a common path switch request acknowledgment for the plurality of wireless devices; and releasing, based on at least one of the plurality of individual indications and the common path switch request acknowledgment, contexts associated with the plurality of wireless devices at a source DU.

Aspect 6 is the method of any of aspects 1 to 5, further comprising: obtaining a measurement report triggering the handover procedure for the plurality of wireless devices, wherein outputting the first common request is based on the measurement report.

Aspect 7 is the method of aspect 6, wherein the CP of the CU is a first CP of a first CU associated with both a source DU and the target DU further comprising: outputting, for a user plane (UP) of a second CU associated with the target DU and based on the measurement report, a third common request associated with a bearer context setup for the plurality of wireless devices; obtaining, from the UP of the second CU, a third common response associated with the bearer context setup, wherein the first common request is output based on the third common response;

Aspect 8 is the method of aspect any of aspects 1, wherein the CP of the CU is a first CP of a first CU associated with the target DU, the method further comprising: obtaining a common handover procedure request for the plurality of wireless devices; and outputting, based on the common handover procedure request, a common handover procedure request acknowledgment for the plurality of wireless devices.

Aspect 9 is the method of aspect 8, further comprising: outputting, for a user plane (UP) of a second CU associated with the target DU and based on the common handover procedure request, a third common request associated with a bearer context setup for the plurality of wireless devices; and obtaining, from the UP of the second CU, a third common response associated with the bearer context setup, wherein the first common request is output based on the third common response.

Aspect 10 is the method of any of aspects 1 to 7, further comprising: obtaining a common sequence number (SN) status transfer message indicating that a second CP of a third CU will stop assigning SNs.

Aspect 11 is a method of wireless communication at a source distributed unit (DU) serving a plurality of wireless devices associated with a multi-modal service, comprising: obtaining, for a handover procedure for the plurality of wireless devices from the source DU to a target DU, a common context modification request relating to modifying a context of the plurality of wireless devices; and outputting, based on the common context modification request, a first common data delivery status indication for the plurality of wireless devices.

Aspect 12 is the method of aspect 11, wherein the common context modification request comprises a plurality of individual radio resource control (RRC) reconfiguration messages for the plurality of wireless devices, wherein the plurality of individual RRC reconfiguration messages comprises an individual RRC reconfiguration message for each of the plurality of wireless devices.

Aspect 13 is the method of aspect 12, further comprising: outputting, for each of the plurality of wireless devices, one of the plurality of individual RRC reconfiguration messages corresponding to the wireless device.

Aspect 14 is the method of any of aspects 11 to 15, wherein the common context modification request comprises one or more of a multi-modal service identifier (ID) associated with the multi-modal service, an ID of each of the plurality of wireless devices, and an indication of characteristics of flows associated with the plurality of wireless devices.

Aspect 15 is the method of aspect 14, further comprising: outputting, based on the common context modification request, a common context modification response for the plurality of wireless devices, wherein the common context modification response comprises one or more of the multi-modal service ID, the ID of each of the plurality of wireless devices, the indication of characteristics of flows associated with the plurality of wireless devices, and an indication that the common context modification response is related to the common context modification request.

Aspect 16 is a method of wireless communication at a target distributed unit (DU) serving a plurality of wireless devices associated with a multi-modal service, comprising: obtaining, for a handover procedure for the plurality of wireless devices from a source DU to a target DU, a common context setup request relating to modifying a context of the plurality of wireless devices; and outputting, based on the common context setup request, a common context setup response for the plurality of wireless devices.

Aspect 17 is the method of aspect 16, further comprising: outputting, based on the common context setup request, a first common data delivery status indication for the plurality of wireless devices.

Aspect 18 is the method of aspect 17, further comprising: receiving, from the plurality of wireless devices, at least a first message of a random access procedure for each of the plurality of wireless devices, wherein outputting the first common data delivery status indication is further based on the first message of the random access procedure for each of the plurality of wireless devices.

Aspect 19 is the method of any of aspects 16 to 18, wherein the common context setup request comprises one or more of a multi-modal service identifier (ID) associated with the multi-modal service, an ID of each of the plurality of wireless devices, and an indication of characteristics of flows associated with the plurality of wireless devices.

Aspect 20 is a method of wireless communication at a user plane (UP) of a centralized unit (CU) associated with a source distributed unit (DU) connected to a plurality of wireless devices associated with a first multi-modal service, comprising: obtaining, from a source DU associated with a handover procedure for the plurality of wireless devices, a first common data delivery status indication relating to the plurality of wireless devices; refraining, based on the first common data delivery status indication, from routing data for the plurality of wireless devices to the source DU.

Aspect 21 is a method of wireless communication at a user plane (UP) of a first centralized unit (CU) associated with a target distributed unit (DU) connected to a plurality of wireless devices associated with a first multi-modal service, comprising: obtaining, from a target DU associated with the handover procedure for the plurality of wireless devices, a common data delivery status indication relating to the plurality of wireless devices; and routing, based on the common data delivery status indication, data to the target DU.

Aspect 22 is a method of wireless communication at one of an access and mobility management function (AMF) or a user plane function (UPF) associated with a plurality of wireless devices associated with a first multi-modal service, comprising: obtaining, from a control plane (CP) of a centralized unit (CU) associated with a target distributed unit (DU) associated with the plurality of wireless devices, a common request associated with a path switch for the plurality of wireless devices; switching, based on the common request, a path for the plurality of wireless devices; and outputting, for the CP of the CU, a common response acknowledging the path switch for the plurality of wireless devices.

Aspect 23 is a method of wireless communication at a CP of a CU associated with a plurality of wireless devices associated with a first multi-modal service, comprising: outputting, for a target distributed unit (DU) associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure; and outputting, for the target DU, a second request relating to a second context of the second wireless device in the plurality of wireless devices, wherein the second request comprises a second identifier of at least the first wireless device.

Aspect 24 is the method of aspect 23, wherein the CP of the CU is a first CP of a first CU associated with the plurality of wireless devices further comprising: obtaining, from a second CP of a second CU associated with the joint handover procedure for the plurality of wireless devices, a first handover request for the first wireless device in the plurality of wireless devices, wherein the first request comprises the first identifier of at least the second wireless device in the plurality of wireless devices; and obtaining, from the second CP of the second CU, a second handover request for the second wireless device in the plurality of wireless devices, wherein the second request comprises the second identifier of at least the first wireless device.

Aspect 25 is the method of aspect 24, further comprising: outputting, for the second CP of the second CU, a first handover request acknowledgment for the first wireless device in the plurality of wireless devices, wherein the first handover request acknowledgment comprises the first identifier of at least the second wireless device in the plurality of wireless devices; and outputting, from the second CP of the second CU, a second handover request acknowledgment for the second wireless device in the plurality of wireless devices, wherein the second handover request acknowledgment comprises the second identifier of at least the first wireless device.

Aspect 26 is the method of aspect 24, further comprising: performing, based on the first handover request and the second handover request, a call admission control for the first wireless device and the second wireless device.

Aspect 27 is the method of aspect 24, further comprising: outputting, based on the first handover request and the second handover request, a first bearer context setup request for the first wireless device, wherein the first bearer context setup request comprises the first identifier of at least the second wireless device in the plurality of wireless devices; and outputting, based on the first handover request and the second handover request, a second bearer context setup request for the second wireless device, wherein the second bearer context setup request comprises the second identifier of at least the first wireless device.

Aspect 28 is the method of aspect 27, further comprising: obtaining, based on the first bearer context setup request, a first bearer context setup response for the first wireless device, wherein the first bearer context setup response comprises the first identifier of at least the second wireless device in the plurality of wireless devices; and obtaining, based on the second bearer context setup request, a second bearer context setup response for the second wireless device, wherein the second bearer context setup request comprises the second identifier of at least the first wireless device.

Aspect 29 is the method of any of aspects 23 to 28, further comprising: obtaining, from the target DU, a first context setup response relating to the first context of the first wireless device in the plurality of wireless devices, wherein the first context setup response comprises the first identifier of at least the second wireless device in the plurality of wireless devices associated with the joint handover procedure; and obtaining, from the target DU, a second context setup response relating to the second context of the second wireless device in the plurality of wireless devices, wherein the second context setup response comprises the second identifier of at least the first wireless device in the plurality of wireless devices associated with the joint handover procedure.

Aspect 30 is the method of any of aspects 23 to 29, further comprising: obtaining a first indication of a completion of a radio resource control (RRC) reconfiguration for the first wireless device; and outputting, based on the first indication, a first path switch request for the first wireless device, wherein the first path switch request comprises the first identifier of at least the second wireless device in the plurality of wireless devices.

Aspect 31 is the method of aspect 30, further comprising: obtaining a second indication of an additional completion of an additional RRC reconfiguration for the second wireless device; and outputting, based on the second indication, a second path switch request for the second wireless device, wherein the second path switch request comprises the second identifier of at least the first wireless device in the plurality of wireless devices.

Aspect 32 is a method of wireless communication at a source distributed unit (DU) serving a plurality of wireless devices associated with a multi-modal service, comprising: obtaining, in association with a handover procedure for the plurality of wireless devices, a first context modification request for a first wireless device in the plurality of wireless devices, wherein the first context modification request comprises a first identifier for at least a second wireless device in the plurality of wireless devices; and obtaining, in association with the handover procedure for the plurality of wireless devices, a second context modification request for the second wireless device, wherein the second context modification request comprises a second identifier for at least the first wireless device in the plurality of wireless devices.

Aspect 33 is the method of aspect 32, wherein the first context modification request further comprises one or more of a multi-modal service identifier (ID) associated with the multi-modal service, an ID of each of the plurality of wireless devices, and an indication of characteristics of flows associated with the plurality of wireless devices.

Aspect 34 is the method of any of aspects 32 and 33, wherein the first context modification request comprises a first individual radio resource control (RRC) reconfiguration message for the first wireless device, and the second context modification request comprises a second individual RRC reconfiguration message for the second wireless device.

Aspect 35 is the method of aspect 34, further comprising: outputting, based on obtaining the first context modification request and the second context modification request, the first individual RRC reconfiguration message for the first wireless device and the second individual RRC reconfiguration message for the second wireless device.

Aspect 36 is the method of any of aspects 32 to 35, further comprising: outputting, based on the first context modification request, a first context modification response for the first wireless device, wherein the first context modification response comprises the first identifier for at least the second wireless device in the plurality of wireless devices; and outputting, based on the second context modification request, a second context modification response for the second wireless device, wherein the second context modification response comprises the second identifier for at least the first wireless device in the plurality of wireless devices.

Aspect 37 is the method of any of aspects 32 to 36, further comprising: outputting, based on the first context modification request, a first data delivery status indication for the first wireless device, wherein the first data delivery status indication comprises the first identifier for at least the second wireless device in the plurality of wireless devices; and outputting, based on the second context modification request, a second data delivery status indication for the second wireless device, wherein the second data delivery status indication comprises the second identifier for at least the first wireless device in the plurality of wireless devices.

Aspect 38 is a method of wireless communication at a target distributed unit (DU) serving a plurality of wireless devices associated with a multi-modal service, comprising: obtaining, in association with a handover procedure for the plurality of wireless devices, a first context setup request for a first wireless device in the plurality of wireless devices, wherein the first context setup request comprises a first identifier for at least a second wireless device in the plurality of wireless devices; and obtaining, in association with the handover procedure for the plurality of wireless devices, a second context setup request for the second wireless device, wherein the second context setup request comprises a second identifier for at least the first wireless device in the plurality of wireless devices.

Aspect 39 is the method of aspect 38, further comprising: checking, based on obtaining the first context setup request and the second context setup request, for resources for the first wireless device and the second wireless device.

Aspect 40 is the method of aspect 39, further comprising: outputting, based on the first context setup request and the checking for the resources, a first context setup response for the first wireless device in the plurality of wireless devices, wherein the first context setup response comprises the first identifier for at least the second wireless device in the plurality of wireless devices; and outputting, based on the second context setup request and the checking for the resources, a second context setup response for the second wireless device in the plurality of wireless devices, wherein the second context setup response comprises the second identifier for at least the first wireless device in the plurality of wireless devices.

Aspect 41 is the method of any of aspects 38 to 40, wherein the first context setup request comprises one or more of a multi-modal service identifier (ID) associated with the multi-modal service, an ID of each of the plurality of wireless devices, and an indication of characteristics of flows associated with the plurality of wireless devices.

Aspect 42 is the method of any of aspects 38 to 41, further comprising: performing, based on the first context setup request and the second context setup request, a random access procedure for the plurality of wireless devices; outputting, based on the random access procedure for the first wireless device, a first data delivery status indication for the first wireless device, wherein the first data delivery status indication comprises the first identifier for at least the second wireless device in the plurality of wireless devices; and outputting, based on the random access procedure for the second wireless device, a second data delivery status indication for the second wireless device, wherein the second data delivery status indication comprises the second identifier for at least the first wireless device in the plurality of wireless devices.

Aspect 43 is a method of wireless communication at a user plane (UP) of a centralized unit (CU) associated with a source distributed unit (DU) connected to a plurality of wireless devices associated with a first multi-modal service, comprising: obtaining, from a source DU associated with a handover procedure for the plurality of wireless devices, a first data delivery status indication, wherein the first data delivery status indication comprises a first identifier for at least a second wireless device in the plurality of wireless devices; and refraining, based on the first data delivery status indication, from routing data for the plurality of wireless devices to the source DU.

Aspect 44 is a method of wireless communication at a user plane (UP) of a first centralized unit (CU) associated with a target distributed unit (DU) connected to a plurality of wireless devices associated with a first multi-modal service, comprising: obtaining, from a target DU associated with the handover procedure for the plurality of wireless devices, a last data delivery status indication in a plurality of data delivery status indications for the plurality of wireless devices, wherein each data delivery status indication is for a different wireless device in the plurality of wireless devices and comprises at least one identifier for at least one other wireless device in the plurality of wireless devices; and routing, based on the last data delivery status indication, data for the plurality of wireless devices to the target DU.

Aspect 45 is a method of wireless communication at one of an access and mobility management function (AMF) or a user plane function (UPF) associated with a plurality of wireless devices associated with a first multi-modal service, comprising: obtaining, from a control plane (CP) of a centralized unit (CU) associated with a target distributed unit (DU) associated with the plurality of wireless devices, a first path switch request for a first wireless device, wherein the first path switch request comprises a first identifier for at least a second wireless device in the plurality of wireless devices; obtaining, from the CP of the CU, a second path switch request for the second wireless device, wherein the second path switch request comprises a second identifier for at least the first wireless device in the plurality of wireless devices; switching, based on the first and second path switch requests, a path for the plurality of wireless devices.

Aspect 46 is an apparatus for wireless communication at a device including a memory and at least one processor coupled to the memory and, based at least in part on information stored in the memory, the at least one processor is configured to implement any of aspects 1 to 10.

Aspect 47 is the apparatus of aspect 46, further including a transceiver or an antenna coupled to the at least one processor.

Aspect 48 is an apparatus for wireless communication at a device including means for implementing any of aspects 1 to 10.

Aspect 49 is a computer-readable medium (e.g., a non-transitory computer-readable medium) storing computer executable code, where the code when executed by a processor causes the processor to implement any of aspects 1 to 10.

Aspect 50 is an apparatus for wireless communication at a device including a memory and at least one processor coupled to the memory and, based at least in part on information stored in the memory, the at least one processor is configured to implement any of aspects 11 to 15.

Aspect 51 is the apparatus of aspect 50, further including a transceiver or an antenna coupled to the at least one processor.

Aspect 52 is an apparatus for wireless communication at a device including means for implementing any of aspects 11 to 15.

Aspect 53 is a computer-readable medium (e.g., a non-transitory computer-readable medium) storing computer executable code, where the code when executed by a processor causes the processor to implement any of aspects 11 to 15.

Aspect 54 is an apparatus for wireless communication at a device including a memory and at least one processor coupled to the memory and, based at least in part on information stored in the memory, the at least one processor is configured to implement any of aspects 16 to 19.

Aspect 55 is the apparatus of aspect 54, further including a transceiver or an antenna coupled to the at least one processor.

Aspect 56 is an apparatus for wireless communication at a device including means for implementing any of aspects 16 to 19.

Aspect 57 is a computer-readable medium (e.g., a non-transitory computer-readable medium) storing computer executable code, where the code when executed by a processor causes the processor to implement any of aspects 16 to 19.

Aspect 58 is an apparatus for wireless communication at a device including a memory and at least one processor coupled to the memory and, based at least in part on information stored in the memory, the at least one processor is configured to implement aspect 20.

Aspect 59 is the apparatus of aspect 58, further including a transceiver or an antenna coupled to the at least one processor.

Aspect 60 is an apparatus for wireless communication at a device including means for implementing aspect 20.

Aspect 61 is a computer-readable medium (e.g., a non-transitory computer-readable medium) storing computer executable code, where the code when executed by a processor causes the processor to implement aspect 20.

Aspect 62 is an apparatus for wireless communication at a device including a memory and at least one processor coupled to the memory and, based at least in part on information stored in the memory, the at least one processor is configured to implement aspect 21.

Aspect 63 is the apparatus of aspect 62, further including a transceiver or an antenna coupled to the at least one processor.

Aspect 64 is an apparatus for wireless communication at a device including means for implementing aspect 21.

Aspect 65 is a computer-readable medium (e.g., a non-transitory computer-readable medium) storing computer executable code, where the code when executed by a processor causes the processor to implement aspect 21.

Aspect 66 is an apparatus for wireless communication at a device including a memory and at least one processor coupled to the memory and, based at least in part on information stored in the memory, the at least one processor is configured to implement aspect 22.

Aspect 67 is the apparatus of aspect 66, further including a transceiver or an antenna coupled to the at least one processor.

Aspect 68 is an apparatus for wireless communication at a device including means for implementing aspect 22.

Aspect 69 is a computer-readable medium (e.g., a non-transitory computer-readable medium) storing computer executable code, where the code when executed by a processor causes the processor to implement aspect 22.

Aspect 70 is an apparatus for wireless communication at a device including a memory and at least one processor coupled to the memory and, based at least in part on information stored in the memory, the at least one processor is configured to implement any of aspects 23 to 31.

Aspect 71 is the apparatus of aspect 70, further including a transceiver or an antenna coupled to the at least one processor.

Aspect 72 is an apparatus for wireless communication at a device including means for implementing any of aspects 23 to 31.

Aspect 73 is a computer-readable medium (e.g., a non-transitory computer-readable medium) storing computer executable code, where the code when executed by a processor causes the processor to implement any of aspects 23 to 31.

Aspect 74 is an apparatus for wireless communication at a device including a memory and at least one processor coupled to the memory and, based at least in part on information stored in the memory, the at least one processor is configured to implement any of aspects 32 to 37.

Aspect 75 is the apparatus of aspect 74, further including a transceiver or an antenna coupled to the at least one processor.

Aspect 76 is an apparatus for wireless communication at a device including means for implementing any of aspects 32 to 37.

Aspect 77 is a computer-readable medium (e.g., a non-transitory computer-readable medium) storing computer executable code, where the code when executed by a processor causes the processor to implement any of aspects 32 to 37.

Aspect 78 is an apparatus for wireless communication at a device including a memory and at least one processor coupled to the memory and, based at least in part on information stored in the memory, the at least one processor is configured to implement any of aspects 38 to 42.

Aspect 79 is the apparatus of aspect 78, further including a transceiver or an antenna coupled to the at least one processor.

Aspect 80 is an apparatus for wireless communication at a device including means for implementing any of aspects 38 to 42.

Aspect 81 is a computer-readable medium (e.g., a non-transitory computer-readable medium) storing computer executable code, where the code when executed by a processor causes the processor to implement any of aspects 38 to 42.

Aspect 82 is an apparatus for wireless communication at a device including a memory and at least one processor coupled to the memory and, based at least in part on information stored in the memory, the at least one processor is configured to implement aspect 43.

Aspect 83 is the apparatus of aspect 82, further including a transceiver or an antenna coupled to the at least one processor.

Aspect 84 is an apparatus for wireless communication at a device including means for implementing aspect 43.

Aspect 85 is a computer-readable medium (e.g., a non-transitory computer-readable medium) storing computer executable code, where the code when executed by a processor causes the processor to implement aspect 43.

Aspect 86 is an apparatus for wireless communication at a device including a memory and at least one processor coupled to the memory and, based at least in part on information stored in the memory, the at least one processor is configured to implement aspect 44.

Aspect 87 is the apparatus of aspect 86, further including a transceiver or an antenna coupled to the at least one processor.

Aspect 88 is an apparatus for wireless communication at a device including means for implementing aspect 44.

Aspect 89 is a computer-readable medium (e.g., a non-transitory computer-readable medium) storing computer executable code, where the code when executed by a processor causes the processor to implement aspect 44.

Aspect 90 is an apparatus for wireless communication at a device including a memory and at least one processor coupled to the memory and, based at least in part on information stored in the memory, the at least one processor is configured to implement aspect 45.

Aspect 91 is the apparatus of aspect 90, further including a transceiver or an antenna coupled to the at least one processor.

Aspect 92 is an apparatus for wireless communication at a device including means for implementing aspect 45.

Aspect 93 is a computer-readable medium (e.g., a non-transitory computer-readable medium) storing computer executable code, where the code when executed by a processor causes the processor to implement aspect 45.

What is claimed is:

1. An apparatus for wireless communication at a CP of a CU associated with a plurality of wireless devices associated with a first multi-modal service, comprising:
at least one memory; and
at least one processor coupled to the at least one memory and, based at least in part on stored information that is stored in the at least one memory, the at least one processor, individually or in any combination, is configured to:
output, for a target distributed unit (DU) associated with a joint handover procedure for the plurality of wireless devices, a first request relating to a first context of a first wireless device in the plurality of wireless devices, wherein the first request comprises a first identifier of at least a second wireless device in the plurality of wireless devices associated with the joint handover procedure; and
output, for the target DU, a second request relating to a second context of the second wireless device in the plurality of wireless devices, wherein the second request comprises a second identifier of at least the first wireless device.

2. The apparatus of claim 1, wherein the CP of the CU is a first CP of a first CU associated with the plurality of wireless devices, and wherein the at least one processor, individually or in any combination, is further configured to:
obtain, from a second CP of a second CU associated with the joint handover procedure for the plurality of wireless devices, a first handover request for the first wireless device in the plurality of wireless devices, wherein the first request comprises the first identifier of at least the second wireless device in the plurality of wireless devices; and
obtain, from the second CP of the second CU, a second handover request for the second wireless device in the plurality of wireless devices, wherein the second request comprises the second identifier of at least the first wireless device.

3. The apparatus of claim 2, wherein the at least one processor, individually or in any combination, is further configured to:
output, for the second CP of the second CU, a first handover request acknowledgment for the first wireless device in the plurality of wireless devices, wherein the first handover request acknowledgment comprises the first identifier of at least the second wireless device in the plurality of wireless devices; and
output, from the second CP of the second CU, a second handover request acknowledgment for the second wireless device in the plurality of wireless devices, wherein the second handover request acknowledgment comprises the second identifier of at least the first wireless device.

4. The apparatus of claim 2, wherein the at least one processor, individually or in any combination, is further configured to:
perform, based on the first handover request and the second handover request, a call admission control for the first wireless device and the second wireless device.

5. The apparatus of claim 2, wherein the at least one processor, individually or in any combination, is further configured to:
output, based on the first handover request and the second handover request, a first bearer context setup request for the first wireless device, wherein the first bearer context setup request comprises the first identifier of at least the second wireless device in the plurality of wireless devices; and
output, based on the first handover request and the second handover request, a second bearer context setup request for the second wireless device, wherein the second bearer context setup request comprises the second identifier of at least the first wireless device.

6. The apparatus of claim 5, wherein the at least one processor, individually or in any combination, is further configured to:
obtain, based on the first bearer context setup request, a first bearer context setup response for the first wireless device, wherein the first bearer context setup response comprises the first identifier of at least the second wireless device in the plurality of wireless devices; and
obtain, based on the second bearer context setup request, a second bearer context setup response for the second wireless device, wherein the second bearer context setup request comprises the second identifier of at least the first wireless device.

7. The apparatus of claim 1, wherein the at least one processor, individually or in any combination, is further configured to:
obtain, from the target DU, a first context setup response relating to the first context of the first wireless device in the plurality of wireless devices, wherein the first context setup response comprises the first identifier of at least the second wireless device in the plurality of wireless devices associated with the joint handover procedure; and
obtain, from the target DU, a second context setup response relating to the second context of the second wireless device in the plurality of wireless devices, wherein the second context setup response comprises the second identifier of at least the first wireless device in the plurality of wireless devices associated with the joint handover procedure.

8. The apparatus of claim 1, wherein the at least one processor, individually or in any combination, is further configured to:
obtain a first indication of a completion of a radio resource control (RRC) reconfiguration for the first wireless device; and
output, based on the first indication, a first path switch request for the first wireless device, wherein the first path switch request comprises the first identifier of at least the second wireless device in the plurality of wireless devices.

9. The apparatus of claim 8, wherein the at least one processor, individually or in any combination, is further configured to:
obtain a second indication of an additional completion of an additional RRC reconfiguration for the second wireless device; and
output, based on the second indication, a second path switch request for the second wireless device, wherein the second path switch request comprises the second identifier of at least the first wireless device in the plurality of wireless devices.

10. An apparatus for wireless communication at a source distributed unit (DU) serving a plurality of wireless devices associated with a multi-modal service, comprising:
at least one memory; and
at least one processor coupled to the at least one memory and, based at least in part on stored information that is stored in the at least one memory, the at least one processor, individually or in any combination, is configured to:
obtain, in association with a handover procedure for the plurality of wireless devices, a first context modification request for a first wireless device in the plurality of wireless devices, wherein the first context modification request comprises a first identifier for at least a second wireless device in the plurality of wireless devices; and
obtain, in association with the handover procedure for the plurality of wireless devices, a second context modification request for the second wireless device, wherein the second context modification request comprises a second identifier for at least the first wireless device in the plurality of wireless devices.

11. The apparatus of claim 10, wherein the first context modification request further comprises one or more of a multi-modal service identifier (ID) associated with the multi-modal service, an ID of each of the plurality of wireless devices, and an indication of characteristics of flows associated with the plurality of wireless devices.

12. The apparatus of claim 10, wherein the first context modification request comprises a first individual radio resource control (RRC) reconfiguration message for the first wireless device, and the second context modification request comprises a second individual RRC reconfiguration message for the second wireless device.

13. The apparatus of claim 12, wherein the at least one processor, individually or in any combination, is further configured to:
output, based on obtaining the first context modification request and the second context modification request, the first individual RRC reconfiguration message for the first wireless device and the second individual RRC reconfiguration message for the second wireless device.

14. The apparatus of claim 10, wherein the at least one processor, individually or in any combination, is further configured to:
output, based on the first context modification request, a first context modification response for the first wireless device, wherein the first context modification response comprises the first identifier for at least the second wireless device in the plurality of wireless devices; and
output, based on the second context modification request, a second context modification response for the second wireless device, wherein the second context modification response comprises the second identifier for at least the first wireless device in the plurality of wireless devices.

15. The apparatus of claim 10, wherein the at least one processor, individually or in any combination, is further configured to:
output, based on the first context modification request, a first data delivery status indication for the first wireless device, wherein the first data delivery status indication comprises the first identifier for at least the second wireless device in the plurality of wireless devices; and
output, based on the second context modification request, a second data delivery status indication for the second wireless device, wherein the second data delivery status indication comprises the second identifier for at least the first wireless device in the plurality of wireless devices.

16. An apparatus for wireless communication at a target distributed unit (DU) serving a plurality of wireless devices associated with a multi-modal service, comprising:
at least one memory; and
at least one processor coupled to the at least one memory and, based at least in part on stored information that is stored in the at least one memory, the at least one processor, individually or in any combination, is configured to:
obtain, in association with a handover procedure for the plurality of wireless devices, a first context setup request for a first wireless device in the plurality of wireless devices, wherein the first context setup request comprises a first identifier for at least a second wireless device in the plurality of wireless devices; and
obtain, in association with the handover procedure for the plurality of wireless devices, a second context setup request for the second wireless device, wherein the second context setup request comprises a second identifier for at least the first wireless device in the plurality of wireless devices.

17. The apparatus of claim 16, wherein the at least one processor, individually or in any combination, is further configured to:
check, based on obtaining the first context setup request and the second context setup request, for resources for the first wireless device and the second wireless device.

18. The apparatus of claim 17, wherein the at least one processor, individually or in any combination, is further configured to:
output, based on the first context setup request and the check for the resources, a first context setup response for the first wireless device in the plurality of wireless devices, wherein the first context setup response comprises the first identifier for at least the second wireless device in the plurality of wireless devices; and
output, based on the second context setup request and the check for the resources, a second context setup response for the second wireless device in the plurality of wireless devices, wherein the second context setup response comprises the second identifier for at least the first wireless device in the plurality of wireless devices.

19. The apparatus of claim 16, wherein the first context setup request comprises one or more of a multi-modal service identifier (ID) associated with the multi-modal service, an ID of each of the plurality of wireless devices, and an indication of characteristics of flows associated with the plurality of wireless devices.

20. The apparatus of claim 16, wherein the at least one processor, individually or in any combination, is further configured to:
perform, based on the first context setup request and the second context setup request, a random access procedure for the plurality of wireless devices;
output, based on the random access procedure for the first wireless device, a first data delivery status indication for the first wireless device, wherein the first data delivery status indication comprises the first identifier for at least the second wireless device in the plurality of wireless devices; and
output, based on the random access procedure for the second wireless device, a second data delivery status indication for the second wireless device, wherein the second data delivery status indication comprises the second identifier for at least the first wireless device in the plurality of wireless devices.
